(19) United States
(12) Patent Application Publication
(10) Pub. No.: US 2023/0286825 A1
(43) Pub. Date: Sep. 14, 2023

(54) MANUFACTURING METHOD OF POSITIVE ELECTRODE ACTIVE MATERIAL

(71) Applicant: SEMICONDUCTOR ENERGY LABORATORY CO., LTD., Atsugi-shi, Kanagawa-ken (JP)

(72) Inventors: Shunpei YAMAZAKI, Setagaya, Tokyo (JP); Tetsuya KAKEHATA, lsehara, Kanagawa (JP); Tetsuji ISHITANI, Atsugi, Kanagawa (JP); Yohei MOMMA, lsehara, Kanagawa (JP); Yusuke YOSHITANI, lsehara, Kanagawa (JP)

(21) Appl. No.: 18/040,286

(22) PCT Filed: Aug. 6, 2021
(86) PCT No.: PCT/IB2021/057244

§ 371 Date: Feb. 2, 2023

(30) Foreign Application Priority Data
Aug. 20, 2020 (JP) 2020-139681
Sep. 8, 2020 (JP) 2020-150429

(51) Int. Cl. C01G 53/00

(52) U.S. Cl. CPC C01G 53/44; C01P 2006/40

(57) ABSTRACT

A manufacturing method of a highly purified positive electrode active material is provided. Alternatively, a manufacturing method of a positive electrode active material whose crystal structure is not easily broken even when charging and discharging are repeated is provided. Provided is a manufacturing method of a positive electrode active material containing lithium and a transition metal. The manufacturing method includes a first step of forming a hydroxide containing the transition metal using a basic aqueous solution and an aqueous solution containing the transition metal, a second step of preparing a lithium compound, a third step of mixing the lithium compound and the hydroxide to form a mixture, and a fourth step of heating the mixture to form a composite oxide containing lithium and the transition metal. A material with a purity higher than or equal to 99.99% is prepared as the lithium compound in the second step, and the heating is performed in an oxygen-containing atmosphere with a dew point lower than or equal to −50° C. in the fourth step.

### TECHNICAL FIELD

The present invention relates to a manufacturing method of a positive electrode active material. Alternatively, the present invention relates to a manufacturing method of a secondary battery. Alternatively, the present invention relates to a portable information terminal, a vehicle, and the like each including a secondary battery.

One embodiment of the present invention relates to an object, a method, or a manufacturing method. Alternatively, the present invention relates to a process, a machine, manufacture, or a composition of matter. One embodiment of the present invention relates to a semiconductor device, a display device, a light-emitting device, a power storage device, a lighting device, an electronic device, or a manufacturing method thereof. Note that one embodiment of the present invention particularly relates to a manufacturing method of a positive electrode active material or the positive electrode active material. Alternatively, one embodiment of the present invention particularly relates to a manufacturing method of a secondary battery or the secondary battery.

Note that semiconductor devices in this specification mean all devices that can function by utilizing semiconductor characteristics, and an electro-optical device, a semiconductor circuit, and an electronic device are all semiconductor devices.

Note that electronic devices in this specification mean all devices including positive electrode active materials, secondary batteries, or power storage devices, and electro-optical devices including positive electrode active materials, secondary batteries, or power storage devices, information terminal devices including power storage devices, and the like are all electronic devices.

Note that in this specification and the like, a power storage device refers to every element and device having a function of storing power. For example, a power storage device (also referred to as a secondary battery) such as a lithium-ion secondary battery, a lithium-ion capacitor, and an electric double layer capacitor are included.

### BACKGROUND ART

In recent years, a variety of power storage devices such as lithium-ion secondary batteries, lithium-ion capacitors, and air batteries have been actively developed. In particular, demand for lithium-ion secondary batteries with high output and high energy density has rapidly grown with the development of the semiconductor industry, for portable information terminals such as mobile phones, smartphones, and laptop computers, portable music players, digital cameras, medical equipment, next-generation clean energy vehicles such as hybrid electric vehicles (HVs), electric vehicles (EVs), and plug-in hybrid electric vehicles (PHVs), and the like, and the lithium-ion secondary batteries are essential as rechargeable energy supply sources for today's information society.

Thus, improvement of a positive electrode active material has been studied to increase the cycle performance and the capacity of the lithium-ion secondary battery (Patent Document 1 and Patent Document 2).

### REFERENCE

### Patent Documents

[Patent Document 1] Japanese Published Patent Application No. 2012-018914
[Patent Document 2] Japanese Published Patent Application No. 2016-076454

### SUMMARY OF THE INVENTION

### Problems to be Solved by the Invention

Since a positive electrode active material is a high-cost material in a lithium-ion secondary battery, the demand for performance improvements (e.g., an increase in capacity, an improvement in cycle performance, and an improvement in reliability or safety) is high. In particular, there is a challenge to increase the purity of a positive electrode active material in order to achieve an increase in capacity, which is one of the performance improvements.

In view of the above, an object of one embodiment of the present invention is to provide a manufacturing method of a highly purified positive electrode active material. Another object is to provide a manufacturing method of a positive electrode active material whose crystal structure is not easily broken even when charging and discharging are repeated. Another object is to provide a manufacturing method of a positive electrode active material with excellent charge and discharge cycle performance. Another object is to provide a manufacturing method of a positive electrode active material with high charge and discharge capacity. Another object is to provide a highly safe or reliable secondary battery.

Another object of one embodiment of the present invention is to provide a novel material, novel active material particles, a novel secondary battery, a novel power storage device, or a manufacturing method thereof. Another object of one embodiment of the present invention is to provide a manufacturing method of a secondary battery having one or more of characteristics selected from increased purity, improved performance, and increased reliability or to provide the secondary battery.

Note that the description of these objects does not preclude the existence of other objects. In one embodiment of the present invention, there is no need to achieve all these objects. Other objects can be derived from the description of the specification, the drawings, and the claims.

### Means for Solving the Problems

One embodiment of the present invention is a manufacturing method of a positive electrode active material containing lithium and a transition metal. The manufacturing method of the positive electrode active material includes a first step of forming a hydroxide containing the transition metal using at least a basic aqueous solution and an aqueous solution containing the transition metal; a second step of preparing a lithium compound; a third step of mixing the lithium compound and the hydroxide to form a mixture; and a fourth step of heating the mixture to form a composite oxide containing the lithium and the transition metal. A material with a purity higher than or equal to 99.99% is prepared as the lithium compound in the second step, and the heating in the fourth step is performed in an oxygen-containing atmosphere with a dew point lower than or equal to −50° C.

Alternatively, one embodiment of the present invention is a manufacturing method of a positive electrode active material containing lithium, nickel, cobalt, and manganese. The manufacturing method of the positive electrode active material includes a first step of forming a hydroxide containing nickel, cobalt, and manganese using at least a basic aqueous solution and a mixed solution of an aqueous solution containing nickel, an aqueous solution containing cobalt, and an aqueous solution containing manganese; a second step of preparing a lithium compound; a third step of mixing the lithium compound and the hydroxide to form a mixture; and a fourth step of heating the mixture to form a composite oxide containing the lithium, the nickel, the cobalt, and the manganese. A material with a purity higher than or equal to 99.99% is prepared as the lithium compound in the second step, and the heating in the fourth step is performed in an oxygen-containing atmosphere with a dew point lower than or equal to −50° C.

Alternatively, one embodiment of the present invention is a manufacturing method of a positive electrode active material containing lithium, nickel, cobalt, manganese, and aluminum. The manufacturing method of the positive electrode active material includes a first step of forming a hydroxide containing nickel, cobalt, manganese, and aluminum using at least a basic aqueous solution and a mixed solution of an aqueous solution containing nickel, an aqueous solution containing cobalt, an aqueous solution containing manganese, and an aqueous solution containing aluminum; a second step of preparing a lithium compound; a third step of mixing the lithium compound and the hydroxide to form a mixture; and a fourth step of heating the mixture to form a composite oxide containing the lithium, the nickel, the cobalt, the manganese, and the aluminum. A material with a purity higher than or equal to 99.99% is prepared as the lithium compound in the second step, and the heating in the fourth step is performed in an oxygen-containing atmosphere with a dew point lower than or equal to −50° C.

Alternatively, one embodiment of the present invention is a manufacturing method of a positive electrode active material containing lithium, nickel, cobalt, manganese, and aluminum. The manufacturing method of the positive electrode active material includes a first step of forming a hydroxide containing nickel, cobalt, and manganese using at least a basic aqueous solution and a mixed solution of an aqueous solution containing nickel, an aqueous solution containing cobalt, and an aqueous solution containing manganese; a second step of preparing a lithium compound and an aluminum source; a third step of mixing the lithium compound, the aluminum source, and the hydroxide to form a mixture; and a fourth step of heating the mixture to form a composite oxide containing the lithium, the nickel, the cobalt, the manganese, and the aluminum. A material with a purity higher than or equal to 99.99% and a material with a purity higher than or equal to 99.9% are prepared as the lithium compound and the aluminum source, respectively, in the second step, and the heating in the fourth step is performed in an oxygen-containing atmosphere with a dew point lower than or equal to −50° C.

Alternatively, one embodiment of the present invention is a manufacturing method of a positive electrode active material containing lithium, nickel, cobalt, manganese, aluminum, magnesium, and fluorine. The manufacturing method of the positive electrode active material includes a first step of forming a hydroxide containing nickel, cobalt, and manganese using at least a basic aqueous solution and a mixed solution of an aqueous solution containing nickel, an aqueous solution containing cobalt, and an aqueous solution containing manganese; a second step of preparing a lithium compound and an aluminum source; a third step of mixing the lithium compound, the aluminum source, and the hydroxide to form a first mixture; a fourth step of heating the first mixture to form a first composite oxide containing the lithium, the nickel, the cobalt, the manganese, and the aluminum; a fifth step of preparing a magnesium source and a fluorine source; a sixth step of mixing the first composite oxide, the magnesium source, and the fluorine source to form a second mixture; and a seventh step of heating the second mixture to form a second composite oxide containing the lithium, the nickel, the cobalt, the manganese, the aluminum, the magnesium, and the fluorine. A material with a purity higher than or equal to 99.99% and a material with a purity higher than or equal to 99.9% are prepared as the lithium compound and the aluminum source, respectively, in the second step; a material with a purity higher than or equal to 99% and a material with a purity higher than or equal to 99% are prepared as the magnesium source and the fluorine source, respectively, in the fifth step; and the heating in the fourth step and the heating in the seventh step are performed in an oxygen-containing atmosphere with a dew point lower than or equal to −50° C.

### Effect of the Invention

According to one embodiment of the present invention, a manufacturing method of a highly purified positive electrode active material can be provided. Alternatively, a manufacturing method of a positive electrode active material whose crystal structure is not easily broken even when charging and discharging are repeated can be provided. Alternatively, a manufacturing method of a positive electrode active material with excellent charge and discharge cycle performance can be provided. Alternatively, a manufacturing method of a positive electrode active material with high charge and discharge capacity can be provided. Alternatively, a highly safe or reliable secondary battery can be provided.

According to one embodiment of the present invention, a novel material, novel active material particles, a novel secondary battery, a novel power storage device, or a manufacturing method thereof can be provided. According to one embodiment of the present invention, a manufacturing method of a secondary battery having one or more of characteristics selected from increased purity, improved performance, and increased reliability or to provide the secondary battery can be provided.

Note that the description of these effects does not preclude the existence of other effects. One embodiment of the present invention does not need to have all the effects. Other effects will be apparent from the description of the specification, the drawings, the claims, and the like, and other effects can be derived from the description of the specification, the drawings, the claims, and the like.

### BRIEF DESCRIPTION OF THE DRAWINGS

FIG. 1 is a diagram showing an example of a manufacturing method of a positive electrode active material of one embodiment of the present invention.

FIG. 2 is a diagram showing an example of a manufacturing method of a positive electrode active material of one embodiment of the present invention.

FIG. 3A to FIG. 3E are diagrams showing examples of a manufacturing method of a positive electrode active material of one embodiment of the present invention.

FIG. 4 is a diagram showing an example of a manufacturing method of a positive electrode active material of one embodiment of the present invention.

FIG. 5 is a diagram showing an example of a manufacturing method of a positive electrode active material of one embodiment of the present invention.

FIG. 6 shows an example of a manufacturing method of a positive electrode active material of one embodiment of the present invention.

FIG. 7 shows an example of a manufacturing method of a positive electrode active material of one embodiment of the present invention.

FIG. 8 shows an example of a manufacturing method of a positive electrode active material of one embodiment of the present invention.

FIG. 9 shows an example of a manufacturing method of a positive electrode active material of one embodiment of the present invention.

FIG. 10 shows an example of a manufacturing method of a positive electrode active material of one embodiment of the present invention.

FIG. 11 shows an example of a manufacturing method of a positive electrode active material of one embodiment of the present invention.

FIG. 12 shows an example of a manufacturing method of a positive electrode active material of one embodiment of the present invention.

FIG. 13A and FIG. 13B are cross-sectional views of a positive electrode active material.

FIG. 14A, FIG. 14B, and FIG. 14C are diagrams showing concentration distribution in a positive electrode active material.

FIG. 15 is a cross-sectional view illustrating an example of a positive electrode of a secondary battery.

FIG. 16A is an exploded perspective view of a coin-type secondary battery, FIG. 16B is a perspective view of the coin-type secondary battery, and FIG. 16C is a cross-sectional perspective view thereof.

FIG. 17A is an example of a cylindrical secondary battery, FIG. 17B is an example of the cylindrical secondary battery, FIG. 17C is an example of a plurality of cylindrical secondary batteries, and FIG. 17D is an example of a power storage system including the plurality of cylindrical secondary batteries.

FIG. 18A and FIG. 18B are diagrams illustrating examples of a secondary battery, and FIG. 18C is a diagram illustrating the appearance of the inside of a secondary battery.

FIG. 19A to FIG. 19C are diagrams illustrating an example of a secondary battery.

FIG. 20A and FIG. 20B are diagrams illustrating the appearance of secondary batteries.

FIG. 21A to FIG. 21C are diagrams illustrating a manufacturing method of a secondary battery.

FIG. 22A to FIG. 22C are diagrams illustrating structure examples of a battery pack.

FIG. 23A and FIG. 23B are diagrams illustrating examples of a secondary battery.

FIG. 24A to FIG. 24C are diagrams illustrating an example of a secondary battery.

FIG. 25A to FIG. 25B are diagrams illustrating an example of a secondary battery.

FIG. 26A is a perspective view of a battery pack of one embodiment of the present invention, FIG. 26B is a block diagram of the battery pack, and FIG. 26C is a block diagram of a vehicle including a motor.

FIG. 27A to FIG. 27D are diagrams illustrating examples of transport vehicles.

FIG. 28A and FIG. 28B are diagrams illustrating a power storage device of one embodiment of the present invention.

FIG. 29A is a diagram illustrating an electric bicycle, FIG. 29B is a diagram illustrating a secondary battery of the electric bicycle, and FIG. 29C is a diagram illustrating an electric motorcycle.

FIG. 30A to FIG. 30D are diagrams illustrating examples of electronic devices.

FIG. 31A illustrates examples of wearable devices, FIG. 31B is a perspective view of a watch-type device, FIG. 31C illustrates a side surface of the watch-type device, and FIG. 31D illustrates an example of wireless earphones.

### MODE FOR CARRYING OUT THE INVENTION

Embodiments of the present invention will be described in detail below with reference to the drawings. Note that the present invention is not limited to the following description, and it is readily understood by those skilled in the art that modes and details of the present invention can be modified in various ways. In addition, the present invention should not be construed as being limited to the description of the embodiments below.

A secondary battery includes a positive electrode and a negative electrode, for example. A positive electrode active material is a material included in the positive electrode. The positive electrode active material is a substance that performs a reaction contributing to the charge and discharge capacity, for example. Note that the positive electrode active material may partly include a substance that does not contribute to the charge and discharge capacity.

In this specification and the like, the positive electrode active material of one embodiment of the present invention is expressed as a positive electrode material, a secondary battery positive electrode material, a composite oxide, or the like in some cases. In this specification and the like, the positive electrode active material of one embodiment of the present invention preferably includes a compound. In this specification and the like, the positive electrode active material of one embodiment of the present invention preferably includes a composition. In this specification and the like, the positive electrode active material of one embodiment of the present invention preferably includes a composite.

In this specification and the like, segregation refers to a phenomenon in which in a solid made of a plurality of elements (e.g., A, B, and C), a certain element (e.g., B) is spatially non-uniformly distributed.

A crack in this specification includes not only a crack caused in the manufacturing process of a positive electrode active material but also a crack caused by pressure application, charging and discharging, and the like after the manufacturing process. A plane generated by a crack (may also be referred to as a split) may also be referred to as a surface.

In this specification and the like, a surface portion of a particle of an active material or the like is a region that is less than or equal to 50 nm, preferably less than or equal to 35 nm, further preferably less than or equal to 20 nm, most preferably less than or equal to 10 nm inward from the surface, for example. The region is also referred to as the vicinity of a surface in some cases. In addition, a region which is deeper than the surface portion is referred to as an inner portion.

In this specification and the like, the term “defect” refers to a crystal defect or a lattice defect. Defects include a point defect, a dislocation, a stacking fault, which is a two-dimensional defect, and a void, which is a three-dimensional defect.

In this specification and the like, particles are not necessarily spherical (with a circular cross section). Other examples of the cross-sectional shapes of particles include an ellipse, a rectangle, a trapezoid, a pyramid, a quadrilateral with rounded corners, and an asymmetrical shape, and a particle may have an indefinite shape.

In this specification and the like, the Miller index is used for the expression of crystal planes and orientations. An individual plane that shows a crystal plane is denoted by “( )”. In the crystallography, a bar is placed over a number in the expression of crystal planes, orientations, and space groups; in this specification and the like, because of application format limitations, crystal planes, orientations, and space groups are sometimes expressed by placing − (minus sign) in front of the number instead of placing a bar over the number.

In this specification and the like, a layered rock-salt crystal structure of a composite oxide containing lithium and a transition metal refers to a crystal structure in which a rock-salt ion arrangement where cations and anions are alternately arranged is included and the transition metal and lithium are regularly arranged to form a two-dimensional plane, so that lithium can diffuse two-dimensionally. Note that in the layered rock-salt crystal structure, a defect such as a cation or anion vacancy may exist. Moreover, in the layered rock-salt crystal structure, strictly, a lattice of a rock-salt crystal is distorted in some cases.

In this specification and the like, a rock-salt crystal structure refers to a structure in which cations and anions are alternately arranged. Note that in the layered rock-salt crystal structure, a cation or anion vacancy may exist.

In this specification and the like, the theoretical capacity of a positive electrode active material refers to the amount of electricity for the case where all the lithium that can be inserted and extracted in the positive electrode active material is extracted. For example, the theoretical capacity of LiCoO₂ is 274 mAh/g, the theoretical capacity of LiNiO₂ is 274 mAh/g, and the theoretical capacity of LiMn₂O₄ is 148 mAh/g.

In this specification and the like, the charge depth obtained when all the lithium that can be inserted and extracted in a positive electrode active material is inserted is 0, and the charge depth obtained when all the lithium that can be inserted and extracted in the positive electrode active material is extracted is 1.

In this specification and the like, an example in which a lithium metal is used for a counter electrode in a secondary battery including a positive electrode and a positive electrode active material of one embodiment of the present invention is described in some cases; however, the secondary battery of one embodiment of the present invention is not limited to this example. A different material such as graphite or lithium titanate may be used for a negative electrode, for example. The properties of the positive electrode and the positive electrode active material of one embodiment of the present invention, such as a crystal structure unlikely to be broken by repeated charging and discharging and excellent cycle performance, are not affected by the material of the negative electrode. A secondary battery in which a lithium metal is used for a counter electrode and charging and discharging are performed at a relatively high charging voltage of 4.6 V is described as an example of the secondary battery of one embodiment of the present invention in some cases; however, charging and discharging may be performed at a lower voltage. Charging and discharging at a lower voltage will result in cycle performance better than that described in this specification and the like.

In this specification and the like, the term “adhere” refers to a state where particles aggregate and fix through heating. The bonding of the particles is presumed to be caused by ionic bonding or the Van der Waals force; however, a state where particles aggregate and fix is called “adhesion” regardless of the heating temperature, the crystal state, the element distribution state, and the like.

In this specification and the like, the term “kiln” refers to an apparatus for heating an object. Instead of the kiln, the term “furnace”, “stove”, or “heating apparatus” may be used, for example.

In this specification and the like, a secondary battery having characteristics of purification is a secondary battery in which at least one or more materials selected from a positive electrode, a negative electrode, a separator, and an electrolyte have high purity. Furthermore, a highly purified positive electrode active material is a positive electrode active material whose material has high purity. For example, the purity of each of Li₂CO₃ and Co₃O₄, which are materials that can be used for the positive electrode active material of one embodiment of the present invention, is higher than or equal to 3N (99.9%), preferably higher than or equal to 4N (99.99%), further preferably higher than or equal to 4N5 (99.995%), still further preferably higher than or equal to 5N (99.999%).

The purity of each of LiF and MgF₂, which are materials that can be used as elements (additive elements X) that can be added to the positive electrode active material of one embodiment of the present invention, is higher than or equal to 2N (99%), preferably higher than or equal to 3N (99.9%), further preferably higher than or equal to 4N (99.99%). Furthermore, the purity of each of Ni(OH)₂ and Al(OH)₃ is higher than or equal to 3N (99.9%), preferably higher than or equal to 4N (99.99%), further preferably higher than or equal to 4N5 (99.995%), still further preferably higher than or equal to 5N (99.999%). Note that the details of the elements (additive elements X) that can be added will be described later.

Note that the positive electrode active material is sometimes referred to as a composite oxide containing lithium, a transition metal M, and oxygen (LiMO₂). As the transition metal M, a metal that can form, together with lithium, a layered rock-salt composite oxide belonging to the space group R-3m is preferably used. The details of the transition metal M will be described later.

Note that a lithium composite oxide containing Ni, Co, and Mn (NCM: lithium nickel-cobalt-manganese oxide) is a composite oxide having a layered rock-salt structure that belongs to the space group R-3m together with lithium, and includes a region having a crystal structure of the space group R-3m when a charge depth is 0 (discharged state). When the charge depth is greater than 0 and less than or equal to 1, the lithium composite oxide may have a layered structure belonging to a space group C2/m, in which case the R-3m phase and the C2/m phase may be separated from each other. A crystal in this embodiment refers to a crystal structure immediately after a crystal formation process and thus basically refers to a crystal of the R-3m phase; however, in this specification, a crystal structure having the C2/m phase or another crystal phase partly or partially is referred to as a crystal of the R-3m phase.

### Embodiment 1

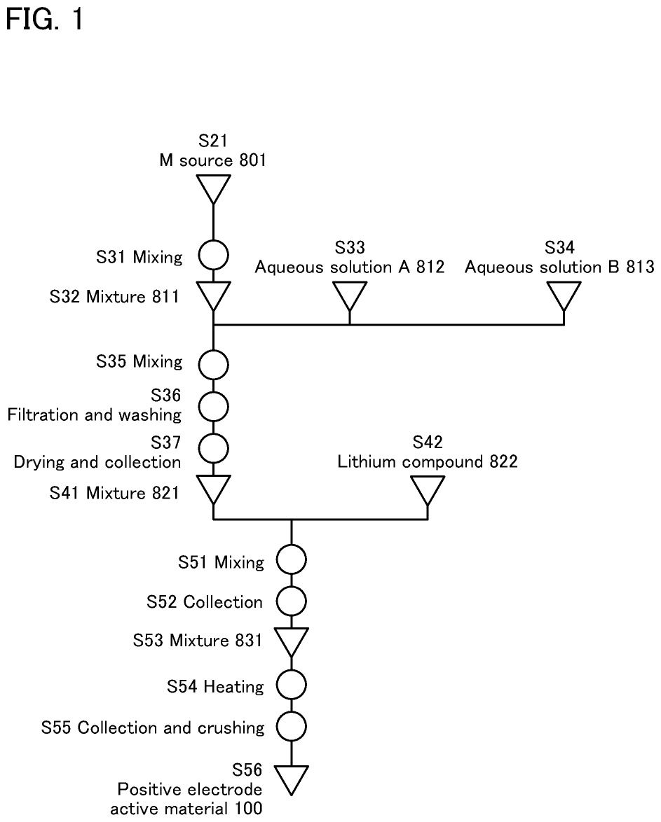

In this embodiment, an example of a manufacturing method of a positive electrode active material of one embodiment of the present invention will be described with reference to FIG. 1.

In Step S21 in FIG. 1, a transition metal M source 801 is prepared.

As the transition metal M, at least one of manganese, cobalt, and nickel can be used, for example. As the transition metal M, for example, cobalt alone; nickel alone; two metals of cobalt and manganese; two metals of cobalt and nickel; or three metals of cobalt, manganese, and nickel may be used. As the transition metal M source 801, an aqueous solution containing the transition metal M is prepared.

As the transition metal M source 801, an aqueous solution containing cobalt, such as an aqueous solution of cobalt sulfate or an aqueous solution of cobalt nitrate, can be used; an aqueous solution containing nickel, such as an aqueous solution of nickel sulfate or an aqueous solution of nickel nitrate, can be used; or an aqueous solution containing manganese, such as an aqueous solution of manganese sulfate or an aqueous solution of manganese nitrate, can be used.

For the transition metal M source 801 used in synthesis, a high-purity material is preferably used. Specifically, in the case of using the aqueous solution containing the transition metal M, the aqueous solution is formed using a solute material with a purity higher than or equal to 2N (99%), preferably higher than or equal to 3N (99.9%), further preferably higher than or equal to 4N (99.99%), and water with a specific resistance of preferably 1 MΩ·cm or higher, further preferably 10 MΩ·cm or higher, still further preferably 15 MΩ·cm or higher, which is desirably pure water containing few impurities. The use of a high-purity material can increase the capacity of a secondary battery and/or increase the reliability of the secondary battery.

In the case where a plurality of the transition metal M sources 801 are used, for example, a cobalt source, a manganese source, and a nickel source are used, the mixture ratio is preferably within a range with which a layered rock-salt crystal structure is obtained.

Next, in Step S31, the transition metal M source 801 is mixed, whereby a mixture 811 in Step S32 is obtained.

Next, an aqueous solution A 812 and an aqueous solution B 813 are prepared in Step S33 and Step S34, respectively.

As the aqueous solution A 812, any one of ammonia water and an aqueous solution containing at least one of chelating agents such as glycine, oxine, 1-nitroso-2-naphthol, and 2-mercaptobenzothiazole, or a mixed solution of a plurality of them can be used.

As the aqueous solution B 813, any one of an aqueous solution of sodium hydroxide, an aqueous solution of potassium hydroxide, and an aqueous solution of lithium hydroxide, or a mixed solution of a plurality of them can be used.

Next, in Step S35, the mixture 811 in Step S32, the aqueous solution A 812, and the aqueous solution B 813 are mixed.

As a mixing method in Step S35, a mixing method in which the mixture 811 in Step S32 and the aqueous solution B 813 are dripped into the aqueous solution A 812 that is put in a reaction container can be used. While the mixture 811 in Step S32 is dripped at a constant rate, the aqueous solution B 813 is desirably dripped as appropriate so that the pH of the mixed solution in the reaction container is kept in a predetermined range. In the mixing of Step S35, it is desirable that the solution in the reaction container be stirred with a stirring blade or a stirrer, and that dissolved oxygen in the solution in the reaction container, the mixture 811 in Step S32, the aqueous solution A 812, and the aqueous solution B 813 be removed by N₂ bubbling. In the mixing of Step S35, the pH in the reaction container is preferably greater than or equal to 9 and less than or equal to 11, further preferably greater than or equal to 10.0 and less than or equal to 10.5. In the mixing of Step S35, the temperature of the solution in the reaction container is preferably higher than or equal to 40° C. and lower than or equal to 80° C., further preferably higher than or equal to 50° C. and lower than or equal to 70° C.

Alternatively, as the mixing method in Step S35, a mixing method in which the aqueous solution A 812 and the aqueous solution B 813 are dripped into the mixture 811 in Step S32 that is put in a reaction container can be used. It is preferred to adjust the dripping rates of the aqueous solution A 812 and the aqueous solution B 813 in order to keep the concentration of hydroxyl groups and the concentration of dissolved ions of the aqueous solution A 812 in the reaction container in predetermined ranges. In the mixing of Step S35, it is desirable that the solution in the reaction container be stirred with a stirring blade or a stirrer, and that dissolved oxygen in the solution in the reaction container, the mixture 811 in Step S32, the aqueous solution A 812, and the aqueous solution B 813 be removed by N₂ bubbling. In the mixing of Step S35, the temperature of the solution in the reaction container is preferably higher than or equal to 40° C. and lower than or equal to 80° C., further preferably higher than or equal to 50° C. and lower than or equal to 70° C.

The case where the aqueous solution A 812 is not used in the mixing method in Step S35 is described. A certain amount of the aqueous solution B 813 is dripped and added to the mixture 811 in Step S32 that is put in a reaction container. In the mixing of Step S35, it is desirable that the solution in the reaction container be stirred with a stirring blade or a stirrer, and that dissolved oxygen in the solution in the reaction container, the mixture 811 in Step S32, and the aqueous solution B 813 be removed by N₂ bubbling. In the mixing of Step S35, the temperature of the solution in the reaction container is preferably higher than or equal to 40° C. and lower than or equal to 80° C., further preferably higher than or equal to 50° C. and lower than or equal to 70° C.

The case where pure water is used in addition to the mixture 811 in Step S32, the aqueous solution A 812, and the aqueous solution B 813 in the mixing method in Step S35 is described. While the mixture 811 in Step S32 and the aqueous solution A 812 are dripped into pure water that is put in a reaction container at constant rates, the aqueous solution B 813 can be dripped as appropriate so that the pH of the mixed solution in the reaction container is kept in a predetermined range. In the mixing of Step S35, it is desirable that the solution in the reaction container be stirred with a stirring blade or a stirrer, and that dissolved oxygen in the solution in the reaction container, the mixture 811 in Step S32, the aqueous solution A 812, and the aqueous solution B 813 be removed by N₂ bubbling. In the mixing of Step S35, the pH in the reaction container is preferably greater than or equal to 9 and less than or equal to 11, further preferably greater than or equal to 10.0 and less than or equal to 10.5. In the mixing of Step S35, the temperature of the solution in the reaction container is preferably higher than or equal to 40° C. and lower than or equal to 80° C., further preferably higher than or equal to 50° C. and lower than or equal to 70° C.

Next, in Step S36, a solution that is formed by the mixing in Step S35 and contains a hydroxide containing the transition metal M is filtered and then washed with water. It is desirable that the water used for the washing be pure water containing few impurities, with a specific resistance of preferably 1 MΩ·cm or higher, further preferably 10 MΩ·cm or higher, still further preferably 15 MΩ·cm or higher. The use of the pure water containing few impurities for the washing can remove impurities contained in the hydroxide containing the transition metal M. Accordingly, a high-purity hydroxide containing the transition metal M can be obtained as a precursor of a positive electrode active material 100.

Next, in Step S37, the hydroxide containing the transition metal M after the washing is dried and collected, and crushed and sieved as needed, whereby a mixture 821 in Step S41 is obtained. The mixture 821 is also referred to as the precursor of the positive electrode active material 100. The precursor preferably has high crystallinity, and further preferably includes single-crystal grains. In other words, the precursor is preferably a single crystal.

The crystallinity can be determined from, for example, a TEM (transmission electron microscope) image, a STEM (scanning transmission electron microscope) image, a HAADF-STEM (high-angle annular dark-field scanning transmission electron microscope) image, an ABF-STEM (annular bright-field scanning transmission electron microscope) image, or the like. In the crystallinity evaluation, X-ray diffraction (XRD), electron diffraction, neutron diffraction, and the like can also be used for determination.

Next, a lithium compound 822 is prepared in Step S42, and the mixture 821 in Step S41 and the lithium compound 822 are mixed in Step S51. After the mixing, the mixture is collected in Step S52, and crushed and sieved as needed, whereby a mixture 831 in Step S53 is obtained. The mixing can be performed by a dry process or a wet process. A mixer such as a planetary centrifugal mixer, a ball mill, or a bead mill can be used for the mixing, for example. In the case where a planetary centrifugal mixer Awatorirentaro manufactured by THINKY CORPORATION is used as the planetary centrifugal mixer, for example, 1.5-minute treatment at a rotational frequency of 2000 rpm is preferably repeated three times. When a ball mill is used, zirconia balls are preferably used as media, for example. When a ball mill, a bead mill, or the like is used, the peripheral speed is preferably greater than or equal to 100 mm/s and less than or equal to 2000 mm/s in order to inhibit contamination from the media or the material. For example, the mixing is preferably performed at a peripheral speed of 838 mm/s (the rotational frequency is 400 rpm, and the ball mill diameter is 40 mm).

It is preferred to perform the mixing in Step S51 sufficiently so that the mixture 821 and the lithium compound 822 can be mixed evenly.

As the lithium compound 822, lithium hydroxide, lithium carbonate, lithium nitrate, or lithium fluoride can be used, for example. The lithium compound 822 is referred to as a lithium source in some cases.

For the lithium compound 822 used in synthesis, a high-purity material is preferably used. Specifically, the purity of the material is higher than or equal to 4N (99.99%), preferably higher than or equal to 4N5UP (99.995%), further preferably higher than or equal to 5N (99.999%). The use of a high-purity material can increase the capacity of a secondary battery and/or increase the reliability of the secondary battery.

Next, in Step S54, the mixture 831 in Step S53 is heated. The heating temperature is preferably around melting points of the mixture 821 and the lithium compound 822, preferably higher than or equal to 700° C. and lower than 1100° C., further preferably higher than or equal to 800° C. and lower than or equal to 1000° C., still further preferably higher than or equal to 800° C. and lower than or equal to 950° C.

The heating time can be longer than or equal to 1 hour and shorter than or equal to 100 hours, for example, and is preferably longer than or equal to 2 hours and shorter than or equal to hours. The heating is preferably performed in oxygen or an oxygen-containing atmosphere with few moisture (e.g., with a dew point lower than or equal to −50° C., preferably lower than or equal to −80° C.), such as a dry air. In this embodiment, the heating is performed in an atmosphere with a dew point of −93° C. Furthermore, it is suitable to perform the heating in an atmosphere where the concentrations of impurities, CH₄, CO, CO₂, and H₂, are each less than or equal to 5 ppb (parts per billion), in which case impurities can be inhibited from entering the materials.

For example, when the heating is performed at 850° C. for 10 hours, the temperature rise is preferably 200° C./h and the flow rate of a dry atmosphere is preferably 10 L/min. After that, the heated materials can be cooled to room temperature. The temperature decreasing time from the specified temperature to room temperature is preferably longer than or equal to 10 hours and shorter than or equal to 50 hours, for example. Note that the cooling to room temperature in Step S54 is not essential.

Note that a crucible used in the heating in Step S54 is suitably made of a material into which impurities do not enter. In this embodiment, a crucible made of alumina with a purity of 99.9% is used.

It is suitable to collect the materials subjected to the heating in Step S54 after the materials are transferred from the crucible to a mortar because impurities are prevented from entering the materials. The mortar is suitably made of a material into which impurities do not enter. Specifically, it is suitable to use a mortar made of alumina with a purity of 90 wt % or higher, preferably 99 wt % or higher.

Next, the materials baked in the above step are collected in Step S55 and crushed, whereby the positive electrode active material 100 in Step S56 is obtained. The materials may be sieved as needed after being crushed. Through the above process, the positive electrode active material 100 of one embodiment of the present invention can be manufactured.

The positive electrode active material 100 preferably has high crystallinity; when the mixture 821 in Step S41 has high crystallinity, the positive electrode active material 100 also has high crystallinity. In the case where the positive electrode active material 100 has high crystallinity and the positive electrode active material 100 includes single-crystal grains, crystal planes where lithium enters and leaves can be aligned. A greater number of the crystal planes where lithium enters and leaves can be exposed to an electrolyte, which improves battery characteristics. Furthermore, the positive electrode active material 100 having high crystallinity and including single-crystal grains is durable; thus, an active material which does not easily deteriorate even when charging and discharging are repeated can be provided.

The positive electrode active material 100 is sometimes referred to as a composite oxide containing lithium, the transition metal M, and oxygen (LiMO₂). Note that the positive electrode active material of one embodiment of the present invention only needs to have a crystal structure of a lithium composite oxide represented by LiMO₂, and the composition is not strictly limited to Li:M:O=1:1:2. For example, in the case where three metals of cobalt, manganese, and nickel are used as the transition metals M, the positive electrode active material 100 is a composite oxide containing Ni, Co, and Mn (NCM: lithium nickel-cobalt-manganese oxide). In the NCM, the ratio of Ni:Co:Mn may be any of 1:1:1 and the neighborhood thereof, 9:0.5:0.5 and the neighborhood thereof, 8:1:1 and the neighborhood thereof, 6:2:2 and the neighborhood thereof, and 5:2:3 and the neighborhood thereof. The NCM is preferable because it has a layered rock-salt structure and has small expansion and contraction due to entering and leaving of lithium at the time of charging and discharging.

As described above, in one embodiment of the present invention, a positive electrode active material is manufactured using high-purity materials as raw materials used in synthesis and using a process which hardly allows entry of impurities in the synthesis. The positive electrode active material obtained by such a manufacturing method of a positive electrode active material is a material that has a low impurity concentration, in other words, is highly purified. Furthermore, the positive electrode active material obtained by such a manufacturing method of a positive electrode active material is a material having high crystallinity. Furthermore, the positive electrode active material obtained by the manufacturing method of a positive electrode active material, which is one embodiment of the present invention, can increase the capacity of a secondary battery and/or increase the reliability of the secondary battery.

### Embodiment 2

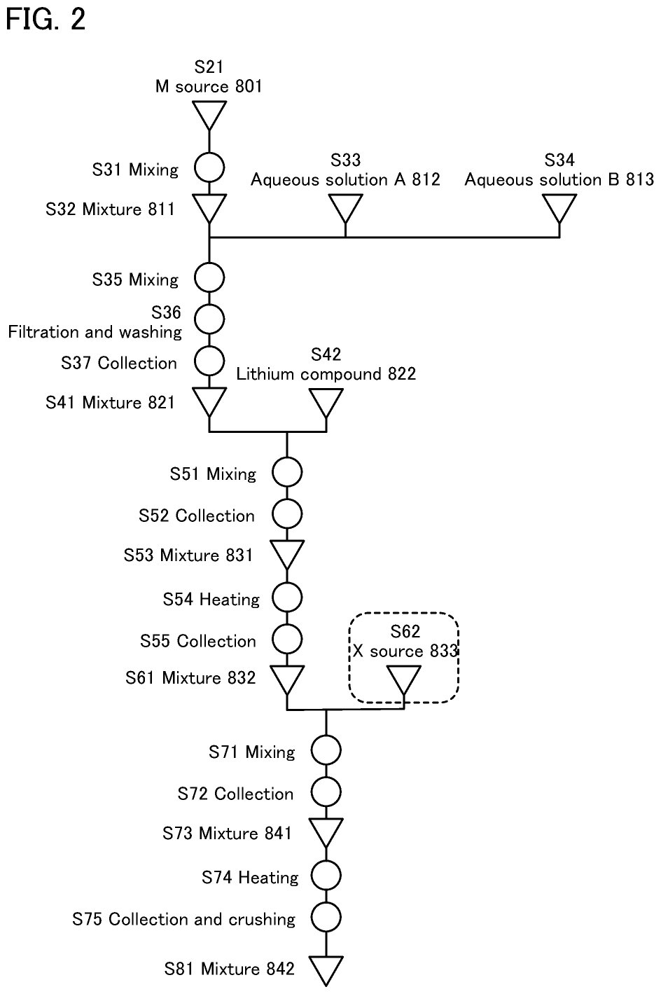

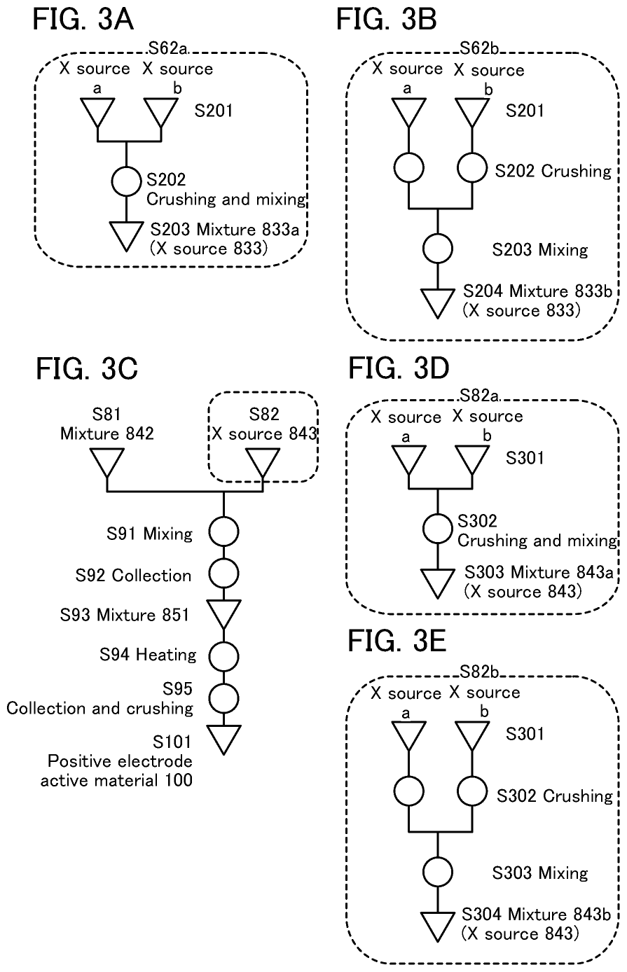

In this embodiment, an example of the manufacturing method of a positive electrode active material of one embodiment of the present invention will be described with reference to FIG. 2 and FIG. 3A to FIG. 3E.

In Step S21 in FIG. 2, the transition metal M source 801 is prepared.

As the transition metal M, at least one of manganese, cobalt, and nickel can be used, for example. As the transition metal M, for example, cobalt alone; nickel alone; two metals of cobalt and manganese; two metals of cobalt and nickel; or three metals of cobalt, manganese, and nickel may be used. As the transition metal M source 801, an aqueous solution containing the transition metal M is prepared.

As the transition metal M source 801, an aqueous solution containing cobalt, such as an aqueous solution of cobalt sulfate or an aqueous solution of cobalt nitrate, can be used; an aqueous solution containing nickel, such as an aqueous solution of nickel sulfate or an aqueous solution of nickel nitrate, can be used; or an aqueous solution containing manganese, such as an aqueous solution of manganese sulfate or an aqueous solution of manganese nitrate, can be used.

For the transition metal M source 801 used in synthesis, a high-purity material is preferably used. Specifically, in the case of using the aqueous solution containing the transition metal M, the aqueous solution is formed using a solute material with a purity higher than or equal to 2N (99%), preferably higher than or equal to 3N (99.9%), further preferably higher than or equal to 4N (99.99%), and water with a specific resistance of preferably 1 MΩ·cm or higher, further preferably 10 MΩ·cm or higher, still further preferably 15 MΩ·cm or higher, which is desirably pure water containing few impurities. The use of a high-purity material can increase the capacity of a secondary battery and/or increase the reliability of the secondary battery.

In the case where a plurality of the transition metal M sources 801 are used, for example, a cobalt source, a manganese source, and a nickel source are used, the mixture ratio is preferably within a range with which a layered rock-salt crystal structure is obtained.

Next, in Step S31, the transition metal M source 801 is mixed, whereby the mixture 811 in Step S32 is obtained.

Next, the aqueous solution A 812 and the aqueous solution B 813 are prepared in Step S33 and Step S34, respectively.

As the aqueous solution A 812, any one of ammonia water and an aqueous solution containing at least one of chelating agents such as glycine, oxine, 1-nitroso-2-naphthol, and 2-mercaptobenzothiazole, or a mixed solution of a plurality of them can be used.

As the aqueous solution B 813, any one of an aqueous solution of sodium hydroxide, an aqueous solution of potassium hydroxide, and an aqueous solution of lithium hydroxide, or a mixed solution of a plurality of them can be used.

Next, in Step S35, the mixture 811 in Step S32, the aqueous solution A 812, and the aqueous solution B 813 are mixed.

As a mixing method in Step S35, a mixing method in which the mixture 811 in Step S32 and the aqueous solution B 813 are dripped into the aqueous solution A 812 that is put in a reaction container can be used. While the mixture 811 in Step S32 is dripped at a constant rate, the aqueous solution B 813 is desirably dripped as appropriate so that the pH of the mixed solution in the reaction container is kept in a predetermined range. In the mixing of Step S35, it is desirable that the solution in the reaction container be stirred with a stirring blade or a stirrer, and that dissolved oxygen in the solution in the reaction container, the mixture 811 in Step S32, the aqueous solution A 812, and the aqueous solution B 813 be removed by N₂ bubbling. In the mixing of Step S35, the pH in the reaction container is preferably greater than or equal to 9 and less than or equal to 11, further preferably greater than or equal to 10.0 and less than or equal to 10.5. In the mixing of Step S35, the temperature of the solution in the reaction container is preferably higher than or equal to 40° C. and lower than or equal to 80° C., further preferably higher than or equal to 50° C. and lower than or equal to 70° C.

Alternatively, as the mixing method in Step S35, a mixing method in which the aqueous solution A 812 and the aqueous solution B 813 are dripped into the mixture 811 in Step S32 that is put in a reaction container can be used. It is preferred to adjust the dripping rates of the aqueous solution A 812 and the aqueous solution B 813 in order to keep the concentration of hydroxyl groups and the concentration of dissolved ions of the aqueous solution A 812 in the reaction container in predetermined ranges. In the mixing of Step S35, it is desirable that the solution in the reaction container be stirred with a stirring blade or a stirrer, and that dissolved oxygen in the solution in the reaction container, the mixture 811 in Step S32, the aqueous solution A 812, and the aqueous solution B 813 be removed by N₂ bubbling. In the mixing of Step S35, the temperature of the solution in the reaction container is preferably higher than or equal to 40° C. and lower than or equal to 80° C., further preferably higher than or equal to 50° C. and lower than or equal to 70° C.

The case where the aqueous solution A 812 is not used in the mixing method in Step S35 is described. A certain amount of the aqueous solution B 813 is dripped and added to the mixture 811 in Step S32 that is put in a reaction container. In the mixing of Step S35, it is desirable that the solution in the reaction container be stirred with a stirring blade or a stirrer, and that dissolved oxygen in the solution in the reaction container, the mixture 811 in Step S32, and the aqueous solution B 813 be removed by N₂ bubbling. In the mixing of Step S35, the temperature of the solution in the reaction container is preferably higher than or equal to 40° C. and lower than or equal to 80° C., further preferably higher than or equal to 50° C. and lower than or equal to 70° C.

The case where pure water is used in addition to the mixture 811 in Step S32, the aqueous solution A 812, and the aqueous solution B 813 in the mixing method in Step S35 is described. While the mixture 811 in Step S32 and the aqueous solution A 812 are dripped into pure water that is put in a reaction container at constant rates, the aqueous solution B 813 can be dripped as appropriate so that the pH of the mixed solution in the reaction container is kept in a predetermined range. In the mixing of Step S35, it is desirable that the solution in the reaction container be stirred with a stirring blade or a stirrer, and that dissolved oxygen in the solution in the reaction container, the mixture 811 in Step S32, the aqueous solution A 812, and the aqueous solution B 813 be removed by N₂ bubbling. In the mixing of Step S35, the pH in the reaction container is preferably greater than or equal to 9 and less than or equal to 11, further preferably greater than or equal to 10.0 and less than or equal to 10.5. In the mixing of Step S35, the temperature of the solution in the reaction container is preferably higher than or equal to 40° C. and lower than or equal to 80° C., further preferably higher than or equal to 50° C. and lower than or equal to 70° C.

Next, in Step S36, a solution that is formed by the mixing in Step S35 and contains a hydroxide containing the transition metal M is filtered and then washed with water. It is desirable that the water used for the washing be pure water containing few impurities, with a specific resistance of preferably 1 MΩ·cm or higher, further preferably 10 MΩ·cm or higher, still further preferably 15 MΩ·cm or higher. The use of the pure water containing few impurities for the washing can remove impurities contained in the hydroxide containing the transition metal M. Accordingly, a high-purity hydroxide containing the transition metal M can be obtained as a precursor of the positive electrode active material 100.

Next, in Step S37, the hydroxide containing the transition metal M after the washing is dried and collected, and crushed or sieved as needed, whereby the mixture 821 in Step S41 is obtained. The mixture 821 is also referred to as the precursor of the positive electrode active material 100. The precursor preferably has high crystallinity, and further preferably includes single-crystal grains. In other words, the precursor is preferably a single crystal.

Next, the lithium compound 822 is prepared in Step S42, and the mixture 821 in Step S41 and the lithium compound 822 are mixed in Step S51. After the mixing, the mixture is collected in Step S52, and crushed and sieved as needed, whereby the mixture 831 in Step S53 is obtained. The mixing can be performed by a dry process or a wet process. A mixer such as a planetary centrifugal mixer, a ball mill, or a bead mill can be used for the mixing, for example. In the case where a planetary centrifugal mixer Awatorirentaro manufactured by THINKY CORPORATION is used as the planetary centrifugal mixer, for example, 1.5-minute treatment at a rotational frequency of 2000 rpm is preferably repeated three times. When a ball mill is used, zirconia balls are preferably used as media, for example. When a ball mill, a bead mill, or the like is used, the peripheral speed is preferably greater than or equal to 100 mm/s and less than or equal to 2000 mm/s in order to inhibit contamination from the media or the material. For example, the mixing is preferably performed at a peripheral speed of 838 mm/s (the rotational frequency is 400 rpm, and the ball mill diameter is 40 mm).

It is preferred to perform the mixing in Step S51 sufficiently so that the mixture 821 and the lithium compound 822 can be mixed evenly.

As the lithium compound 822, lithium hydroxide, lithium carbonate, lithium nitrate, or lithium fluoride can be used, for example. The lithium compound 822 is referred to as a lithium source in some cases.

For the lithium compound 822 used in synthesis, a high-purity material is preferably used. Specifically, the purity of the material is higher than or equal to 4N (99.99%), preferably higher than or equal to 4N5UP (99.995%), further preferably higher than or equal to 5N (99.999%). The use of a high-purity material can increase the capacity of a secondary battery and/or increase the reliability of the secondary battery.

Next, in Step S54, the mixture 831 in Step S53 is heated. The heating temperature is preferably around melting points of the mixture 821 and the lithium compound 822, preferably higher than or equal to 700° C. and lower than 1100° C., further preferably higher than or equal to 800° C. and lower than or equal to 1000° C., still further preferably higher than or equal to 800° C. and lower than or equal to 950° C.

The heating time can be longer than or equal to 1 hour and shorter than or equal to 100 hours, for example, and is preferably longer than or equal to 2 hours and shorter than or equal to hours. The heating is preferably performed in oxygen or an oxygen-containing atmosphere with few moisture (e.g., with a dew point lower than or equal to −50° C., preferably lower than or equal to −80° C.), such as a dry air. In this embodiment, the heating is performed in an atmosphere with a dew point of −93° C. Furthermore, it is suitable to perform the heating in an atmosphere where the concentrations of impurities, CH₄, CO, CO₂, and H₂, are each less than or equal to 5 ppb (parts per billion), in which case impurities can be inhibited from entering the materials.

For example, when the heating is performed at 850° C. for 10 hours, the temperature rise is preferably 200° C./h and the flow rate of a dry atmosphere is preferably 10 L/min. After that, the heated materials can be cooled to room temperature. The temperature decreasing time from the specified temperature to room temperature is preferably longer than or equal to 10 hours and shorter than or equal to 50 hours, for example. Note that the cooling to room temperature in Step S54 is not essential.

Note that a crucible used in the heating in Step S54 is suitably made of a material into which impurities do not enter. In this embodiment, a crucible made of alumina with a purity of 99.9% is used.

It is suitable to collect the materials subjected to the heating in Step S54 after the materials are transferred from the crucible to a mortar because impurities are prevented from entering the materials. The mortar is suitably made of a material into which impurities do not enter. Specifically, it is suitable to use a mortar made of alumina with a purity of 90 wt % or higher, preferably 99 wt % or higher. Note that conditions equivalent to those in Step S54 can be employed in an after-mentioned heating step other than Step S54.

Next, in Step S62, an additive element X source 833 is prepared.

As an additive element X contained in the additive element X source 833, one or more selected from nickel, cobalt, magnesium, calcium, chlorine, fluorine, aluminum, manganese, titanium, zirconium, yttrium, vanadium, iron, chromium, niobium, lanthanum, hafnium, zinc, silicon, sulfur, phosphorus, boron, and arsenic can be used. In addition to the above elements, bromine and beryllium may be used as the additive elements X Note that the additive elements X given earlier are more suitable because bromine and beryllium are elements having toxicity to living things.

As the additive element X source 833 in Step S62 in FIG. 2, any one or more of an aqueous solution containing the additive element X, an alkoxide containing the additive element X, and a solid compound containing the additive element X can be used. For example, as shown in S62a or S62b in FIG. 3A and FIG. 3B, one or more solid compounds each containing the additive element X may be prepared, crushing and mixing may be performed, and the mixture (a mixture 833a or a mixture 833b) may be used as the additive element X source 833 in Step S62 in FIG. 2. In the case of using one or more solid compounds each containing the additive element X, mixing may be performed after crushing, crushing may be performed after mixing, or the solid compounds may be used as the additive element X source 833 in Step S62 without being subjected to crushing.

For the additive element X source used in synthesis, a high-purity material is preferably used. Specifically, the purity of the material is higher than or equal to 2N (99%), preferably higher than or equal to 3N (99.9%), further preferably higher than or equal to 4N (99.99%). The use of a high-purity material can increase the capacity of a secondary battery and/or increase the reliability of the secondary battery.

In the case where the mixing and crushing step is performed by a wet method, a solvent is prepared. As the solvent, ketone such as acetone, alcohol such as ethanol or isopropanol, ether, dioxane, acetonitrile, N-methyl-2-pyrrolidone (NMP), or the like can be used. An aprotic solvent that hardly reacts with lithium is further preferably used. In this embodiment, dehydrated acetone with a purity of higher than or equal to 99.5% is used.

Next, in Step S71 in FIG. 2, a mixture 832 in Step S61 and the additive element X source 833 in Step S62 are mixed. After the mixing, the mixture is collected in Step S72, and crushed and sieved as needed, whereby a mixture 841 in Step S73 is obtained. The mixing can be performed by a dry process or a wet process. A mixer such as a planetary centrifugal mixer, a ball mill, or a bead mill can be used for the mixing, for example. In the case where a planetary centrifugal mixer Awatorirentaro manufactured by THINKY CORPORATION is used as the planetary centrifugal mixer, for example, 1.5-minute treatment at a rotational frequency of 2000 rpm is preferably repeated three times. When a ball mill is used, zirconia balls are preferably used as media, for example. When a ball mill, a bead mill, or the like is used, the peripheral speed is preferably greater than or equal to 100 mm/s and less than or equal to 2000 mm/s in order to inhibit contamination from the media or the material. For example, the mixing is preferably performed at a peripheral speed of 838 mm/s (the rotational frequency is 400 rpm, and the ball mill diameter is 40 mm).

Next, in Step S74, the mixture 841 in Step S73 is heated. In the heating, a container (crucible) containing the mixture 841 is preferably covered with a lid. Unnecessary evaporation of the raw materials can be prevented. The temperature of the heating in Step S74 is preferably higher than or equal to 500° C. and lower than or equal to 1100° C., further preferably higher than or equal to 500° C. and lower than or equal to 1000° C., still further preferably higher than or equal to 500° C. and lower than or equal to 950° C., yet still further preferably higher than or equal to 500° C. and lower than or equal to 900° C.

As the heating in Step S74, heating by a roller hearth kiln may be performed. When heat treatment is performed by a roller hearth kiln, the mixture 841 may be processed using a heat-resistant container having a lid.

The heating time can be longer than or equal to 1 hour and shorter than or equal to 100 hours, for example, and is preferably longer than or equal to 2 hours and shorter than or equal to hours. The heating is preferably performed in oxygen or an oxygen-containing atmosphere with few moisture (e.g., with a dew point lower than or equal to −50° C., preferably lower than or equal to −80° C.), such as a dry air. In this embodiment, the heating is performed in an atmosphere with a dew point of −93° C. Furthermore, it is suitable to perform the heating in an atmosphere where the concentrations of impurities, CH₄, CO, CO₂, and H₂, are each less than or equal to 5 ppb (parts per billion), in which case impurities can be inhibited from entering the materials.

For example, when the heating is performed at 850° C. for 10 hours, the temperature rise is preferably 200° C./h and the flow rate of a dry atmosphere is preferably 10 L/min. After that, the heated materials can be cooled to room temperature. The temperature decreasing time from the specified temperature to room temperature is preferably longer than or equal to 10 hours and shorter than or equal to 50 hours, for example. Note that the cooling to room temperature in Step S74 is not essential.

Next, the materials baked in the above step are collected, and crushed and sieved as needed in Step S75, whereby a mixture 842 in Step S81 is obtained. The mixture 842 obtained in Step S81 can be used as the positive electrode active material 100. The mixture 842 obtained in Step S81 can be provided for steps after Step S81 shown in FIG. 3C.

Next, the steps after Step S81 shown in FIG. 3C are described. In Step S82, an additive element X source 843 is prepared.

The additive element X added in Step S82 can be selected from the above-described additive elements X to be used. As the additive element X source 843 in Step S82, any one or more of an aqueous solution containing the additive element X, an alkoxide containing the additive element X, and a solid compound containing the additive element X can be used. For example, as shown in S82a or S82b in FIG. 3D and FIG. 3E, one or more solid compounds each containing the additive element X may be prepared, crushing and mixing may be performed, and the mixture (a mixture 843a or a mixture 843b) may be used as the additive element X source 843 in Step S82 in FIG. 3C. In the case of using one or more solid compounds each containing the additive element X, mixing may be performed after crushing, crushing may be performed after mixing, or the solid compounds may be used as the additive element X source 843 in Step S82 without being subjected to crushing.

For the additive element X source used in synthesis, a high-purity material is preferably used. Specifically, the purity of the material is higher than or equal to 2N (99%), preferably higher than or equal to 3N (99.9%), further preferably higher than or equal to 4N (99.99%). The use of a high-purity material can increase the capacity of a secondary battery and/or increase the reliability of the secondary battery.

Next, in Step S91 in FIG. 3C, the mixture 842 in Step S81 and the additive element X source 843 in Step S82 are mixed. After the mixing, the mixture is collected in Step S92, and crushed and sieved as needed, whereby a mixture 851 in Step S93 is obtained. The mixing can be performed by a dry process or a wet process. A mixer such as a planetary centrifugal mixer, a ball mill, or a bead mill can be used for the mixing, for example. In the case where a planetary centrifugal mixer Awatorirentaro manufactured by THINKY CORPORATION is used as the planetary centrifugal mixer, for example, 1.5-minute treatment at a rotational frequency of 2000 rpm is preferably repeated three times. When a ball mill is used, zirconia balls are preferably used as media, for example. When a ball mill, a bead mill, or the like is used, the peripheral speed is preferably greater than or equal to 100 mm/s and less than or equal to 2000 mm/s in order to inhibit contamination from the media or the material. For example, the mixing is preferably performed at a peripheral speed of 838 mm/s (the rotational frequency is 400 rpm, and the ball mill diameter is 40 mm).

In this embodiment, the mixing is performed with a ball mill using zirconia balls with a diameter of 1 mm by a dry method at 150 rpm for 1 hour. The mixing is performed in a dry room the dew point of which is higher than or equal to −100° C. and lower than or equal to −10° C.

Next, in Step S94, the mixture 851 in Step S93 is heated. The temperature of the heating in Step S94 is preferably higher than or equal to 500° C. and lower than or equal to 1130° C., further preferably higher than or equal to 500° C. and lower than or equal to 1000° C., still further preferably higher than or equal to 500° C. and lower than or equal to 950° C., yet still further preferably higher than or equal to 500° C. and lower than or equal to 900° C.

The heating time can be longer than or equal to 1 hour and shorter than or equal to 100 hours, for example, and is preferably longer than or equal to 2 hours and shorter than or equal to 20 hours. The heating is preferably performed in oxygen or an oxygen-containing atmosphere with few moisture (e.g., with a dew point lower than or equal to −50° C., preferably lower than or equal to −80° C.), such as a dry air. In this embodiment, the heating is performed in an atmosphere with a dew point of −93° C. Furthermore, it is suitable to perform the heating in an atmosphere where the concentrations of impurities, CH₄, CO, CO₂, and H₂, are each less than or equal to 5 ppb (parts per billion), in which case impurities can be inhibited from entering the materials.

For example, when the heating is performed at 850° C. for 10 hours, the temperature rise is preferably 200° C./h and the flow rate of a dry atmosphere is preferably 10 L/min. After that, the heated materials can be cooled to room temperature. The temperature decreasing time from the specified temperature to room temperature is preferably longer than or equal to 10 hours and shorter than or equal to 50 hours, for example.

Note that the cooling to room temperature in Step S94 is not essential. As long as later steps are performed without problems, it is possible to perform cooling to a temperature higher than room temperature.

Next, the materials baked in the above step are collected and crushed in Step S95, whereby the positive electrode active material 100 in Step S101 is obtained. The materials may be sieved as needed after being crushed. Through the above process, the positive electrode active material 100 of one embodiment of the present invention can be manufactured.

The positive electrode active material 100 preferably has high crystallinity; when the mixture 821 in Step S41 has high crystallinity, the positive electrode active material 100 also has high crystallinity. In the case where the positive electrode active material 100 has high crystallinity and the positive electrode active material 100 includes single-crystal grains, crystal planes where lithium enters and leaves can be aligned. A greater number of the crystal planes where lithium enters and leaves can be exposed to an electrolyte, which improves battery characteristics. Furthermore, the positive electrode active material 100 having high crystallinity and including single-crystal grains is durable; thus, an active material which does not easily deteriorate even when charging and discharging are repeated can be provided.

The positive electrode active material 100 is sometimes referred to as a composite oxide containing lithium, the transition metal M, and oxygen (LiMO₂). Note that the positive electrode active material of one embodiment of the present invention only needs to have a crystal structure of a lithium composite oxide represented by LiMO₂, and the composition is not strictly limited to Li:M:O=1:1:2. For example, in the case where three metals of cobalt, manganese, and nickel are used as the transition metals M and aluminum is used as the additive element X, the positive electrode active material 100 is a composite oxide containing Ni, Co, Mn, and Al (referred to as an NCMA). The NCMA may be obtained by adding Al to an NCM in which the ratio of Ni:Co:Mn is any of 1:1:1 and the neighborhood thereof, 9:0.5:0.5 and the neighborhood thereof, 8:1:1 and the neighborhood thereof, 6:2:2 and the neighborhood thereof, and 5:2:3 and the neighborhood thereof. In the case where Ni:Co:Mn is 8:1:1 and the neighborhood thereof, for example, the aluminum concentration is preferably higher than or equal to 0.1 at % and lower than or equal to 2 at %.

When the step of introducing the transition metal M and the steps of introducing the additive elements X are separately performed as shown in FIG. 2 and FIG. 3A to FIG. 3E, the element concentration profiles in the depth direction can be made different from each other in some cases. For example, the concentration of each of the additive elements X can be made higher in the surface portion than in the inner portion of a particle. Furthermore, with the number of atoms of the transition metal M as a reference, the ratio of the number of atoms of each of the additive elements X with respect to the reference can be higher in the surface portion than in the inner portion. In the NCMA, a region with an aluminum concentration higher than or equal to 0.1 at % and lower than or equal to 2 at % may be in either the surface portion or the inner portion of the particle.

In one embodiment of the present invention, a positive electrode active material is manufactured using a high-purity material for the transition metal M source used in synthesis and using a process which hardly allows entry of impurities in the synthesis. The manufacturing method in which entry of impurities into the transition metal M source and entry of impurities in the synthesis are thoroughly prevented and in which desired additive elements X are controlled to be introduced into the positive electrode active material can provide a positive electrode active material in which a region with a low impurity concentration and a region where the additive elements are introduced are controlled. The positive electrode active material described in this embodiment is a material having high crystallinity. Furthermore, the positive electrode active material obtained by the manufacturing method of a positive electrode active material, which is one embodiment of the present invention, can increase the capacity of a secondary battery and/or increase the reliability of the secondary battery.

### Embodiment 3

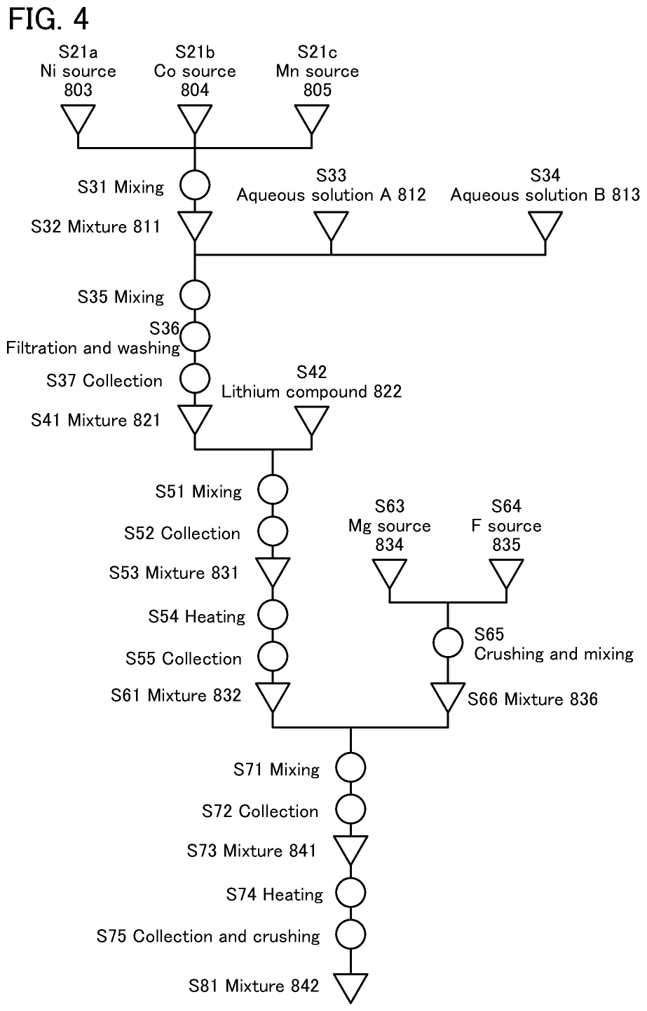

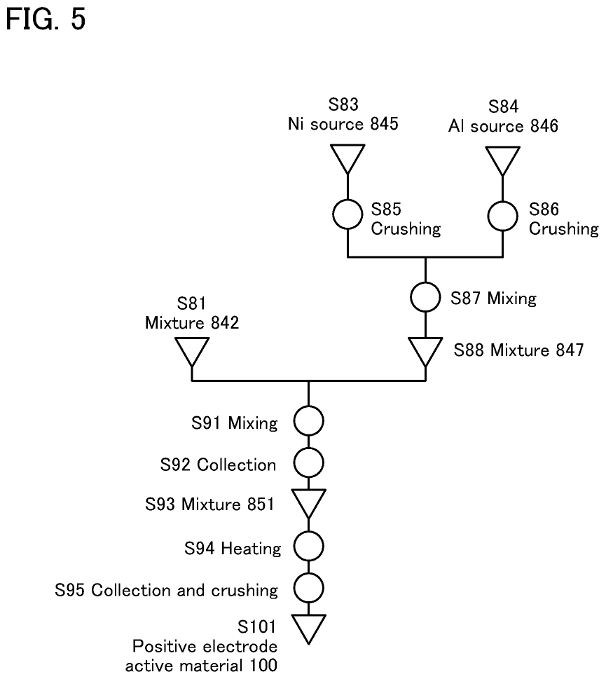

In this embodiment, an example of the manufacturing method of a positive electrode active material of one embodiment of the present invention will be described with reference to FIG. 4 and FIG. 5.

In Step S21a, Step S21b, and Step 21c in FIG. 4, transition metal M sources are prepared. In this embodiment, the case where three transition metal M sources, a nickel source 803, a cobalt source 804, and a manganese source 805, are used as the transition metal M sources will be described.

As the nickel source 803, an aqueous solution containing nickel, such as an aqueous solution of nickel sulfate or an aqueous solution of nickel nitrate, can be used. As the cobalt source 804, an aqueous solution containing cobalt, such as an aqueous solution of cobalt sulfate or an aqueous solution of cobalt nitrate, can be used. As the manganese source 805, an aqueous solution containing manganese, such as an aqueous solution of manganese sulfate or an aqueous solution of manganese nitrate, can be used.

For the nickel source 803, the cobalt source 804, and the manganese source 805 used in synthesis, high-purity materials are preferably used. Specifically, in the case of using aqueous solutions containing the nickel source 803, the cobalt source 804, and the manganese source 805, the aqueous solutions are formed using solute materials with a purity higher than or equal to 2N (99%), preferably higher than or equal to 3N (99.9%), further preferably higher than or equal to 4N (99.99%), and water with a specific resistance of preferably 1 MΩ·cm or higher, further preferably 10 MΩ·cm or higher, still further preferably 15 MΩ·cm or higher, which is desirably pure water containing few impurities. The use of high-purity materials can increase the capacity of a secondary battery and/or increase the reliability of the secondary battery.

In the case where a plurality of the transition metal M sources 801 are used, for example, a cobalt source, a manganese source, and a nickel source are used, the mixture ratio is preferably within a range with which a layered rock-salt crystal structure is obtained.

Next, in Step S31, the nickel source 803, the cobalt source 804, and the manganese source 805 are mixed, whereby the mixture 811 in Step S32 is obtained.

Next, the aqueous solution A 812 and the aqueous solution B 813 are prepared in Step S33 and Step S34, respectively.

As the aqueous solution A 812, any one of ammonia water and an aqueous solution containing at least one of chelating agents such as glycine, oxine, 1-nitroso-2-naphthol, and 2-mercaptobenzothiazole, or a mixed solution of a plurality of them can be used.

As the aqueous solution B 813, any one of an aqueous solution of sodium hydroxide, an aqueous solution of potassium hydroxide, and an aqueous solution of lithium hydroxide, or a mixed solution of a plurality of them can be used.

Next, in Step S35, the mixture 811 in Step S32, the aqueous solution A 812, and the aqueous solution B 813 are mixed.

As a mixing method in Step S35, a mixing method in which the mixture 811 in Step S32 and the aqueous solution B 813 are dripped into the aqueous solution A 812 that is put in a reaction container can be used. While the mixture 811 in Step S32 is dripped at a constant rate, the aqueous solution B 813 is desirably dripped as appropriate so that the pH of the mixed solution in the reaction container is kept in a predetermined range. In the mixing of Step S35, it is desirable that the solution in the reaction container be stirred with a stirring blade or a stirrer, and that dissolved oxygen in the solution in the reaction container, the mixture 811 in Step S32, the aqueous solution A 812, and the aqueous solution B 813 be removed by N₂ bubbling. In the mixing of Step S35, the pH in the reaction container is preferably greater than or equal to 9 and less than or equal to 11, further preferably greater than or equal to 10.0 and less than or equal to 10.5. In the mixing of Step S35, the temperature of the solution in the reaction container is preferably higher than or equal to 40° C. and lower than or equal to 80° C., further preferably higher than or equal to 50° C. and lower than or equal to 70° C.

Alternatively, as the mixing method in Step S35, a mixing method in which the aqueous solution A 812 and the aqueous solution B 813 are dripped into the mixture 811 in Step S32 that is put in a reaction container can be used. It is preferred to adjust the dripping rates of the aqueous solution A 812 and the aqueous solution B 813 in order to keep the concentration of hydroxyl groups and the concentration of dissolved ions of the aqueous solution A 812 in the reaction container in predetermined ranges. In the mixing of Step S35, it is desirable that the solution in the reaction container be stirred with a stirring blade or a stirrer, and that dissolved oxygen in the solution in the reaction container, the mixture 811 in Step S32, the aqueous solution A 812, and the aqueous solution B 813 be removed by N₂ bubbling. In the mixing of Step S35, the temperature of the solution in the reaction container is preferably higher than or equal to 40° C. and lower than or equal to 80° C., further preferably higher than or equal to 50° C. and lower than or equal to 70° C.

The case where the aqueous solution A 812 is not used in the mixing method in Step S35 is described. A certain amount of the aqueous solution B 813 is dripped and added to the mixture 811 in Step S32 that is put in a reaction container. In the mixing of Step S35, it is desirable that the solution in the reaction container be stirred with a stirring blade or a stirrer, and that dissolved oxygen in the solution in the reaction container, the mixture 811 in Step S32, and the aqueous solution B 813 be removed by N₂ bubbling. In the mixing of Step S35, the temperature of the solution in the reaction container is preferably higher than or equal to 40° C. and lower than or equal to 80° C., further preferably higher than or equal to 50° C. and lower than or equal to 70° C.

The case where pure water is used in addition to the mixture 811 in Step S32, the aqueous solution A 812, and the aqueous solution B 813 in the mixing method in Step S35 is described. While the mixture 811 in Step S32 and the aqueous solution A 812 are dripped into pure water that is put in a reaction container at constant rates, the aqueous solution B 813 can be dripped as appropriate so that the pH of the mixed solution in the reaction container is kept in a predetermined range. In the mixing of Step S35, it is desirable that the solution in the reaction container be stirred with a stirring blade or a stirrer, and that dissolved oxygen in the solution in the reaction container, the mixture 811 in Step S32, the aqueous solution A 812, and the aqueous solution B 813 be removed by N₂ bubbling. In the mixing of Step S35, the pH in the reaction container is preferably greater than or equal to 9 and less than or equal to 11, further preferably greater than or equal to 10.0 and less than or equal to 10.5. In the mixing of Step S35, the temperature of the solution in the reaction container is preferably higher than or equal to 40° C. and lower than or equal to 80° C., further preferably higher than or equal to 50° C. and lower than or equal to 70° C.

Next, in Step S36, a solution that is formed by the mixing in Step S35 and contains a hydroxide containing nickel, cobalt, and manganese is filtered and then washed with water. It is desirable that the water used for the washing be pure water containing few impurities, with a specific resistance of preferably 1 MΩ·cm or higher, further preferably 10 MΩ·cm or higher, still further preferably 15M Ω cm or higher. The use of the pure water containing few impurities for the washing can remove impurities contained in the hydroxide containing nickel, cobalt, and manganese. Accordingly, a high-purity hydroxide containing nickel, cobalt, and manganese can be obtained as a precursor of the positive electrode active material 100.

Next, in Step S37, the hydroxide containing nickel, cobalt, and manganese after the washing is dried and collected, and crushed or sieved as needed, whereby the mixture 821 in Step S41 is obtained. The mixture 821 is also referred to as the precursor of the positive electrode active material 100. The precursor preferably has high crystallinity, and further preferably includes single-crystal grains. In other words, the precursor is preferably a single crystal.

Next, the lithium compound 822 is prepared in Step S42, and the mixture 821 in Step S41 and the lithium compound 822 are mixed in Step S51. After the mixing, the mixture is collected in Step S52, and crushed and sieved as needed, whereby the mixture 831 in Step S53 is obtained. The mixing can be performed by a dry process or a wet process. A mixer such as a planetary centrifugal mixer, a ball mill, or a bead mill can be used for the mixing, for example. In the case where a planetary centrifugal mixer Awatorirentaro manufactured by THINKY CORPORATION is used as the planetary centrifugal mixer, for example, 1.5-minute treatment at a rotational frequency of 2000 rpm is preferably repeated three times. When a ball mill is used, zirconia balls are preferably used as media, for example. When a ball mill, a bead mill, or the like is used, the peripheral speed is preferably greater than or equal to 100 mm/s and less than or equal to 2000 mm/s in order to inhibit contamination from the media or the material. For example, the mixing is preferably performed at a peripheral speed of 838 mm/s (the rotational frequency is 400 rpm, and the ball mill diameter is 40 mm).

It is preferred to perform the mixing in Step S51 sufficiently so that the mixture 821 and the lithium compound 822 can be mixed evenly.

As the lithium compound 822, lithium hydroxide, lithium carbonate, lithium nitrate, or lithium fluoride can be used, for example. The lithium compound 822 is referred to as a lithium source in some cases.

For the lithium compound 822 used in synthesis, a high-purity material is preferably used. Specifically, the purity of the material is higher than or equal to 4N (99.99%), preferably higher than or equal to 4N5UP (99.995%), further preferably higher than or equal to 5N (99.999%). The use of a high-purity material can increase the capacity of a secondary battery and/or increase the reliability of the secondary battery.

Next, in Step S54, the mixture 831 in Step S53 is heated. The heating temperature is preferably around melting points of the mixture 821 and the lithium compound 822, preferably higher than or equal to 700° C. and lower than 1100° C., further preferably higher than or equal to 800° C. and lower than or equal to 1000° C., still further preferably higher than or equal to 800° C. and lower than or equal to 950° C.

The heating time can be longer than or equal to 1 hour and shorter than or equal to 100 hours, for example, and is preferably longer than or equal to 2 hours and shorter than or equal to hours. The heating is preferably performed in oxygen or an oxygen-containing atmosphere with few moisture (e.g., with a dew point lower than or equal to −50° C., preferably lower than or equal to −80° C.), such as a dry air. In this embodiment, the heating is performed in an atmosphere with a dew point of −93° C. Furthermore, it is suitable to perform the heating in an atmosphere where the concentrations of impurities, CH₄, CO, CO₂, and H₂, are each less than or equal to 5 ppb (parts per billion), in which case impurities can be inhibited from entering the materials.

For example, when the heating is performed at 850° C. for 10 hours, the temperature rise is preferably 200° C./h and the flow rate of a dry atmosphere is preferably 10 L/min. After that, the heated materials can be cooled to room temperature. The temperature decreasing time from the specified temperature to room temperature is preferably longer than or equal to 10 hours and shorter than or equal to 50 hours, for example. Note that the cooling to room temperature in Step S54 is not essential.

Note that a crucible used in the heating in Step S54 is suitably made of a material into which impurities do not enter. In this embodiment, a crucible made of alumina with a purity of 99.9% is used.

It is suitable to collect the materials subjected to the heating in Step S54 after the materials are transferred from the crucible to a mortar because impurities are prevented from entering the materials. The mortar is suitably made of a material into which impurities do not enter. Specifically, it is suitable to use a mortar made of alumina with a purity of 90 wt % or higher, preferably 99 wt % or higher. Note that conditions equivalent to those in Step S54 can be employed in an after-mentioned heating step other than Step S54.

Next, the materials baked in the above step are collected in Step S55 and crushed and sieved as needed, whereby the mixture 832 in Step S61 is obtained.

Next, in Step S63 and Step S64, a magnesium source 834 and a fluorine source 835 are prepared as additive element X sources. Subsequently, the magnesium source 834 and the fluorine source 835 are crushed and mixed in Step S65, whereby a mixture 836 in Step S66 is obtained.

As the magnesium source 834, for example, magnesium fluoride, magnesium oxide, magnesium hydroxide, or magnesium carbonate can be used.

As the fluorine source 835, for example, lithium fluoride (LiF), magnesium fluoride (MgF₂), aluminum fluoride (AlF₃), titanium fluoride (TiF₄), cobalt fluoride (CoF₂ or CoF₃), nickel fluoride (NiF₂), zirconium fluoride (ZrF₄), vanadium fluoride (VF₅), manganese fluoride, iron fluoride, chromium fluoride, niobium fluoride, zinc fluoride (ZnF₂), calcium fluoride (CaF₂), sodium fluoride (NaF), potassium fluoride (KF), barium fluoride (BaF₂), cerium fluoride (CeF₂), lanthanum fluoride (LaF₃), sodium aluminum hexafluoride (Na₃AlF₆), or the like can be used. The fluorine source is not limited to a solid, and for example, fluorine (F₂), carbon fluoride, sulfur fluoride, oxygen fluoride (OF₂, O₂F₂, O₃F₂, O₄F₂, or O₂F), or the like may be used and mixed in the atmosphere in a heating step described later. A plurality of fluorine sources may be mixed to be used. Among them, lithium fluoride, which has a relatively low melting point of 848° C., is preferable because it is easily melted in an annealing process described later.

In this embodiment, lithium fluoride LiF is prepared as the fluorine source, and magnesium fluoride MgF₂ is prepared as the fluorine source and the magnesium source. When lithium fluoride LiF and magnesium fluoride MgF₂ are mixed at a molar ratio of approximately LiF:MgF2=65:35, the effect of lowering the melting point becomes the highest. On the other hand, when the amount of lithium fluoride increases, cycle performance might deteriorate because of too large an amount of lithium. Thus, the molar ratio of lithium fluoride LiF to magnesium fluoride MgF₂ is preferably LiF:MgF₂=x:1 (0≤x≤1.9), further preferably LiF:MgF₂=x:1 (0.1≤x≤0.5), still further preferably LiF:MgF2=x:1 (x=the vicinity of 0.33). Note that in this specification and the like, the vicinity means a value greater than 0.9 times and less than 1.1 times a certain value.

In the case where the crushing and mixing step in Step S65 is performed by a wet method, a solvent is prepared. As the solvent, ketone such as acetone, alcohol such as ethanol or isopropanol, ether, dioxane, acetonitrile, N-methyl-2-pyrrolidone (NMP), or the like can be used. An aprotic solvent that hardly reacts with lithium is further preferably used. In this embodiment, dehydrated acetone with a purity of higher than or equal to 99.5% is used.

For the magnesium source and the fluorine source used in synthesis, high-purity materials are preferably used. Specifically, the purity of each of the materials is higher than or equal to 4N (99.99%), preferably higher than or equal to 4N5UP (99.995%), further preferably higher than or equal to 5N (99.999%). The use of high-purity materials can increase the capacity of a secondary battery and/or increase the reliability of the secondary battery.

Next, in Step S71, the mixture 832 in Step S61 and the mixture 836 in Step S66 are mixed. After the mixing, the mixture is collected in Step S72, and crushed and sieved as needed, whereby the mixture 841 in Step S73 is obtained. The mixing can be performed by a dry process or a wet process. A mixer such as a planetary centrifugal mixer, a ball mill, or a bead mill can be used for the mixing, for example. In the case where a planetary centrifugal mixer Awatorirentaro manufactured by THINKY CORPORATION is used as the planetary centrifugal mixer, for example, 1.5-minute treatment at a rotational frequency of 2000 rpm is preferably repeated three times. When a ball mill is used, zirconia balls are preferably used as media, for example. When a ball mill, a bead mill, or the like is used, the peripheral speed is preferably greater than or equal to 100 mm/s and less than or equal to 2000 mm/s in order to inhibit contamination from the media or the material. For example, the mixing is preferably performed at a peripheral speed of 838 mm/s (the rotational frequency is 400 rpm, and the ball mill diameter is 40 mm).

Next, in Step S74, the mixture 841 in Step S73 is heated. In the heating, a container (crucible) containing the mixture 841 is preferably covered with a lid. Unnecessary evaporation of the raw materials can be prevented. The temperature of the heating in Step S74 is preferably higher than or equal to 500° C. and lower than or equal to 1100° C., further preferably higher than or equal to 500° C. and lower than or equal to 1000° C., still further preferably higher than or equal to 500° C. and lower than or equal to 950° C., yet still further preferably higher than or equal to 500° C. and lower than or equal to 900° C.

As the heating in Step S74, heating by a roller hearth kiln may be performed. When heat treatment is performed by a roller hearth kiln, the mixture 841 may be processed using a heat-resistant container having a lid.

The heating time can be longer than or equal to 1 hour and shorter than or equal to 100 hours, for example, and is preferably longer than or equal to 2 hours and shorter than or equal to hours. The heating is preferably performed in oxygen or an oxygen-containing atmosphere with few moisture (e.g., with a dew point lower than or equal to −50° C., preferably lower than or equal to −80° C.), such as a dry air. In this embodiment, the heating is performed in an atmosphere with a dew point of −93° C. Furthermore, it is suitable to perform the heating in an atmosphere where the concentrations of impurities, CH₄, CO, CO₂, and H₂, are each less than or equal to 5 ppb (parts per billion), in which case impurities can be inhibited from entering the materials.

For example, when the heating is performed at 850° C. for 10 hours, the temperature rise is preferably 200° C./h and the flow rate of a dry atmosphere is preferably 10 L/min. After that, the heated materials can be cooled to room temperature. The temperature decreasing time from the specified temperature to room temperature is preferably longer than or equal to 10 hours and shorter than or equal to 50 hours, for example. Note that the cooling to room temperature in Step S74 is not essential.

Next, the materials baked in the above step are collected, and crushed and sieved as needed in Step S75, whereby the mixture 842 in Step S81 is obtained. Since lithium fluoride LiF is prepared as the fluorine source, magnesium fluoride MgF₂ is prepared as the fluorine source and the magnesium source, and the container (crucible) is covered with a lid, an appropriate amount of fluorine is introduced into the mixture 842. Fluorine in LiF and MgF₂ sometimes moves to the surface portion of the mixture 842. A region containing fluorine in the surface portion of the mixture 842 functions as a barrier film. Owing to the fluorine, the mixture 842 has a smooth surface with little unevenness. The heating performed after fluorine is mixed leads to promotion of single crystallization of the mixture 842.

The mixture 842 obtained in Step S81 can be used as the positive electrode active material 100. The mixture 842 obtained in Step S81 can be provided for steps after Step S81 shown in FIG. 5.

Next, the steps after Step S81 shown in FIG. 5 are described. In Step S83 and Step S84, a nickel source 845 and an aluminum source 846 are prepared as additive element X sources. The nickel source 845 and the aluminum source 846 are crushed in Step S85 and Step S86, respectively, and mixed in Step S87, whereby a mixture 847 in Step S88 is obtained.

As the nickel source, nickel oxide, nickel hydroxide, or the like can be used.

As the aluminum source, aluminum oxide, aluminum hydroxide, or the like can be used.

For the nickel source and the aluminum source used in synthesis, high-purity materials are preferably used. Specifically, the purity of each of the materials is higher than or equal to 4N (99.99%), preferably higher than or equal to 4N5UP (99.995%), further preferably higher than or equal to 5N (99.999%). The use of high-purity materials can increase the capacity of a secondary battery and/or increase the reliability of the secondary battery.

Next, in Step S91, the mixture 842 in Step S81 and the mixture 847 in Step S88 are mixed. After the mixing, the mixture is collected in Step S92, and crushed and sieved as needed, whereby the mixture 851 in Step S93 is obtained. The mixing can be performed by a dry process or a wet process. A mixer such as a planetary centrifugal mixer, a ball mill, or a bead mill can be used for the mixing, for example. In the case where a planetary centrifugal mixer Awatorirentaro manufactured by THINKY CORPORATION is used as the planetary centrifugal mixer, for example, 1.5-minute treatment at a rotational frequency of 2000 rpm is preferably repeated three times. When a ball mill is used, zirconia balls are preferably used as media, for example. When a ball mill, a bead mill, or the like is used, the peripheral speed is preferably greater than or equal to 100 mm/s and less than or equal to 2000 mm/s in order to inhibit contamination from the media or the material. For example, the mixing is preferably performed at a peripheral speed of 838 mm/s (the rotational frequency is 400 rpm, and the ball mill diameter is 40 mm).

In this embodiment, the mixing is performed with a ball mill using zirconia balls with a diameter of 1 mm by a dry method at 150 rpm for 1 hour. The mixing is performed in a dry room the dew point of which is higher than or equal to −100° C. and lower than or equal to −10° C.

Next, in Step S94, the mixture 851 in Step S93 is heated. The temperature of the heating in Step S94 is preferably higher than or equal to 500° C. and lower than or equal to 1130° C., further preferably higher than or equal to 500° C. and lower than or equal to 1000° C., still further preferably higher than or equal to 500° C. and lower than or equal to 950° C., yet still further preferably higher than or equal to 500° C. and lower than or equal to 900° C.

The heating time can be longer than or equal to 1 hour and shorter than or equal to 100 hours, for example, and is preferably longer than or equal to 2 hours and shorter than or equal to hours. The heating is preferably performed in oxygen or an oxygen-containing atmosphere with few moisture (e.g., with a dew point lower than or equal to −50° C., preferably lower than or equal to −80° C.), such as a dry air. In this embodiment, the heating is performed in an atmosphere with a dew point of −93° C. Furthermore, it is suitable to perform the heating in an atmosphere where the concentrations of impurities, CH₄, CO, CO₂, and H₂, are each less than or equal to 5 ppb (parts per billion), in which case impurities can be inhibited from entering the materials.

For example, when the heating is performed at 850° C. for 10 hours, the temperature rise is preferably 200° C./h and the flow rate of a dry atmosphere is preferably 10 L/min. After that, the heated materials can be cooled to room temperature. The temperature decreasing time from the specified temperature to room temperature is preferably longer than or equal to 10 hours and shorter than or equal to 50 hours, for example. Note that the cooling to room temperature in Step S94 is not essential.

Next, the materials baked in the above step are collected and crushed in Step S95, whereby the positive electrode active material 100 in Step S101 is obtained. The materials may be sieved as needed after being crushed. Through the above process, the positive electrode active material 100 of one embodiment of the present invention can be manufactured.

The positive electrode active material 100 preferably has high crystallinity; when the mixture 821 in Step S41 has high crystallinity, the positive electrode active material 100 also has high crystallinity. In the case where the positive electrode active material 100 has high crystallinity and the positive electrode active material 100 includes single-crystal grains, crystal planes where lithium enters and leaves can be aligned. A greater number of the crystal planes where lithium enters and leaves can be exposed to an electrolyte, which improves battery characteristics. Furthermore, the positive electrode active material 100 having high crystallinity and including single-crystal grains is durable; thus, an active material which does not easily deteriorate even when charging and discharging are repeated can be provided.

The positive electrode active material 100 is preferable because it contains fluorine and thus has a smooth surface with little unevenness. When particle surface unevenness information is quantified with measurement data in cross-sectional observation of a cross section obtained by cutting the positive electrode active material 100 toward its center with a scanning transmission electron microscope (STEM), at least part of the particle preferably has surface roughness of less than 3 nm, further preferably less than 1 nm. Nickel and aluminum sometimes move to the surface portion of the positive electrode active material 100. A region containing nickel or a region containing aluminum in the surface portion of the positive electrode active material 100 functions as a barrier film.

Note that the positive electrode active material 100 is a lithium composite oxide containing at least nickel, cobalt, and manganese, and further contains aluminum and nickel. In the lithium composite oxide, the ratio of at least Ni, Co, and Mn is any of 1:1:1 and the neighborhood thereof, 9:0.5:0.5 and the neighborhood thereof, 8:1:1 and the neighborhood thereof, 6:2:2 and the neighborhood thereof, and 5:2:3 and the neighborhood thereof. In the lithium composite oxide, aluminum and nickel are elements added in small amounts; for example, in the case where Ni:Mn:Co is 8:1:1 and the neighborhood thereof, the aluminum concentration is preferably higher than or equal to 0.1 at % and lower than or equal to 2 at %.

When the step of introducing the transition metal M and the steps of introducing the additive elements X are separately performed as shown in FIG. 4 and FIG. 5, the element concentration profiles in the depth direction can be made different from each other in some cases. For example, the concentration of each of the additive elements X can be made higher in the surface portion than in the inner portion of a particle. Furthermore, with the number of atoms of the transition metal Mas a reference, the ratio of the number of atoms of each of the additive elements X with respect to the reference can be higher in the surface portion than in the inner portion. In the lithium composite oxide, a region with an aluminum concentration higher than or equal to 0.1 at % and lower than or equal to 2 at % may be in either the surface portion or the inner portion of the particle.

In one embodiment of the present invention, a positive electrode active material is manufactured using high-purity materials for the transition metal M sources used in synthesis and using a process which hardly allows entry of impurities in the synthesis. The manufacturing method in which entry of impurities into the transition metal M sources and entry of impurities in the synthesis are thoroughly prevented and in which desired additive elements X are controlled to be introduced into the positive electrode active material can provide a positive electrode active material in which a region with a low impurity concentration and a region where the additive elements X are introduced are controlled. The positive electrode active material described in this embodiment is a material having high crystallinity. Furthermore, the positive electrode active material obtained by the manufacturing method of a positive electrode active material, which is one embodiment of the present invention, can increase the capacity of a secondary battery and/or increase the reliability of the secondary battery.

### Embodiment 4

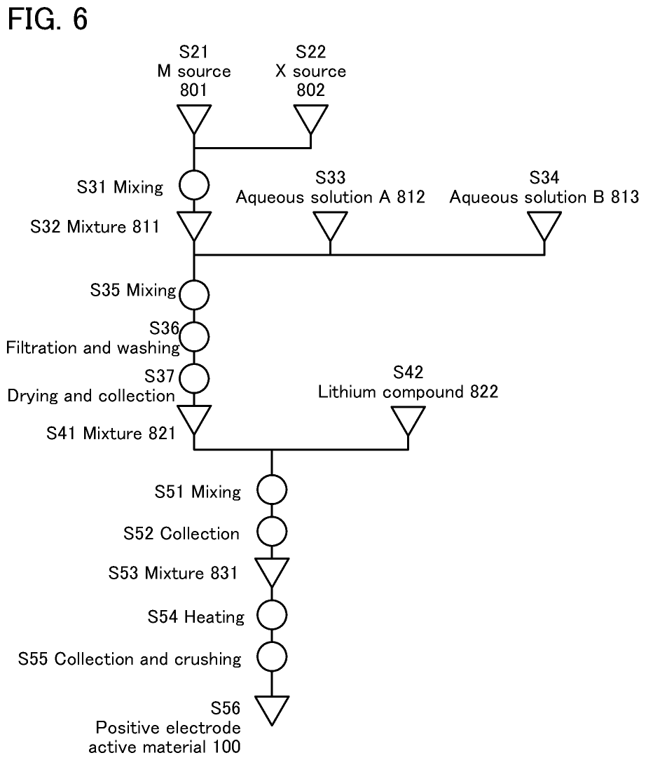

In this embodiment, an example of the manufacturing method of a positive electrode active material of one embodiment of the present invention will be described with reference to FIG. 6.

The transition metal M source 801 and an additive element X source 802 are prepared in Step S21 and Step S22 in FIG. 6, respectively.

As the transition metal M, at least one of manganese, cobalt, and nickel can be used, for example. As the transition metal M, for example, cobalt alone; nickel alone; two metals of cobalt and manganese; two metals of cobalt and nickel; or three metals of cobalt, manganese, and nickel may be used. As the transition metal M source 801, an aqueous solution containing the transition metal M is prepared.

As the transition metal M source 801, an aqueous solution containing cobalt, such as an aqueous solution of cobalt sulfate or an aqueous solution of cobalt nitrate, can be used; an aqueous solution containing nickel, such as an aqueous solution of nickel sulfate or an aqueous solution of nickel nitrate, can be used; or an aqueous solution containing manganese, such as an aqueous solution of manganese sulfate or an aqueous solution of manganese nitrate, can be used.

For the transition metal M source 801 used in synthesis, a high-purity material is preferably used. Specifically, in the case of using the aqueous solution containing the transition metal M, the aqueous solution is formed using a solute material with a purity higher than or equal to 2N (99%), preferably higher than or equal to 3N (99.9%), further preferably higher than or equal to 4N (99.99%), and water with a specific resistance of preferably 1 MΩ·cm or higher, further preferably 10 MΩ·cm or higher, still further preferably 15 MΩ·cm or higher, which is desirably pure water containing few impurities. The use of a high-purity material can increase the capacity of a secondary battery and/or increase the reliability of the secondary battery.

As the additive element X, one or more selected from nickel, cobalt, magnesium, calcium, chlorine, fluorine, bromine, aluminum, manganese, titanium, zirconium, yttrium, vanadium, iron, chromium, niobium, lanthanum, hafnium, zinc, silicon, sulfur, phosphorus, boron, and arsenic can be used. As the additive element X source 802, any one or more of an aqueous solution containing the additive element X, an alkoxide containing the additive element X, and a solid compound containing the additive element X can be used. An aqueous solution containing the additive element X is preferably prepared as the additive element X source 802 in Step S22.

For the additive element X source 802 used in synthesis, a high-purity material is preferably used. Specifically, the purity of the material is higher than or equal to 2N (99%), preferably higher than or equal to 3N (99.9%), further preferably higher than or equal to 4N (99.99%). The use of a high-purity material can increase the capacity of a secondary battery and/or increase the reliability of the secondary battery.

Next, in Step S31, the transition metal M source 801 and the additive element X source 802 are mixed, whereby the mixture 811 in Step S32 is obtained.

Next, the aqueous solution A 812 and the aqueous solution B 813 are prepared in Step S33 and Step S34, respectively.

As the aqueous solution A 812, any one of ammonia water and an aqueous solution containing at least one of chelating agents such as glycine, oxine, 1-nitroso-2-naphthol, and 2-mercaptobenzothiazole, or a mixed solution of a plurality of them can be used.

As the aqueous solution B 813, any one of an aqueous solution of sodium hydroxide, an aqueous solution of potassium hydroxide, and an aqueous solution of lithium hydroxide, or a mixed solution of a plurality of them can be used.

Next, in Step S35, the mixture 811 in Step S32, the aqueous solution A 812, and the aqueous solution B 813 are mixed.

As a mixing method in Step S35, a mixing method in which the mixture 811 in Step S32 and the aqueous solution B 813 are dripped into the aqueous solution A 812 that is put in a reaction container can be used. While the mixture 811 in Step S32 is dripped at a constant rate, the aqueous solution B 813 is desirably dripped as appropriate so that the pH of the mixed solution in the reaction container is kept in a predetermined range. In the mixing of Step S35, it is desirable that the solution in the reaction container be stirred with a stirring blade or a stirrer, and that dissolved oxygen in the solution in the reaction container, the mixture 811 in Step S32, the aqueous solution A 812, and the aqueous solution B 813 be removed by N₂ bubbling. In the mixing of Step S35, the pH in the reaction container is preferably greater than or equal to 9 and less than or equal to 11, further preferably greater than or equal to 10.0 and less than or equal to 10.5. In the mixing of Step S35, the temperature of the solution in the reaction container is preferably higher than or equal to 40° C. and lower than or equal to 80° C., further preferably higher than or equal to 50° C. and lower than or equal to 70° C.

Alternatively, as the mixing method in Step S35, a mixing method in which the aqueous solution A 812 and the aqueous solution B 813 are dripped into the mixture 811 in Step S32 that is put in a reaction container can be used. It is preferred to adjust the dripping rates of the aqueous solution A 812 and the aqueous solution B 813 in order to keep the concentration of hydroxyl groups and the concentration of dissolved ions of the aqueous solution A 812 in the reaction container in predetermined ranges. In the mixing of Step S35, it is desirable that the solution in the reaction container be stirred with a stirring blade or a stirrer, and that dissolved oxygen in the solution in the reaction container, the mixture 811 in Step S32, the aqueous solution A 812, and the aqueous solution B 813 be removed by N₂ bubbling. In the mixing of Step S35, the temperature of the solution in the reaction container is preferably higher than or equal to 40° C. and lower than or equal to 80° C., further preferably higher than or equal to 50° C. and lower than or equal to 70° C.

The case where the aqueous solution A 812 is not used in the mixing method in Step S35 is described. A certain amount of the aqueous solution B 813 is dripped and added to the mixture 811 in Step S32 that is put in a reaction container. In the mixing of Step S35, it is desirable that the solution in the reaction container be stirred with a stirring blade or a stirrer, and that dissolved oxygen in the solution in the reaction container, the mixture 811 in Step S32, and the aqueous solution B 813 be removed by N₂ bubbling. In the mixing of Step S35, the temperature of the solution in the reaction container is preferably higher than or equal to 40° C. and lower than or equal to 80° C., further preferably higher than or equal to 50° C. and lower than or equal to 70° C.

The case where pure water is used in addition to the mixture 811 in Step S32, the aqueous solution A 812, and the aqueous solution B 813 in the mixing method in Step S35 is described. While the mixture 811 in Step S32 and the aqueous solution A 812 are dripped into pure water that is put in a reaction container at constant rates, the aqueous solution B 813 can be dripped as appropriate so that the pH of the mixed solution in the reaction container is kept in a predetermined range. In the mixing of Step S35, it is desirable that the solution in the reaction container be stirred with a stirring blade or a stirrer, and that dissolved oxygen in the solution in the reaction container, the mixture 811 in Step S32, the aqueous solution A 812, and the aqueous solution B 813 be removed by N₂ bubbling. In the mixing of Step S35, the pH of the solution in the reaction container is preferably greater than or equal to 9 and less than or equal to 11, further preferably greater than or equal to 10.0 and less than or equal to 10.5. In the mixing of Step S35, the temperature of the solution in the reaction container is preferably higher than or equal to 40° C. and lower than or equal to 80° C., further preferably higher than or equal to 50° C. and lower than or equal to 70° C.

Next, in Step S36, a solution that is formed by the mixing in Step S35 and contains a hydroxide containing the transition metal M is filtered and then washed with water. It is desirable that the water used for the washing be pure water containing few impurities, with a specific resistance of preferably 1 MΩ·cm or higher, further preferably 10 MΩ·cm or higher, still further preferably 15 MΩ·cm or higher. The use of the pure water containing few impurities for the washing can remove impurities contained in the hydroxide containing the transition metal M. Accordingly, a high-purity hydroxide containing the transition metal M can be obtained as a precursor of the positive electrode active material 100.

Next, the hydroxide containing the transition metal M and the additive element X after the washing in Step S36 is dried and collected, and crushed and sieved as needed, whereby the mixture 821 in Step S41 is obtained. The mixture 821 is also referred to as the precursor of the positive electrode active material 100. The precursor preferably has high crystallinity, and further preferably includes single-crystal grains. In other words, the precursor is preferably a single crystal.

Next, the lithium compound 822 is prepared in Step S42, and the mixture 821 in Step S41 and the lithium compound 822 are mixed in Step S51. After the mixing, the mixture is collected in Step S52, and crushed and sieved as needed, whereby the mixture 831 in Step S53 is obtained. The mixing can be performed by a dry process or a wet process. A mixer such as a planetary centrifugal mixer, a ball mill, or a bead mill can be used for the mixing, for example. In the case where a planetary centrifugal mixer Awatorirentaro manufactured by THINKY CORPORATION is used as the planetary centrifugal mixer, for example, 1.5-minute treatment at a rotational frequency of 2000 rpm is preferably repeated three times. When a ball mill is used, zirconia balls are preferably used as media, for example. When a ball mill, a bead mill, or the like is used, the peripheral speed is preferably greater than or equal to 100 mm/s and less than or equal to 2000 mm/s in order to inhibit contamination from the media or the material. For example, the mixing is preferably performed at a peripheral speed of 838 mm/s (the rotational frequency is 400 rpm, and the ball mill diameter is 40 mm).

It is preferred to perform the mixing in Step S51 sufficiently so that the mixture 821 and the lithium compound 822 can be mixed evenly.

As the lithium compound 822, lithium hydroxide, lithium carbonate, lithium nitrate, or lithium fluoride can be used, for example. The lithium compound 822 is referred to as a lithium source in some cases.

Next, in Step S54, the mixture 831 in Step S53 is heated. The heating temperature is preferably around melting points of the mixture 821 and the lithium compound 822, preferably higher than or equal to 700° C. and lower than 1100° C., further preferably higher than or equal to 800° C. and lower than or equal to 1000° C., still further preferably higher than or equal to 800° C. and lower than or equal to 950° C. In the heating, a container (crucible) containing the mixture 831 is preferably covered with a lid. Unnecessary evaporation of the raw materials can be prevented.

The heating time can be longer than or equal to 1 hour and shorter than or equal to 100 hours, for example, and is preferably longer than or equal to 2 hours and shorter than or equal to hours. The heating is preferably performed in oxygen or an oxygen-containing atmosphere with few moisture (e.g., with a dew point lower than or equal to −50° C., preferably lower than or equal to −80° C.), such as a dry air. In this embodiment, the heating is performed in an atmosphere with a dew point of −93° C. Furthermore, it is suitable to perform the heating in an atmosphere where the concentrations of impurities, CH₄, CO, CO₂, and H₂, are each less than or equal to 5 ppb (parts per billion), in which case impurities can be inhibited from entering the materials.

For example, when the heating is performed at 850° C. for 10 hours, the temperature rise is preferably 200° C./h and the flow rate of a dry atmosphere is preferably 10 L/min. After that, the heated materials can be cooled to room temperature. The temperature decreasing time from the specified temperature to room temperature is preferably longer than or equal to 10 hours and shorter than or equal to 50 hours, for example. Note that the cooling to room temperature in Step S54 is not essential.

Note that the crucible used in the heating in Step S54 is suitably made of a material into which impurities do not enter. In this embodiment, a crucible made of alumina with a purity of 99.9% is used.

It is suitable to collect the materials subjected to the heating in Step S54 after the materials are transferred from the crucible to a mortar because impurities are prevented from entering the materials. The mortar is suitably made of a material into which impurities do not enter. Specifically, it is suitable to use a mortar made of alumina with a purity of 90 wt % or higher, preferably 99 wt % or higher.

Next, the materials baked in the above step are collected and crushed in Step S55, whereby the positive electrode active material 100 in Step S56 is obtained. The materials may be sieved as needed after being crushed. Through the above process, the positive electrode active material 100 of one embodiment of the present invention can be manufactured.

Since the number of heating steps is small, this embodiment is preferable for high mass productivity. The positive electrode active material 100 preferably has high crystallinity; when the mixture 821 in Step S41 has high crystallinity, the positive electrode active material 100 also has high crystallinity. In the case where the positive electrode active material 100 has high crystallinity and the positive electrode active material 100 includes single-crystal grains, crystal planes where lithium enters and leaves can be aligned. A greater number of the crystal planes where lithium enters and leaves can be exposed to an electrolyte, which improves battery characteristics. Furthermore, the positive electrode active material 100 having high crystallinity and including single-crystal grains is durable; thus, an active material which does not easily deteriorate even when charging and discharging are repeated can be provided.

The positive electrode active material 100 is sometimes referred to as a composite oxide containing lithium, the transition metal M, and oxygen (LiMO₂). Note that the positive electrode active material of one embodiment of the present invention only needs to have a crystal structure of a lithium composite oxide represented by LiMO₂, and the composition is not strictly limited to Li:M:O=1:1:2. For example, in the case where three metals of cobalt, manganese, and nickel are used as the transition metals M and aluminum is used as the additive element X, the positive electrode active material 100 is a composite oxide containing Ni, Co, Mn, and Al (an NCMA). The NCMA may be obtained by adding Al to an NCM in which the ratio of Ni:Co:Mn is any of 1:1:1 and the neighborhood thereof, 9:0.5:0.5 and the neighborhood thereof, 8:1:1 and the neighborhood thereof, 6:2:2 and the neighborhood thereof, and 5:2:3 and the neighborhood thereof. In the case where Ni:Co:Mn is 8:1:1 and the neighborhood thereof, for example, the aluminum concentration is preferably higher than or equal to 0.1 at % and lower than or equal to 2 at %.

When the step of introducing the transition metal M and the step of introducing the additive element X are separately performed as shown in FIG. 6, the element concentration profiles in the depth direction can be made different from each other in some cases. For example, the concentration of the additive element X can be made higher in the surface portion than in the inner portion of a particle. Furthermore, with the number of atoms of the transition metal M as a reference, the ratio of the number of atoms of the additive element X with respect to the reference can be higher in the surface portion than in the inner portion. In the NCMA, a region with an aluminum concentration higher than or equal to 0.1 at % and lower than or equal to 2 at % may be in either the surface portion or the inner portion of the particle.

In one embodiment of the present invention, a positive electrode active material is manufactured using a high-purity material for the transition metal M source used in synthesis and using a process which hardly allows entry of impurities in the synthesis. The manufacturing method in which entry of impurities into the transition metal M source and entry of impurities in the synthesis are thoroughly prevented and in which a desired additive element X is controlled to be introduced into the positive electrode active material can provide a positive electrode active material in which a region with a low impurity concentration and a region where the additive element X is introduced are controlled. The positive electrode active material described in this embodiment is a material having high crystallinity. Furthermore, the positive electrode active material obtained by the manufacturing method of a positive electrode active material, which is one embodiment of the present invention, can increase the capacity of a secondary battery and/or increase the reliability of the secondary battery.

### Embodiment 5

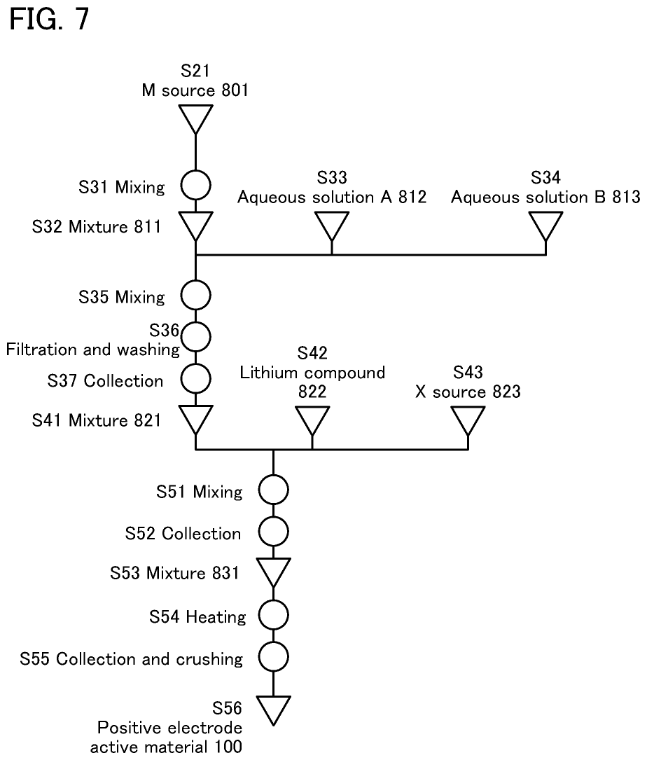

In this embodiment, an example of the manufacturing method of a positive electrode active material of one embodiment of the present invention will be described with reference to FIG. 7.

The transition metal M source 801 is prepared in Step S21 in FIG. 7.

As the transition metal M, at least one of manganese, cobalt, and nickel can be used, for example. As the transition metal M, for example, cobalt alone; nickel alone; two metals of cobalt and manganese; two metals of cobalt and nickel; or three metals of cobalt, manganese, and nickel may be used. As the transition metal M source, an aqueous solution containing the transition metal M is prepared.

As the transition metal M source 801, an aqueous solution containing cobalt, such as an aqueous solution of cobalt sulfate or an aqueous solution of cobalt nitrate, can be used; an aqueous solution containing nickel, such as an aqueous solution of nickel sulfate or an aqueous solution of nickel nitrate, can be used; or an aqueous solution containing manganese, such as an aqueous solution of manganese sulfate or an aqueous solution of manganese nitrate, can be used.

For the transition metal M source 801 used in synthesis, a high-purity material is preferably used. Specifically, in the case of using the aqueous solution containing the transition metal M, the aqueous solution is formed using a solute material with a purity higher than or equal to 2N (99%), preferably higher than or equal to 3N (99.9%), further preferably higher than or equal to 4N (99.99%), and water with a specific resistance of preferably 1 MΩ·cm or higher, further preferably 10 MΩ·cm or higher, still further preferably 15 MΩ·cm or higher, which is desirably pure water containing few impurities. The use of a high-purity material can increase the capacity of a secondary battery and/or increase the reliability of the secondary battery.

In the case where a plurality of the transition metal M sources 801 are used, for example, a cobalt source, a manganese source, and a nickel source are used, the mixture ratio is preferably within a range with which a layered rock-salt crystal structure is obtained.

Next, in Step S31, the transition metal M source 801 is mixed, whereby the mixture 811 in Step S32 is obtained.

Next, the aqueous solution A 812 and the aqueous solution B 813 are prepared in Step S33 and Step S34, respectively.

As the aqueous solution A 812, any one of ammonia water and an aqueous solution containing at least one of chelating agents such as glycine, oxine, 1-nitroso-2-naphthol, and 2-mercaptobenzothiazole, or a mixed solution of a plurality of them can be used.

As the aqueous solution B 813, any one of an aqueous solution of sodium hydroxide, an aqueous solution of potassium hydroxide, and an aqueous solution of lithium hydroxide, or a mixed solution of a plurality of them can be used.

Next, in Step S35, the mixture 811 in Step S32, the aqueous solution A 812, and the aqueous solution B 813 are mixed.

As a mixing method in Step S35, a mixing method in which the mixture 811 in Step S32 and the aqueous solution B 813 are dripped into the aqueous solution A 812 that is put in a reaction container can be used. While the mixture 811 in Step S32 is dripped at a constant rate, the aqueous solution B 813 is desirably dripped as appropriate so that the pH of the mixed solution in the reaction container is kept in a predetermined range. In the mixing of Step S35, it is desirable that the solution in the reaction container be stirred with a stirring blade or a stirrer, and that dissolved oxygen in the solution in the reaction container, the mixture 811 in Step S32, the aqueous solution A 812, and the aqueous solution B 813 be removed by N₂ bubbling. In the mixing of Step S35, the pH in the reaction container is preferably greater than or equal to 9 and less than or equal to 11, further preferably greater than or equal to 10.0 and less than or equal to 10.5. In the mixing of Step S35, the temperature of the solution in the reaction container is preferably higher than or equal to 40° C. and lower than or equal to 80° C., further preferably higher than or equal to 50° C. and lower than or equal to 70° C.

Alternatively, as the mixing method in Step S35, a mixing method in which the aqueous solution A 812 and the aqueous solution B 813 are dripped into the mixture 811 in Step S32 that is put in a reaction container can be used. It is preferred to adjust the dripping rates of the aqueous solution A 812 and the aqueous solution B 813 in order to keep the concentration of hydroxyl groups and the concentration of dissolved ions of the aqueous solution A 812 in the reaction container in predetermined ranges. In the mixing of Step S35, it is desirable that the solution in the reaction container be stirred with a stirring blade or a stirrer, and that dissolved oxygen in the solution in the reaction container, the mixture 811 in Step S32, the aqueous solution A 812, and the aqueous solution B 813 be removed by N₂ bubbling. In the mixing of Step S35, the temperature of the solution in the reaction container is preferably higher than or equal to 40° C. and lower than or equal to 80° C., further preferably higher than or equal to 50° C. and lower than or equal to 70° C.

The case where the aqueous solution A 812 is not used in the mixing method in Step S35 is described. A certain amount of the aqueous solution B 813 is dripped and added to the mixture 811 in Step S32 that is put in a reaction container. In the mixing of Step S35, it is desirable that the solution in the reaction container be stirred with a stirring blade or a stirrer, and that dissolved oxygen in the solution in the reaction container, the mixture 811 in Step S32, and the aqueous solution B 813 be removed by N₂ bubbling. In the mixing of Step S35, the temperature of the solution in the reaction container is preferably higher than or equal to 40° C. and lower than or equal to 80° C., further preferably higher than or equal to 50° C. and lower than or equal to 70° C.

The case where pure water is used in addition to the mixture 811 in Step S32, the aqueous solution A 812, and the aqueous solution B 813 in the mixing method in Step S35 is described. While the mixture 811 in Step S32 and the aqueous solution A 812 are dripped into pure water that is put in a reaction container at constant rates, the aqueous solution B 813 can be dripped as appropriate so that the pH of the mixed solution in the reaction container is kept in a predetermined range. In the mixing of Step S35, it is desirable that the solution in the reaction container be stirred with a stirring blade or a stirrer, and that dissolved oxygen in the solution in the reaction container, the mixture 811 in Step S32, the aqueous solution A 812, and the aqueous solution B 813 be removed by N₂ bubbling. In the mixing of Step S35, the pH in the reaction container is preferably greater than or equal to 9 and less than or equal to 11, further preferably greater than or equal to 10.0 and less than or equal to 10.5. In the mixing of Step S35, the temperature of the solution in the reaction container is preferably higher than or equal to 40° C. and lower than or equal to 80° C., further preferably higher than or equal to 50° C. and lower than or equal to 70° C.

Next, in Step S36, a solution that is formed by the mixing in Step S35 and contains a hydroxide containing the transition metal M is filtered and then washed with water. It is desirable that the water used for the washing be pure water containing few impurities, with a specific resistance of preferably 1 MΩ·cm or higher, further preferably 10 MΩ·cm or higher, still further preferably 15 MΩ·cm or higher. The use of the pure water containing few impurities for the washing can remove impurities contained in the hydroxide containing the transition metal M. Accordingly, a high-purity hydroxide containing the transition metal M can be obtained as a precursor of the positive electrode active material 100.

Next, the hydroxide containing the transition metal M after the washing in Step S36 is dried and collected, and crushed and sieved as needed, whereby the mixture 821 in Step S41 is obtained. The mixture 821 is also referred to as the precursor of the positive electrode active material 100. The precursor preferably has high crystallinity, and further preferably includes single-crystal grains. In other words, the precursor is preferably a single crystal.

Next, the lithium compound 822 is prepared in Step S42, and an additive element X source 823 is prepared in Step S43. In Step S51, the mixture 821 in Step S41, the lithium compound 822, and the additive element X source 823 are mixed. After the mixing, the mixture is collected in Step S52, and crushed and sieved as needed, whereby the mixture 831 in Step S53 is obtained. The mixing can be performed by a dry process or a wet process. A mixer such as a planetary centrifugal mixer, a ball mill, or a bead mill can be used for the mixing, for example. In the case where a planetary centrifugal mixer Awatorirentaro manufactured by THINKY CORPORATION is used as the planetary centrifugal mixer, for example, 1.5-minute treatment at a rotational frequency of 2000 rpm is preferably repeated three times. When a ball mill is used, zirconia balls are preferably used as media, for example. When a ball mill, a bead mill, or the like is used, the peripheral speed is preferably greater than or equal to 100 mm/s and less than or equal to 2000 mm/s in order to inhibit contamination from the media or the material. For example, the mixing is preferably performed at a peripheral speed of 838 mm/s (the rotational frequency is 400 rpm, and the ball mill diameter is 40 mm).

It is preferred to perform the mixing in Step S51 sufficiently so that the mixture 821 and the lithium compound 822 can be mixed evenly.

As the lithium compound 822, lithium hydroxide, lithium carbonate, lithium nitrate, or lithium fluoride can be used, for example. The lithium compound 822 is referred to as a lithium source in some cases.

For the lithium compound 822 used in synthesis, a high-purity material is preferably used. Specifically, the purity of the material is higher than or equal to 4N (99.99%), preferably higher than or equal to 4N5UP (99.995%), further preferably higher than or equal to 5N (99.999%). The use of a high-purity material can increase the capacity of a secondary battery and/or increase the reliability of the secondary battery.

As the additive element X, one or more selected from nickel, cobalt, magnesium, calcium, chlorine, fluorine, aluminum, manganese, titanium, zirconium, yttrium, vanadium, iron, chromium, niobium, lanthanum, hafnium, zinc, silicon, sulfur, phosphorus, boron, and arsenic can be used. In addition to the above elements, bromine and beryllium may be used as the additive elements X Note that the additive elements X given earlier are more suitable because bromine and beryllium are elements having toxicity to living things.

As the additive element X source 823 in Step S43, any one or more of an aqueous solution containing the additive element X, an alkoxide containing the additive element X, and a solid compound containing the additive element X can be used.

For the additive element X source used in synthesis, a high-purity material is preferably used. Specifically, the purity of the material is higher than or equal to 2N (99%), preferably higher than or equal to 3N (99.9%), further preferably higher than or equal to 4N (99.99%). The use of a high-purity material can increase the capacity of a secondary battery and/or increase the reliability of the secondary battery.

Next, in Step S54, the mixture 831 in Step S53 is heated. The heating temperature is preferably around melting points of the mixture 821, the lithium compound 822, and the like, preferably higher than or equal to 700° C. and lower than 1100° C., further preferably higher than or equal to 800° C. and lower than or equal to 1000° C., still further preferably higher than or equal to 800° C. and lower than or equal to 950° C.

The heating time can be longer than or equal to 1 hour and shorter than or equal to 100 hours, for example, and is preferably longer than or equal to 2 hours and shorter than or equal to 20 hours. The heating is preferably performed in oxygen or an oxygen-containing atmosphere with few moisture (e.g., with a dew point lower than or equal to −50° C., preferably lower than or equal to −80° C.), such as a dry air. In this embodiment, the heating is performed in an atmosphere with a dew point of −93° C. Furthermore, it is suitable to perform the heating in an atmosphere where the concentrations of impurities, CH₄, CO, CO₂, and H₂, are each less than or equal to 5 ppb (parts per billion), in which case impurities can be inhibited from entering the materials.

For example, when the heating is performed at 850° C. for 10 hours, the temperature rise is preferably 200° C./h and the flow rate of a dry atmosphere is preferably 10 L/min. After that, the heated materials can be cooled to room temperature. The temperature decreasing time from the specified temperature to room temperature is preferably longer than or equal to 10 hours and shorter than or equal to 50 hours, for example. Note that the cooling to room temperature in Step S54 is not essential.

Note that the crucible used in the heating in Step S54 is suitably made of a material into which impurities do not enter. In this embodiment, a crucible made of alumina with a purity of 99.9% is used.

It is suitable to collect the materials subjected to the heating in Step S54 after the materials are transferred from the crucible to a mortar because impurities are prevented from entering the materials. The mortar is suitably made of a material into which impurities do not enter. Specifically, it is suitable to use a mortar made of alumina with a purity of 90 wt % or higher, preferably 99 wt % or higher.

Next, the materials baked in the above step are collected and crushed in Step S55, whereby the positive electrode active material 100 in Step S56 is obtained. The materials may be sieved as needed after being crushed. Through the above process, the positive electrode active material 100 of one embodiment of the present invention can be manufactured.

The positive electrode active material 100 preferably has high crystallinity; when the mixture 821 in Step S41 has high crystallinity, the positive electrode active material 100 also has high crystallinity. In the case where the positive electrode active material 100 has high crystallinity and the positive electrode active material 100 includes single-crystal grains, crystal planes where lithium enters and leaves can be aligned. A greater number of the crystal planes where lithium enters and leaves can be exposed to an electrolyte, which improves battery characteristics. Furthermore, the positive electrode active material 100 having high crystallinity and including single-crystal grains is durable; thus, an active material which does not easily deteriorate even when charging and discharging are repeated can be provided.

The positive electrode active material 100 is sometimes referred to as a composite oxide containing lithium, the transition metal M, and oxygen (LiMO₂). Note that the positive electrode active material of one embodiment of the present invention only needs to have a crystal structure of a lithium composite oxide represented by LiMO₂, and the composition is not strictly limited to Li:M:O=1:1:2. For example, in the case where three metals of cobalt, manganese, and nickel are used as the transition metals M and aluminum is used as the additive element X, the positive electrode active material 100 is a composite oxide containing Ni, Co, Mn, and Al (an NCMA). The NCMA may be obtained by adding Al to an NCM in which the ratio of Ni:Co:Mn is any of 1:1:1 and the neighborhood thereof, 9:0.5:0.5 and the neighborhood thereof, 8:1:1 and the neighborhood thereof, 6:2:2 and the neighborhood thereof, and 5:2:3 and the neighborhood thereof. In the case where Ni:Co:Mn is 8:1:1 and the neighborhood thereof, for example, the aluminum concentration is preferably higher than or equal to 0.1 at % and lower than or equal to 2 at %.

When the step of introducing the transition metal M and the step of introducing the additive element X are separately performed as shown in FIG. 7, the element concentration profiles in the depth direction can be made different from each other in some cases. For example, the concentration of the additive element X can be made higher in the surface portion than in the inner portion of a particle. Furthermore, with the number of atoms of the transition metal M as a reference, the ratio of the number of atoms of the additive element X with respect to the reference can be higher in the surface portion than in the inner portion. In the NCMA, a region with an aluminum concentration higher than or equal to 0.1 at % and lower than or equal to 2 at % may be in either the surface portion or the inner portion of the particle.

In one embodiment of the present invention, a positive electrode active material is manufactured using a high-purity material for the transition metal M source used in synthesis and using a process which hardly allows entry of impurities in the synthesis. The manufacturing method in which entry of impurities into the transition metal M source and entry of impurities in the synthesis are thoroughly prevented and in which a desired additive element X is controlled to be introduced into the positive electrode active material can provide a positive electrode active material in which a region with a low impurity concentration and a region where the additive element X is introduced are controlled. The positive electrode active material described in this embodiment is a material having high crystallinity. Furthermore, the positive electrode active material obtained by the manufacturing method of a positive electrode active material, which is one embodiment of the present invention, can increase the capacity of a secondary battery and/or increase the reliability of the secondary battery.

### Embodiment 6

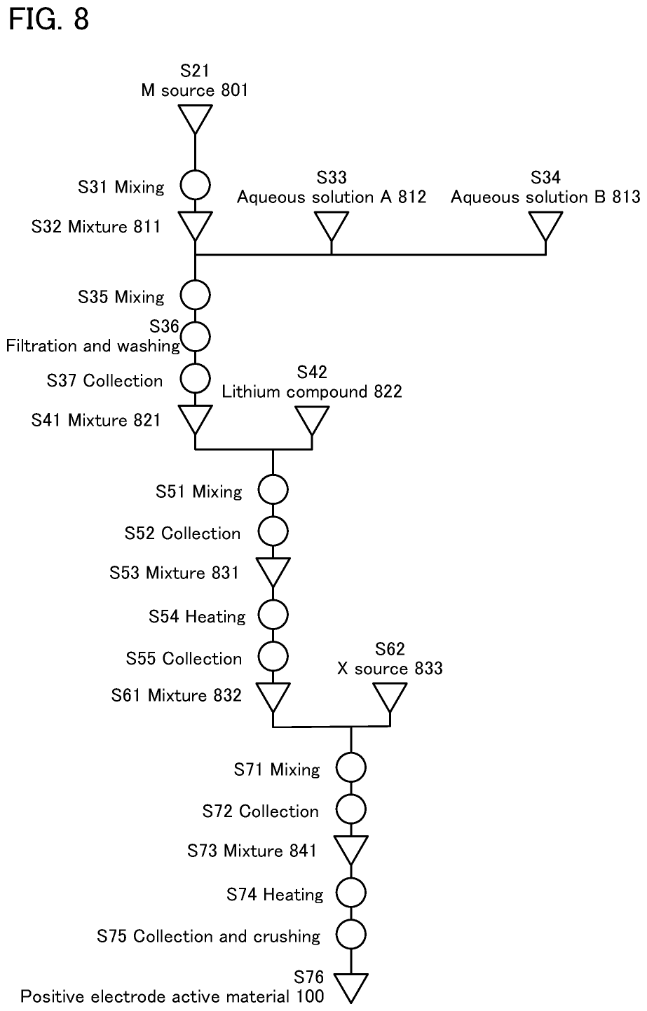

In this embodiment, an example of the manufacturing method of a positive electrode active material of one embodiment of the present invention will be described with reference to FIG. 8.

In Step S21 in FIG. 8, the transition metal M source 801 is prepared.

As the transition metal M, at least one of manganese, cobalt, and nickel can be used, for example. As the transition metal M, for example, cobalt alone; nickel alone; two metals of cobalt and manganese; two metals of cobalt and nickel; or three metals of cobalt, manganese, and nickel may be used. As the transition metal M source 801, an aqueous solution containing the transition metal M is prepared.

As the transition metal M source 801, an aqueous solution containing cobalt, such as an aqueous solution of cobalt sulfate or an aqueous solution of cobalt nitrate, can be used; an aqueous solution containing nickel, such as an aqueous solution of nickel sulfate or an aqueous solution of nickel nitrate, can be used; or an aqueous solution containing manganese, such as an aqueous solution of manganese sulfate or an aqueous solution of manganese nitrate, can be used.

For the transition metal M source 801 used in synthesis, a high-purity material is preferably used. Specifically, in the case of using the aqueous solution containing the transition metal M, the aqueous solution is formed using a solute material with a purity higher than or equal to 2N (99%), preferably higher than or equal to 3N (99.9%), further preferably higher than or equal to 4N (99.99%), and water with a specific resistance of preferably 1 MΩ·cm or higher, further preferably 10 MΩ·cm or higher, still further preferably 15 MΩ·cm or higher, which is desirably pure water containing few impurities. The use of a high-purity material can increase the capacity of a secondary battery and/or increase the reliability of the secondary battery.

In the case where a plurality of the transition metal M sources 801 are used, for example, a cobalt source, a manganese source, and a nickel source are used, the mixture ratio is preferably within a range with which a layered rock-salt crystal structure is obtained.

Next, in Step S31, the transition metal M source 801 is mixed, whereby the mixture 811 in Step S32 is obtained.

Next, the aqueous solution A 812 and the aqueous solution B 813 are prepared in Step S33 and Step S34, respectively.

As the aqueous solution A 812, any one of ammonia water and an aqueous solution containing at least one of chelating agents such as glycine, oxine, 1-nitroso-2-naphthol, and 2-mercaptobenzothiazole, or a mixed solution of a plurality of them can be used.

As the aqueous solution B 813, any one of an aqueous solution of sodium hydroxide, an aqueous solution of potassium hydroxide, and an aqueous solution of lithium hydroxide, or a mixed solution of a plurality of them can be used.

Next, in Step S35, the mixture 811 in Step S32, the aqueous solution A 812, and the aqueous solution B 813 are mixed.

As a mixing method in Step S35, a mixing method in which the mixture 811 in Step S32 and the aqueous solution B 813 are dripped into the aqueous solution A 812 that is put in a reaction container can be used. While the mixture 811 in Step S32 is dripped at a constant rate, the aqueous solution B 813 is desirably dripped as appropriate so that the pH of the mixed solution in the reaction container is kept in a predetermined range. In the mixing of Step S35, it is desirable that the solution in the reaction container be stirred with a stirring blade or a stirrer, and that dissolved oxygen in the solution in the reaction container, the mixture 811 in Step S32, the aqueous solution A 812, and the aqueous solution B 813 be removed by N₂ bubbling. In the mixing of Step S35, the pH in the reaction container is preferably greater than or equal to 9 and less than or equal to 11, further preferably greater than or equal to 10.0 and less than or equal to 10.5. In the mixing of Step S35, the temperature of the solution in the reaction container is preferably higher than or equal to 40° C. and lower than or equal to 80° C., further preferably higher than or equal to 50° C. and lower than or equal to 70° C.

Alternatively, as the mixing method in Step S35, a mixing method in which the aqueous solution A 812 and the aqueous solution B 813 are dripped into the mixture 811 in Step S32 that is put in a reaction container can be used. It is preferred to adjust the dripping rates of the aqueous solution A 812 and the aqueous solution B 813 in order to keep the concentration of hydroxyl groups and the concentration of dissolved ions of the aqueous solution A 812 in the reaction container in predetermined ranges. In the mixing of Step S35, it is desirable that the solution in the reaction container be stirred with a stirring blade or a stirrer, and that dissolved oxygen in the solution in the reaction container, the mixture 811 in Step S32, the aqueous solution A 812, and the aqueous solution B 813 be removed by N₂ bubbling. In the mixing of Step S35, the temperature of the solution in the reaction container is preferably higher than or equal to 40° C. and lower than or equal to 80° C., further preferably higher than or equal to 50° C. and lower than or equal to 70° C.

The case where the aqueous solution A 812 is not used in the mixing method in Step S35 is described. A certain amount of the aqueous solution B 813 is dripped and added to the mixture 811 in Step S32 that is put in a reaction container. In the mixing of Step S35, it is desirable that the solution in the reaction container be stirred with a stirring blade or a stirrer, and that dissolved oxygen in the solution in the reaction container, the mixture 811 in Step S32, and the aqueous solution B 813 be removed by N₂ bubbling. In the mixing of Step S35, the temperature of the solution in the reaction container is preferably higher than or equal to 40° C. and lower than or equal to 80° C., further preferably higher than or equal to 50° C. and lower than or equal to 70° C.

The case where pure water is used in addition to the mixture 811 in Step S32, the aqueous solution A 812, and the aqueous solution B 813 in the mixing method in Step S35 is described. While the mixture 811 in Step S32 and the aqueous solution A 812 are dripped into pure water that is put in a reaction container at constant rates, the aqueous solution B 813 can be dripped as appropriate so that the pH of the mixed solution in the reaction container is kept in a predetermined range. In the mixing of Step S35, it is desirable that the solution in the reaction container be stirred with a stirring blade or a stirrer, and that dissolved oxygen in the solution in the reaction container, the mixture 811 in Step S32, the aqueous solution A 812, and the aqueous solution B 813 be removed by N₂ bubbling. In the mixing of Step S35, the pH in the reaction container is preferably greater than or equal to 9 and less than or equal to 11, further preferably greater than or equal to 10.0 and less than or equal to 10.5. In the mixing of Step S35, the temperature of the solution in the reaction container is preferably higher than or equal to 40° C. and lower than or equal to 80° C., further preferably higher than or equal to 50° C. and lower than or equal to 70° C.

Next, in Step S36, a solution that is formed by the mixing in Step S35 and contains a hydroxide containing the transition metal M is filtered and then washed with water. It is desirable that the water used for the washing be pure water containing few impurities, with a specific resistance of preferably 1 MΩ·cm or higher, further preferably 10 MΩ·cm or higher, still further preferably 15 MΩ·cm or higher. The use of the pure water containing few impurities for the washing can remove impurities contained in the hydroxide containing the transition metal M. Accordingly, a high-purity hydroxide containing the transition metal M can be obtained as a precursor of the positive electrode active material 100.

Next, the hydroxide containing the transition metal M after the washing in Step S36 is dried and collected, and crushed and sieved as needed, whereby the mixture 821 in Step S41 is obtained. The mixture 821 is also referred to as the precursor of the positive electrode active material 100. The precursor preferably has high crystallinity, and further preferably includes single-crystal grains. In other words, the precursor is preferably a single crystal.

Next, the lithium compound 822 is prepared in Step S42, and the mixture 821 in Step S41 and the lithium compound 822 are mixed in Step S51. After the mixing, the mixture is collected in Step S52, and crushed and sieved as needed, whereby the mixture 831 in Step S53 is obtained. The mixing can be performed by a dry process or a wet process. A mixer such as a planetary centrifugal mixer, a ball mill, or a bead mill can be used for the mixing, for example. In the case where a planetary centrifugal mixer Awatorirentaro manufactured by THINKY CORPORATION is used as the planetary centrifugal mixer, for example, 1.5-minute treatment at a rotational frequency of 2000 rpm is preferably repeated three times. When a ball mill is used, zirconia balls are preferably used as media, for example. When a ball mill, a bead mill, or the like is used, the peripheral speed is preferably greater than or equal to 100 mm/s and less than or equal to 2000 mm/s in order to inhibit contamination from the media or the material. For example, the mixing is preferably performed at a peripheral speed of 838 mm/s (the rotational frequency is 400 rpm, and the ball mill diameter is 40 mm).

It is preferred to perform the mixing in Step S51 sufficiently so that the mixture 821 and the lithium compound 822 can be mixed evenly.

As the lithium compound 822, lithium hydroxide, lithium carbonate, lithium nitrate, or lithium fluoride can be used, for example. The lithium compound 822 is referred to as a lithium source in some cases.

For the lithium compound 822 used in synthesis, a high-purity material is preferably used. Specifically, the purity of the material is higher than or equal to 4N (99.99%), preferably higher than or equal to 4N5UP (99.995%), further preferably higher than or equal to 5N (99.999%). The use of a high-purity material can increase the capacity of a secondary battery and/or increase the reliability of the secondary battery.

Next, in Step S54, the mixture 831 in Step S53 is heated. The heating temperature is preferably around melting points of the mixture 821 and the lithium compound 822, preferably higher than or equal to 700° C. and lower than 1100° C., further preferably higher than or equal to 800° C. and lower than or equal to 1000° C., still further preferably higher than or equal to 800° C. and lower than or equal to 950° C.

The heating time can be longer than or equal to 1 hour and shorter than or equal to 100 hours, for example, and is preferably longer than or equal to 2 hours and shorter than or equal to hours. The heating is preferably performed in oxygen or an oxygen-containing atmosphere with few moisture (e.g., with a dew point lower than or equal to −50° C., preferably lower than or equal to −80° C.), such as a dry air. In this embodiment, the heating is performed in an atmosphere with a dew point of −93° C. Furthermore, it is suitable to perform the heating in an atmosphere where the concentrations of impurities, CH₄, CO, CO₂, and H₂, are each less than or equal to 5 ppb (parts per billion), in which case impurities can be inhibited from entering the materials.

For example, when the heating is performed at 850° C. for 10 hours, the temperature rise is preferably 200° C./h and the flow rate of a dry atmosphere is preferably 10 L/min. After that, the heated materials can be cooled to room temperature. The temperature decreasing time from the specified temperature to room temperature is preferably longer than or equal to 10 hours and shorter than or equal to 50 hours, for example. Note that the cooling to room temperature in Step S54 is not essential.

Note that a crucible used in the heating in Step S54 is suitably made of a material into which impurities do not enter. In this embodiment, a crucible made of alumina with a purity of 99.9% is used.

It is suitable to collect the materials subjected to the heating in Step S54 after the materials are transferred from the crucible to a mortar because impurities are prevented from entering the materials. The mortar is suitably made of a material into which impurities do not enter. Specifically, it is suitable to use a mortar made of alumina with a purity of 90 wt % or higher, preferably 99 wt % or higher.

Next, the materials baked in the above step are collected in Step S55 and crushed, whereby the mixture 832 in Step S61 is obtained.

Next, in Step S62, the additive element X source 833 is prepared.

As the additive element X contained in the additive element X source 833, one or more selected from nickel, cobalt, magnesium, calcium, chlorine, fluorine, aluminum, manganese, titanium, zirconium, yttrium, vanadium, iron, chromium, niobium, lanthanum, hafnium, zinc, silicon, sulfur, phosphorus, boron, and arsenic can be used. In addition to the above elements, bromine and beryllium may be used as the additive elements X Note that the additive elements X given earlier are more suitable because bromine and beryllium are elements having toxicity to living things.

As the additive element X source 833 in Step S62 in FIG. 8, any one or more of an aqueous solution containing the additive element X, an alkoxide containing the additive element X, and a solid compound containing the additive element X can be used. For example, as shown in S62a or S62b in FIG. 3A and FIG. 3B, one or more solid compounds each containing the additive element X may be prepared, crushing and mixing may be performed, and the mixture (the mixture 843a or the mixture 843b) may be used as the additive element X source 833 in Step S62 in FIG. 8. In the case of using one or more solid compounds each containing the additive element X, mixing may be performed after crushing, crushing may be performed after mixing, or the solid compounds may be used as the additive element X source 833 in Step S62 without being subjected to crushing.

For the additive element X source used in synthesis, a high-purity material is preferably used. Specifically, the purity of the material is higher than or equal to 2N (99%), preferably higher than or equal to 3N (99.9%), further preferably higher than or equal to 4N (99.99%). The use of a high-purity material can increase the capacity of a secondary battery and/or increase the reliability of the secondary battery.

Next, in Step S71, the mixture 832 in Step S61 and the additive element X source 833 in Step S62 are mixed. After the mixing, the mixture is collected in Step S72, and crushed and sieved as needed, whereby the mixture 841 in Step S73 is obtained. The mixing can be performed by a dry process or a wet process. A mixer such as a planetary centrifugal mixer, a ball mill, or a bead mill can be used for the mixing, for example. In the case where a planetary centrifugal mixer Awatorirentaro manufactured by THINKY CORPORATION is used as the planetary centrifugal mixer, for example, 1.5-minute treatment at a rotational frequency of 2000 rpm is preferably repeated three times. When a ball mill is used, zirconia balls are preferably used as media, for example. When a ball mill, a bead mill, or the like is used, the peripheral speed is preferably greater than or equal to 100 mm/s and less than or equal to 2000 mm/s in order to inhibit contamination from the media or the material. For example, the mixing is preferably performed at a peripheral speed of 838 mm/s (the rotational frequency is 400 rpm, and the ball mill diameter is 40 mm).

Next, in Step S74, the mixture 841 in Step S73 is heated. In the heating, a container (crucible) containing the mixture 841 is preferably covered with a lid. Unnecessary evaporation of the raw materials can be prevented. The temperature of the heating in Step S74 is preferably higher than or equal to 500° C. and lower than or equal to 1100° C., further preferably higher than or equal to 500° C. and lower than or equal to 1000° C., still further preferably higher than or equal to 500° C. and lower than or equal to 950° C., yet still further preferably higher than or equal to 500° C. and lower than or equal to 900° C.

As the heating in Step S74, heating by a roller hearth kiln may be performed. When heat treatment is performed by a roller hearth kiln, the mixture 841 may be processed using a heat-resistant container having a lid.

The heating time can be longer than or equal to 1 hour and shorter than or equal to 100 hours, for example, and is preferably longer than or equal to 2 hours and shorter than or equal to hours. The heating is preferably performed in oxygen or an oxygen-containing atmosphere with few moisture (e.g., with a dew point lower than or equal to −50° C., preferably lower than or equal to −80° C.), such as a dry air. In this embodiment, the heating is performed in an atmosphere with a dew point of −93° C. Furthermore, it is suitable to perform the heating in an atmosphere where the concentrations of impurities, CH₄, CO, CO₂, and H₂, are each less than or equal to 5 ppb (parts per billion), in which case impurities can be inhibited from entering the materials.

For example, when the heating is performed at 850° C. for 10 hours, the temperature rise is preferably 200° C./h and the flow rate of a dry atmosphere is preferably 10 L/min. After that, the heated materials can be cooled to room temperature. The temperature decreasing time from the specified temperature to room temperature is preferably longer than or equal to 10 hours and shorter than or equal to 50 hours, for example. Note that the cooling to room temperature in Step S74 is not essential.

Next, the materials baked in the above step are collected and crushed in Step S75, whereby the positive electrode active material 100 in Step S76 is obtained. The materials may be sieved as needed after being crushed. Through the above process, the positive electrode active material 100 of one embodiment of the present invention can be manufactured.

The positive electrode active material 100 preferably has high crystallinity; when the mixture 821 in Step S41 has high crystallinity, the positive electrode active material 100 also has high crystallinity. In the case where the positive electrode active material 100 has high crystallinity and the positive electrode active material 100 includes single-crystal grains, crystal planes where lithium enters and leaves can be aligned. A greater number of the crystal planes where lithium enters and leaves can be exposed to an electrolyte, which improves battery characteristics. Furthermore, the positive electrode active material 100 having high crystallinity and including single-crystal grains is durable; thus, an active material which does not easily deteriorate even when charging and discharging are repeated can be provided.

The positive electrode active material 100 is sometimes referred to as a composite oxide containing lithium, the transition metal M, and oxygen (LiMO₂). Note that the positive electrode active material of one embodiment of the present invention only needs to have a crystal structure of a lithium composite oxide represented by LiMO₂, and the composition is not strictly limited to Li:M:O=1:1:2. For example, in the case where three metals of cobalt, manganese, and nickel are used as the transition metals M and aluminum is used as the additive element X, the positive electrode active material 100 is a composite oxide containing Ni, Co, Mn, and Al (an NCMA). The NCMA may be obtained by adding Al to an NCM in which the ratio of Ni:Co:Mn is any of 1:1:1 and the neighborhood thereof, 9:0.5:0.5 and the neighborhood thereof, 8:1:1 and the neighborhood thereof, 6:2:2 and the neighborhood thereof, and 5:2:3 and the neighborhood thereof. In the case where Ni:Co:Mn is 8:1:1 and the neighborhood thereof, for example, the aluminum concentration is preferably higher than or equal to 0.1 at % and lower than or equal to 2 at %.

When the step of introducing the transition metal M and the step of introducing the additive element X are separately performed as shown in FIG. 8, the element concentration profiles in the depth direction can be made different from each other in some cases. For example, the concentration of the additive element X can be made higher in the surface portion than in the inner portion of a particle. Furthermore, with the number of atoms of the transition metal M as a reference, the ratio of the number of atoms of the additive element X with respect to the reference can be higher in the surface portion than in the inner portion. In the NCMA, a region with an aluminum concentration higher than or equal to 0.1 at % and lower than or equal to 2 at % may be in either the surface portion or the inner portion of the particle.

In one embodiment of the present invention, a positive electrode active material is manufactured using a high-purity material for the transition metal M source used in synthesis and using a process which hardly allows entry of impurities in the synthesis. The manufacturing method in which entry of impurities into the transition metal M source and entry of impurities in the synthesis are thoroughly prevented and in which a desired additive element X is controlled to be introduced into the positive electrode active material can provide a positive electrode active material in which a region with a low impurity concentration and a region where the additive element X is introduced are controlled. The positive electrode active material described in this embodiment is a material having high crystallinity. Furthermore, the positive electrode active material obtained by the manufacturing method of a positive electrode active material, which is one embodiment of the present invention, can increase the capacity of a secondary battery and/or increase the reliability of the secondary battery.

### Embodiment 7

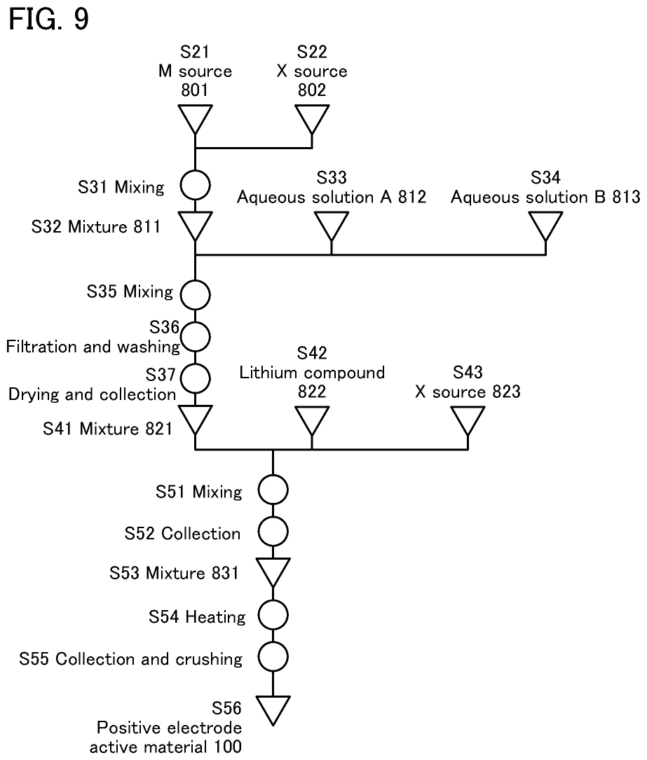

In this embodiment, an example of the manufacturing method of a positive electrode active material of one embodiment of the present invention will be described with reference to FIG. 9.

The transition metal M source 801 and the additive element X source 802 are prepared in Step S21 and Step S22 in FIG. 9, respectively.

As the transition metal M, at least one of manganese, cobalt, and nickel can be used, for example. As the transition metal M, for example, cobalt alone; nickel alone; two metals of cobalt and manganese; two metals of cobalt and nickel; or three metals of cobalt, manganese, and nickel may be used. As the transition metal M source 801, an aqueous solution containing the transition metal M is prepared.

As the transition metal M source 801, an aqueous solution containing cobalt, such as an aqueous solution of cobalt sulfate or an aqueous solution of cobalt nitrate, can be used; an aqueous solution containing nickel, such as an aqueous solution of nickel sulfate or an aqueous solution of nickel nitrate, can be used; or an aqueous solution containing manganese, such as an aqueous solution of manganese sulfate or an aqueous solution of manganese nitrate, can be used.

For the transition metal M source 801 used in synthesis, a high-purity material is preferably used. Specifically, in the case of using the aqueous solution containing the transition metal M, the aqueous solution is formed using a solute material with a purity higher than or equal to 2N (99%), preferably higher than or equal to 3N (99.9%), further preferably higher than or equal to 4N (99.99%), and water with a specific resistance of preferably 1 MΩ·cm or higher, further preferably 10 MΩ·cm or higher, still further preferably 15 MΩ·cm or higher, which is desirably pure water containing few impurities. The use of a high-purity material can increase the capacity of a secondary battery and/or increase the reliability of the secondary battery.

As the additive element X, one or more selected from nickel, cobalt, magnesium, calcium, chlorine, fluorine, aluminum, manganese, titanium, zirconium, yttrium, vanadium, iron, chromium, niobium, lanthanum, hafnium, zinc, silicon, sulfur, phosphorus, boron, and arsenic can be used. In addition to the above elements, bromine and beryllium may be used as additive elements. Note that the additive elements X given earlier are more suitable because bromine and beryllium are elements having toxicity to living things.

As the additive element X source 802, any one or more of an aqueous solution containing the additive element X, an alkoxide containing the additive element X, and a solid compound containing the additive element X can be used. An aqueous solution containing the additive element X is preferably prepared as the additive element X source 802 in Step S22.

For the additive element X source 802 used in synthesis, a high-purity material is preferably used. Specifically, the purity of the material is higher than or equal to 2N (99%), preferably higher than or equal to 3N (99.9%), further preferably higher than or equal to 4N (99.99%). The use of a high-purity material can increase the capacity of a secondary battery and/or increase the reliability of the secondary battery.

Next, in Step S31, the transition metal M source 801 and the additive element X source 802 are mixed, whereby the mixture 811 in Step S32 is obtained.

Next, the aqueous solution A 812 and the aqueous solution B 813 are prepared in Step S33 and Step S34, respectively.

As the aqueous solution A 812, any one of ammonia water and an aqueous solution containing at least one of chelating agents such as glycine, oxine, 1-nitroso-2-naphthol, and 2-mercaptobenzothiazole, or a mixed solution of a plurality of them can be used.

As the aqueous solution B 813, any one of an aqueous solution of sodium hydroxide, an aqueous solution of potassium hydroxide, and an aqueous solution of lithium hydroxide, or a mixed solution of a plurality of them can be used.

Next, in Step S35, the mixture 811 in Step S32, the aqueous solution A 812, and the aqueous solution B 813 are mixed.

As a mixing method in Step S35, a mixing method in which the mixture 811 in Step S32 and the aqueous solution B 813 are dripped into the aqueous solution A 812 that is put in a reaction container can be used. While the mixture 811 in Step S32 is dripped at a constant rate, the aqueous solution B 813 is desirably dripped as appropriate so that the pH of the mixed solution in the reaction container is kept in a predetermined range. In the mixing of Step S35, it is desirable that the solution in the reaction container be stirred with a stirring blade or a stirrer, and that dissolved oxygen in the solution in the reaction container, the mixture 811 in Step S32, the aqueous solution A 812, and the aqueous solution B 813 be removed by N₂ bubbling. In the mixing of Step S35, the pH in the reaction container is preferably greater than or equal to 9 and less than or equal to 11, further preferably greater than or equal to 10.0 and less than or equal to 10.5. In the mixing of Step S35, the temperature of the solution in the reaction container is preferably higher than or equal to 40° C. and lower than or equal to 80° C., further preferably higher than or equal to 50° C. and lower than or equal to 70° C.

Alternatively, as the mixing method in Step S35, a mixing method in which the aqueous solution A 812 and the aqueous solution B 813 are dripped into the mixture 811 in Step S32 that is put in a reaction container can be used. It is preferred to adjust the dripping rates of the aqueous solution A 812 and the aqueous solution B 813 in order to keep the concentration of hydroxyl groups and the concentration of dissolved ions of the aqueous solution A 812 in the reaction container in predetermined ranges. In the mixing of Step S35, it is desirable that the solution in the reaction container be stirred with a stirring blade or a stirrer, and that dissolved oxygen in the solution in the reaction container, the mixture 811 in Step S32, the aqueous solution A 812, and the aqueous solution B 813 be removed by N₂ bubbling. In the mixing of Step S35, the temperature of the solution in the reaction container is preferably higher than or equal to 40° C. and lower than or equal to 80° C., further preferably higher than or equal to 50° C. and lower than or equal to 70° C.

The case where the aqueous solution A 812 is not used in the mixing method in Step S35 is described. A certain amount of the aqueous solution B 813 is dripped and added to the mixture 811 in Step S32 that is put in a reaction container. In the mixing of Step S35, it is desirable that the solution in the reaction container be stirred with a stirring blade or a stirrer, and that dissolved oxygen in the solution in the reaction container, the mixture 811 in Step S32, and the aqueous solution B 813 be removed by N₂ bubbling. In the mixing of Step S35, the temperature of the solution in the reaction container is preferably higher than or equal to 40° C. and lower than or equal to 80° C., further preferably higher than or equal to 50° C. and lower than or equal to 70° C.

The case where pure water is used in addition to the mixture 811 in Step S32, the aqueous solution A 812, and the aqueous solution B 813 in the mixing method in Step S35 is described. While the mixture 811 in Step S32 and the aqueous solution A 812 are dripped into pure water that is put in a reaction container at constant rates, the aqueous solution B 813 can be dripped as appropriate so that the pH of the mixed solution in the reaction container is kept in a predetermined range. In the mixing of Step S35, it is desirable that the solution in the reaction container be stirred with a stirring blade or a stirrer, and that dissolved oxygen in the solution in the reaction container, the mixture 811 in Step S32, the aqueous solution A 812, and the aqueous solution B 813 be removed by N₂ bubbling. In the mixing of Step S35, the pH in the reaction container is preferably greater than or equal to 9 and less than or equal to 11, further preferably greater than or equal to 10.0 and less than or equal to 10.5. In the mixing of Step S35, the temperature of the solution in the reaction container is preferably higher than or equal to 40° C. and lower than or equal to 80° C., further preferably higher than or equal to 50° C. and lower than or equal to 70° C.

Next, in Step S36, a solution that is formed by the mixing in Step S35 and contains a hydroxide containing the transition metal M is filtered and then washed with water. It is desirable that the water used for the washing be pure water containing few impurities, with a specific resistance of preferably 1 MΩ·cm or higher, further preferably 10 MΩ·cm or higher, still further preferably 15 MΩ·cm or higher. The use of the pure water containing few impurities for the washing can remove impurities contained in the hydroxide containing the transition metal M. Accordingly, a high-purity hydroxide containing the transition metal M can be obtained as a precursor of the positive electrode active material 100.

Next, the hydroxide containing the transition metal M and the additive element X after the washing in Step S36 is dried and collected, and crushed and sieved as needed, whereby the mixture 821 in Step S41 is obtained. The mixture 821 is also referred to as the precursor of the positive electrode active material 100. The precursor preferably has high crystallinity, and further preferably includes single-crystal grains. In other words, the precursor is preferably a single crystal.

Next, the lithium compound 822 is prepared in Step S42, and the additive element X source 823 is prepared in Step S43. In Step S51, the mixture 821 in Step S41, the lithium compound 822, and the additive element X source 823 are mixed. After the mixing, the mixture is collected in Step S52, and crushed and sieved as needed, whereby the mixture 831 in Step S53 is obtained. The mixing can be performed by a dry process or a wet process. A mixer such as a planetary centrifugal mixer, a ball mill, or a bead mill can be used for the mixing, for example. In the case where a planetary centrifugal mixer Awatorirentaro manufactured by THINKY CORPORATION is used as the planetary centrifugal mixer, for example, 1.5-minute treatment at a rotational frequency of 2000 rpm is preferably repeated three times. When a ball mill is used, zirconia balls are preferably used as media, for example. When a ball mill, a bead mill, or the like is used, the peripheral speed is preferably greater than or equal to 100 mm/s and less than or equal to 2000 mm/s in order to inhibit contamination from the media or the material. For example, the mixing is preferably performed at a peripheral speed of 838 mm/s (the rotational frequency is 400 rpm, and the ball mill diameter is 40 mm).

It is preferred to perform the mixing in Step S51 sufficiently so that the mixture 821 and the lithium compound 822 can be mixed evenly.

As the lithium compound 822, lithium hydroxide, lithium carbonate, lithium nitrate, or lithium fluoride can be used, for example. The lithium compound 822 is referred to as a lithium source in some cases.

For the lithium compound 822 used in synthesis, a high-purity material is preferably used. Specifically, the purity of the material is higher than or equal to 4N (99.99%), preferably higher than or equal to 4N5UP (99.995%), further preferably higher than or equal to 5N (99.999%). The use of a high-purity material can increase the capacity of a secondary battery and/or increase the reliability of the secondary battery.

As the additive element X, one or more selected from nickel, cobalt, magnesium, calcium, chlorine, fluorine, aluminum, manganese, titanium, zirconium, yttrium, vanadium, iron, chromium, niobium, lanthanum, hafnium, zinc, silicon, sulfur, phosphorus, boron, and arsenic can be used. In addition to the above elements, bromine and beryllium may be used as the additive elements X Note that the additive elements X given earlier are more suitable because bromine and beryllium are elements having toxicity to living things.

As the additive element X source 823 in Step S43, any one or more of an aqueous solution containing the additive element X, an alkoxide containing the additive element X, and a solid compound containing the additive element X can be used.

For the additive element X source used in synthesis, a high-purity material is preferably used. Specifically, the purity of the material is higher than or equal to 2N (99%), preferably higher than or equal to 3N (99.9%), further preferably higher than or equal to 4N (99.99%). The use of a high-purity material can increase the capacity of a secondary battery and/or increase the reliability of the secondary battery.

Next, in Step S54, the mixture 831 in Step S53 is heated. In the heating, a container (crucible) containing the mixture 831 is preferably covered with a lid. Unnecessary evaporation of the raw materials can be prevented. The heating is preferably performed at higher than or equal to 700° C. and lower than 1100° C., further preferably at higher than or equal to 800° C. and lower than or equal to 1000° C., still further preferably at higher than or equal to 800° C. and lower than or equal to 950° C.

The heating time can be longer than or equal to 1 hour and shorter than or equal to 100 hours, for example, and is preferably longer than or equal to 2 hours and shorter than or equal to hours. The heating is preferably performed in oxygen or an oxygen-containing atmosphere with few moisture (e.g., with a dew point lower than or equal to −50° C., preferably lower than or equal to −80° C.), such as a dry air. In this embodiment, the heating is performed in an atmosphere with a dew point of −93° C. Furthermore, it is suitable to perform the heating in an atmosphere where the concentrations of impurities, CH₄, CO, CO₂, and H₂, are each less than or equal to 5 ppb (parts per billion), in which case impurities can be inhibited from entering the materials.

For example, when the heating is performed at 850° C. for 10 hours, the temperature rise is preferably 200° C./h and the flow rate of a dry atmosphere is preferably 10 L/min. After that, the heated materials can be cooled to room temperature. The temperature decreasing time from the specified temperature to room temperature is preferably longer than or equal to 10 hours and shorter than or equal to 50 hours, for example. Note that the cooling to room temperature in Step S54 is not essential.

Note that the crucible used in the heating in Step S54 is suitably made of a material into which impurities do not enter. In this embodiment, a crucible made of alumina with a purity of 99.9% is used.

It is suitable to collect the materials subjected to the heating in Step S54 after the materials are transferred from the crucible to a mortar because impurities are prevented from entering the materials. The mortar is suitably made of a material into which impurities do not enter. Specifically, it is suitable to use a mortar made of alumina with a purity of 90 wt % or higher, preferably 99 wt % or higher.

Next, the materials baked in the above step are collected in Step S55 and crushed, whereby the positive electrode active material 100 in Step S56 is obtained. The materials may be sieved as needed after being crushed. Through the above process, the positive electrode active material 100 of one embodiment of the present invention can be manufactured.

The positive electrode active material 100 preferably has high crystallinity; when the mixture 821 in Step S41 has high crystallinity, the positive electrode active material 100 also has high crystallinity. In the case where the positive electrode active material 100 has high crystallinity and the positive electrode active material 100 includes single-crystal grains, crystal planes where lithium enters and leaves can be aligned. A greater number of the crystal planes where lithium enters and leaves can be exposed to an electrolyte, which improves battery characteristics. Furthermore, the positive electrode active material 100 having high crystallinity and including single-crystal grains is durable; thus, an active material which does not easily deteriorate even when charging and discharging are repeated can be provided.

The positive electrode active material 100 is sometimes referred to as a composite oxide containing lithium, the transition metal M, and oxygen (LiMO₂). Note that the positive electrode active material of one embodiment of the present invention only needs to have a crystal structure of a lithium composite oxide represented by LiMO₂, and the composition is not strictly limited to Li:M:O=1:1:2. For example, in the case where three metals of cobalt, manganese, and nickel are used as the transition metals M and aluminum is used as the additive element X, the positive electrode active material 100 is a composite oxide containing Ni, Co, Mn, and Al (an NCMA). The NCMA may be obtained by adding Al to an NCM in which the ratio of Ni:Co:Mn is any of 1:1:1 and the neighborhood thereof, 9:0.5:0.5 and the neighborhood thereof, 8:1:1 and the neighborhood thereof, 6:2:2 and the neighborhood thereof, and 5:2:3 and the neighborhood thereof. In the case where Ni:Co:Mn is 8:1:1 and the neighborhood thereof, for example, the aluminum concentration is preferably higher than or equal to 0.1 at % and lower than or equal to 2 at %.

When the step of introducing the transition metal M and the steps of introducing the additive elements X are separately performed as shown in FIG. 9, the element concentration profiles in the depth direction can be made different from each other in some cases. For example, the concentration of each of the additive elements X can be made higher in the surface portion than in the inner portion of a particle. Furthermore, with the number of atoms of the transition metal M as a reference, the ratio of the number of atoms of each of the additive elements X with respect to the reference can be higher in the surface portion than in the inner portion. In the NCMA, a region with an aluminum concentration higher than or equal to 0.1 at % and lower than or equal to 2 at % may be in either the surface portion or the inner portion of the particle.

In one embodiment of the present invention, a positive electrode active material is manufactured using a high-purity material for the transition metal M source used in synthesis and using a process which hardly allows entry of impurities in the synthesis. The manufacturing method in which entry of impurities into the transition metal M source and entry of impurities in the synthesis are thoroughly prevented and in which a desired additive element X is controlled to be introduced into the positive electrode active material can provide a positive electrode active material in which a region with a low impurity concentration and a region where the additive element X is introduced are controlled. The positive electrode active material described in this embodiment is a material having high crystallinity. Furthermore, the positive electrode active material obtained by the manufacturing method of a positive electrode active material, which is one embodiment of the present invention, can increase the capacity of a secondary battery and/or increase the reliability of the secondary battery.

### Embodiment 8

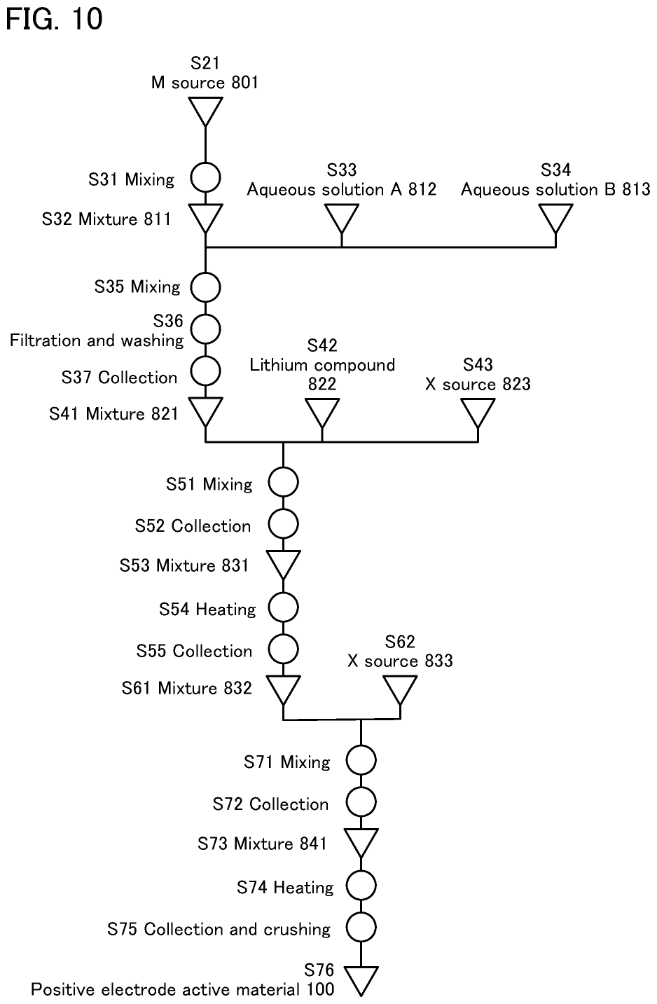

In this embodiment, an example of the manufacturing method of a positive electrode active material of one embodiment of the present invention will be described with reference to FIG. 10.

The transition metal M source 801 is prepared in Step S21 in FIG. 10.

As the transition metal M, at least one of manganese, cobalt, and nickel can be used, for example. As the transition metal M, for example, cobalt alone; nickel alone; two metals of cobalt and manganese; two metals of cobalt and nickel; or three metals of cobalt, manganese, and nickel may be used. As the transition metal M source 801, an aqueous solution containing the transition metal M is prepared.

As the transition metal M source 801, an aqueous solution containing cobalt, such as an aqueous solution of cobalt sulfate or an aqueous solution of cobalt nitrate, can be used; an aqueous solution containing nickel, such as an aqueous solution of nickel sulfate or an aqueous solution of nickel nitrate, can be used; or an aqueous solution containing manganese, such as an aqueous solution of manganese sulfate or an aqueous solution of manganese nitrate, can be used.

For the transition metal M source 801 used in synthesis, a high-purity material is preferably used. Specifically, in the case of using the aqueous solution containing the transition metal M, the aqueous solution is formed using a solute material with a purity higher than or equal to 2N (99%), preferably higher than or equal to 3N (99.9%), further preferably higher than or equal to 4N (99.99%), and water with a specific resistance of preferably 1 MΩ·cm or higher, further preferably 10 MΩ·cm or higher, still further preferably 15 MΩ·cm or higher, which is desirably pure water containing few impurities. The use of a high-purity material can increase the capacity of a secondary battery and/or increase the reliability of the secondary battery.

In the case where a plurality of the transition metal M sources 801 are used, for example, a cobalt source, a manganese source, and a nickel source are used, the mixture ratio is preferably within a range with which a layered rock-salt crystal structure is obtained.

Next, in Step S31, the transition metal M source is mixed, whereby the mixture 811 in Step S32 is obtained.

Next, the aqueous solution A 812 and the aqueous solution B 813 are prepared in Step S33 and Step S34, respectively.

As the aqueous solution A 812, any one of ammonia water and an aqueous solution containing at least one of chelating agents such as glycine, oxine, 1-nitroso-2-naphthol, and 2-mercaptobenzothiazole, or a mixed solution of a plurality of them can be used.

As the aqueous solution B 813, any one of an aqueous solution of sodium hydroxide, an aqueous solution of potassium hydroxide, and an aqueous solution of lithium hydroxide, or a mixed solution of a plurality of them can be used.

Next, in Step S35, the mixture 811 in Step S32, the aqueous solution A 812, and the aqueous solution B 813 are mixed.

As a mixing method in Step S35, a mixing method in which the mixture 811 in Step S32 and the aqueous solution B 813 are dripped into the aqueous solution A 812 that is put in a reaction container can be used. While the mixture 811 in Step S32 is dripped at a constant rate, the aqueous solution B 813 is desirably dripped as appropriate so that the pH of the mixed solution in the reaction container is kept in a predetermined range. In the mixing of Step S35, it is desirable that the solution in the reaction container be stirred with a stirring blade or a stirrer, and that dissolved oxygen in the solution in the reaction container, the mixture 811 in Step S32, the aqueous solution A 812, and the aqueous solution B 813 be removed by N₂ bubbling. In the mixing of Step S35, the pH in the reaction container is preferably greater than or equal to 9 and less than or equal to 11, further preferably greater than or equal to 10.0 and less than or equal to 10.5. In the mixing of Step S35, the temperature of the solution in the reaction container is preferably higher than or equal to 40° C. and lower than or equal to 80° C., further preferably higher than or equal to 50° C. and lower than or equal to 70° C.

Alternatively, as the mixing method in Step S35, a mixing method in which the aqueous solution A 812 and the aqueous solution B 813 are dripped into the mixture 811 in Step S32 that is put in a reaction container can be used. It is preferred to adjust the dripping rates of the aqueous solution A 812 and the aqueous solution B 813 in order to keep the concentration of hydroxyl groups and the concentration of dissolved ions of the aqueous solution A 812 in the reaction container in predetermined ranges. In the mixing of Step S35, it is desirable that the solution in the reaction container be stirred with a stirring blade or a stirrer, and that dissolved oxygen in the solution in the reaction container, the mixture 811 in Step S32, the aqueous solution A 812, and the aqueous solution B 813 be removed by N₂ bubbling. In the mixing of Step S35, the temperature of the solution in the reaction container is preferably higher than or equal to 40° C. and lower than or equal to 80° C., further preferably higher than or equal to 50° C. and lower than or equal to 70° C.

The case where the aqueous solution A 812 is not used in the mixing method in Step S35 is described. A certain amount of the aqueous solution B 813 is dripped and added to the mixture 811 in Step S32 that is put in a reaction container. In the mixing of Step S35, it is desirable that the solution in the reaction container be stirred with a stirring blade or a stirrer, and that dissolved oxygen in the solution in the reaction container, the mixture 811 in Step S32, and the aqueous solution B 813 be removed by N₂ bubbling. In the mixing of Step S35, the temperature of the solution in the reaction container is preferably higher than or equal to 40° C. and lower than or equal to 80° C., further preferably higher than or equal to 50° C. and lower than or equal to 70° C.

The case where pure water is used in addition to the mixture 811 in Step S32, the aqueous solution A 812, and the aqueous solution B 813 in the mixing method in Step S35 is described. While the mixture 811 in Step S32 and the aqueous solution A 812 are dripped into pure water that is put in a reaction container at constant rates, the aqueous solution B 813 can be dripped as appropriate so that the pH of the mixed solution in the reaction container is kept in a predetermined range. In the mixing of Step S35, it is desirable that the solution in the reaction container be stirred with a stirring blade or a stirrer, and that dissolved oxygen in the solution in the reaction container, the mixture 811 in Step S32, the aqueous solution A 812, and the aqueous solution B 813 be removed by N₂ bubbling. In the mixing of Step S35, the pH in the reaction container is preferably greater than or equal to 9 and less than or equal to 11, further preferably greater than or equal to 10.0 and less than or equal to 10.5. In the mixing of Step S35, the temperature of the solution in the reaction container is preferably higher than or equal to 40° C. and lower than or equal to 80° C., further preferably higher than or equal to 50° C. and lower than or equal to 70° C.

Next, in Step S36, a solution that is formed by the mixing in Step S35 and contains a hydroxide containing the transition metal M is filtered and then washed with water. It is desirable that the water used for the washing be pure water containing few impurities, with a specific resistance of preferably 1 MΩ·cm or higher, further preferably 10 MΩ·cm or higher, still further preferably 15 MΩ·cm or higher. The use of the pure water containing few impurities for the washing can remove impurities contained in the hydroxide containing the transition metal M. Accordingly, a high-purity hydroxide containing the transition metal M can be obtained as a precursor of the positive electrode active material 100.

Next, the hydroxide containing the transition metal M after the washing in Step S36 is dried and collected, and crushed and sieved as needed, whereby the mixture 821 in Step S41 is obtained. The mixture 821 is also referred to as the precursor of the positive electrode active material 100. The precursor preferably has high crystallinity, and further preferably includes single-crystal grains. In other words, the precursor is preferably a single crystal.

Next, the lithium compound 822 is prepared in Step S42, and an additive element X source 823 is prepared in Step S43. In Step S51, the mixture 821 in Step S41, the lithium compound 822, and the additive element X source 823 are mixed. After the mixing, the mixture is collected in Step S52, and crushed and sieved as needed, whereby the mixture 831 in Step S53 is obtained. The mixing can be performed by a dry process or a wet process. A mixer such as a planetary centrifugal mixer, a ball mill, or a bead mill can be used for the mixing, for example. In the case where a planetary centrifugal mixer Awatorirentaro manufactured by THINKY CORPORATION is used as the planetary centrifugal mixer, for example, 1.5-minute treatment at a rotational frequency of 2000 rpm is preferably repeated three times. When a ball mill is used, zirconia balls are preferably used as media, for example. When a ball mill, a bead mill, or the like is used, the peripheral speed is preferably greater than or equal to 100 mm/s and less than or equal to 2000 mm/s in order to inhibit contamination from the media or the material. For example, the mixing is preferably performed at a peripheral speed of 838 mm/s (the rotational frequency is 400 rpm, and the ball mill diameter is 40 mm).

It is preferred to perform the mixing in Step S51 sufficiently so that the mixture 821 and the lithium compound 822 can be mixed evenly.

As the lithium compound 822, lithium hydroxide, lithium carbonate, lithium nitrate, or lithium fluoride can be used, for example. The lithium compound 822 is referred to as a lithium source in some cases.

For the lithium compound 822 used in synthesis, a high-purity material is preferably used. Specifically, the purity of the material is higher than or equal to 4N (99.99%), preferably higher than or equal to 4N5UP (99.995%), further preferably higher than or equal to 5N (99.999%). The use of a high-purity material can increase the capacity of a secondary battery and/or increase the reliability of the secondary battery.

As the additive element X, one or more selected from nickel, cobalt, magnesium, calcium, chlorine, fluorine, aluminum, manganese, titanium, zirconium, yttrium, vanadium, iron, chromium, niobium, lanthanum, hafnium, zinc, silicon, sulfur, phosphorus, boron, and arsenic can be used. In addition to the above elements, bromine and beryllium may be used as the additive elements X Note that the additive elements X given earlier are more suitable because bromine and beryllium are elements having toxicity to living things.

As the additive element X source 823 in Step S43, any one or more of an aqueous solution containing the additive element X, an alkoxide containing the additive element X, and a solid compound containing the additive element X can be used.

For the additive element X source used in synthesis, a high-purity material is preferably used. Specifically, the purity of the material is higher than or equal to 2N (99%), preferably higher than or equal to 3N (99.9%), further preferably higher than or equal to 4N (99.99%). The use of a high-purity material can increase the capacity of a secondary battery and/or increase the reliability of the secondary battery.

Next, in Step S54, the mixture 831 in Step S53 is heated. The heating temperature is preferably around melting points of the mixture 821 and the lithium compound 822, preferably higher than or equal to 700° C. and lower than 1100° C., further preferably higher than or equal to 800° C. and lower than or equal to 1000° C., still further preferably higher than or equal to 800° C. and lower than or equal to 950° C.

The heating time can be longer than or equal to 1 hour and shorter than or equal to 100 hours, for example, and is preferably longer than or equal to 2 hours and shorter than or equal to 20 hours. The heating is preferably performed in oxygen or an oxygen-containing atmosphere with few moisture (e.g., with a dew point lower than or equal to −50° C., preferably lower than or equal to −80° C.), such as a dry air. In this embodiment, the heating is performed in an atmosphere with a dew point of −93° C. Furthermore, it is suitable to perform the heating in an atmosphere where the concentrations of impurities, CH₄, CO, CO₂, and H₂, are each less than or equal to 5 ppb (parts per billion), in which case impurities can be inhibited from entering the materials.

For example, when the heating is performed at 850° C. for 10 hours, the temperature rise is preferably 200° C./h and the flow rate of a dry atmosphere is preferably 10 L/min. After that, the heated materials can be cooled to room temperature. The temperature decreasing time from the specified temperature to room temperature is preferably longer than or equal to 10 hours and shorter than or equal to 50 hours, for example. Note that the cooling to room temperature in Step S54 is not essential.

Note that the crucible used in the heating in Step S54 is suitably made of a material into which impurities do not enter. In this embodiment, a crucible made of alumina with a purity of 99.9% is used.

It is suitable to collect the materials subjected to the heating in Step S54 after the materials are transferred from the crucible to a mortar because impurities are prevented from entering the materials. The mortar is suitably made of a material into which impurities do not enter. Specifically, it is suitable to use a mortar made of alumina with a purity of 90 wt % or higher, preferably 99 wt % or higher.

Next, the materials baked in the above step are collected in Step S55 and crushed, whereby the mixture 832 in Step S61 is obtained. The materials may be sieved as needed after being crushed.

Next, in Step S62, the additive element X source 833 is prepared.

As the additive element X contained in the additive element X source 833, one or more selected from nickel, cobalt, magnesium, calcium, chlorine, fluorine, aluminum, manganese, titanium, zirconium, yttrium, vanadium, iron, chromium, niobium, lanthanum, hafnium, zinc, silicon, sulfur, phosphorus, boron, and arsenic can be used. In addition to the above elements, bromine and beryllium may be used as the additive elements X Note that the additive elements X given earlier are more suitable because bromine and beryllium are elements having toxicity to living things.

As the additive element X source 833 in Step S62 in FIG. 10, any one or more of an aqueous solution containing the additive element X, an alkoxide containing the additive element X, and a solid compound containing the additive element X can be used. For example, as shown in S62a or S62b in FIG. 3A and FIG. 3B, one or more solid compounds each containing the additive element X may be prepared, crushing and mixing may be performed, and the mixture (the mixture 843a or the mixture 843b) may be used as the additive element X source 833 in Step S62 in FIG. 10. In the case of using one or more solid compounds each containing the additive element X, mixing may be performed after crushing, crushing may be performed after mixing, or the solid compounds may be used as the additive element X source 833 in Step S62 without being subjected to crushing.

For the additive element X source used in synthesis, a high-purity material is preferably used. Specifically, the purity of the material is higher than or equal to 2N (99%), preferably higher than or equal to 3N (99.9%), further preferably higher than or equal to 4N (99.99%). The use of a high-purity material can increase the capacity of a secondary battery and/or increase the reliability of the secondary battery.

Next, in Step S71, the mixture 832 in Step S61 and the additive element X source 833 in Step S62 are mixed. After the mixing, the mixture is collected in Step S72, and crushed and sieved as needed, whereby the mixture 841 in Step S73 is obtained. The mixing can be performed by a dry process or a wet process. A mixer such as a planetary centrifugal mixer, a ball mill, or a bead mill can be used for the mixing, for example. In the case where a planetary centrifugal mixer Awatorirentaro manufactured by THINKY CORPORATION is used as the planetary centrifugal mixer, for example, 1.5-minute treatment at a rotational frequency of 2000 rpm is preferably repeated three times. When a ball mill is used, zirconia balls are preferably used as media, for example. When a ball mill, a bead mill, or the like is used, the peripheral speed is preferably greater than or equal to 100 mm/s and less than or equal to 2000 mm/s in order to inhibit contamination from the media or the material. For example, the mixing is preferably performed at a peripheral speed of 838 mm/s (the rotational frequency is 400 rpm, and the ball mill diameter is 40 mm).

Next, in Step S74, the mixture 841 in Step S73 is heated. In the heating, a container (crucible) containing the mixture 841 is preferably covered with a lid. Unnecessary evaporation of the raw materials can be prevented. The temperature of the heating in Step S74 is preferably higher than or equal to 500° C. and lower than or equal to 1100° C., further preferably higher than or equal to 500° C. and lower than or equal to 1000° C., still further preferably higher than or equal to 500° C. and lower than or equal to 950° C., yet still further preferably higher than or equal to 500° C. and lower than or equal to 900° C.

As the heating in Step S74, heating by a roller hearth kiln may be performed. When heat treatment is performed by a roller hearth kiln, the mixture 841 may be processed using a heat-resistant container having a lid.

The heating time can be longer than or equal to 1 hour and shorter than or equal to 100 hours, for example, and is preferably longer than or equal to 2 hours and shorter than or equal to hours. The heating is preferably performed in oxygen or an oxygen-containing atmosphere with few moisture (e.g., with a dew point lower than or equal to −50° C., preferably lower than or equal to −80° C.), such as a dry air. In this embodiment, the heating is performed in an atmosphere with a dew point of −93° C. Furthermore, it is suitable to perform the heating in an atmosphere where the concentrations of impurities, CH₄, CO, CO₂, and H₂, are each less than or equal to 5 ppb (parts per billion), in which case impurities can be inhibited from entering the materials.

For example, when the heating is performed at 850° C. for 10 hours, the temperature rise is preferably 200° C./h and the flow rate of a dry atmosphere is preferably 10 L/min. After that, the heated materials can be cooled to room temperature. The temperature decreasing time from the specified temperature to room temperature is preferably longer than or equal to 10 hours and shorter than or equal to 50 hours, for example. Note that the cooling to room temperature in Step S74 is not essential.

Next, the materials baked in the above step are collected and crushed in Step S75, whereby the positive electrode active material 100 in Step S76 is obtained. The materials may be sieved as needed after being crushed. Through the above process, the positive electrode active material 100 of one embodiment of the present invention can be manufactured.

The positive electrode active material 100 preferably has high crystallinity; when the mixture 821 in Step S41 has high crystallinity, the positive electrode active material 100 also has high crystallinity. In the case where the positive electrode active material 100 has high crystallinity and the positive electrode active material 100 includes single-crystal grains, crystal planes where lithium enters and leaves can be aligned. A greater number of the crystal planes where lithium enters and leaves can be exposed to an electrolyte, which improves battery characteristics. Furthermore, the positive electrode active material 100 having high crystallinity and including single-crystal grains is durable; thus, an active material which does not easily deteriorate even when charging and discharging are repeated can be provided.

The positive electrode active material 100 is sometimes referred to as a composite oxide containing lithium, the transition metal M, and oxygen (LiMO₂). Note that the positive electrode active material of one embodiment of the present invention only needs to have a crystal structure of a lithium composite oxide represented by LiMO₂, and the composition is not strictly limited to Li:M:O=1:1:2. For example, in the case where three metals of cobalt, manganese, and nickel are used as the transition metals M and aluminum is used as the additive element X, the positive electrode active material 100 is a composite oxide containing Ni, Co, Mn, and Al (an NCMA). The NCMA may be obtained by adding Al to an NCM in which the ratio of Ni:Co:Mn is any of 1:1:1 and the neighborhood thereof, 9:0.5:0.5 and the neighborhood thereof, 8:1:1 and the neighborhood thereof, 6:2:2 and the neighborhood thereof, and 5:2:3 and the neighborhood thereof. In the case where Ni:Co:Mn is 8:1:1 and the neighborhood thereof, for example, the aluminum concentration is preferably higher than or equal to 0.1 at % and lower than or equal to 2 at %.

When the step of introducing the transition metal M and the steps of introducing the additive elements X are separately performed as shown in FIG. 10, the element concentration profiles in the depth direction can be made different from each other in some cases. For example, the concentration of each of the additive elements X can be made higher in the surface portion than in the inner portion of a particle. Furthermore, with the number of atoms of the transition metal M as a reference, the ratio of the number of atoms of each of the additive elements X with respect to the reference can be higher in the surface portion than in the inner portion. In the NCMA, a region with an aluminum concentration higher than or equal to 0.1 at % and lower than or equal to 2 at % may be in either the surface portion or the inner portion of the particle.

In one embodiment of the present invention, a positive electrode active material is manufactured using a high-purity material for the transition metal M source used in synthesis and using a process which hardly allows entry of impurities in the synthesis. The manufacturing method in which entry of impurities into the transition metal M source and entry of impurities in the synthesis are thoroughly prevented and in which desired additive elements X are controlled to be introduced into the positive electrode active material can provide a positive electrode active material in which a region with a low impurity concentration and a region where the additive elements X are introduced are controlled. The positive electrode active material described in this embodiment is a material having high crystallinity. Furthermore, the positive electrode active material obtained by the manufacturing method of a positive electrode active material, which is one embodiment of the present invention, can increase the capacity of a secondary battery and/or increase the reliability of the secondary battery.

### Embodiment 9

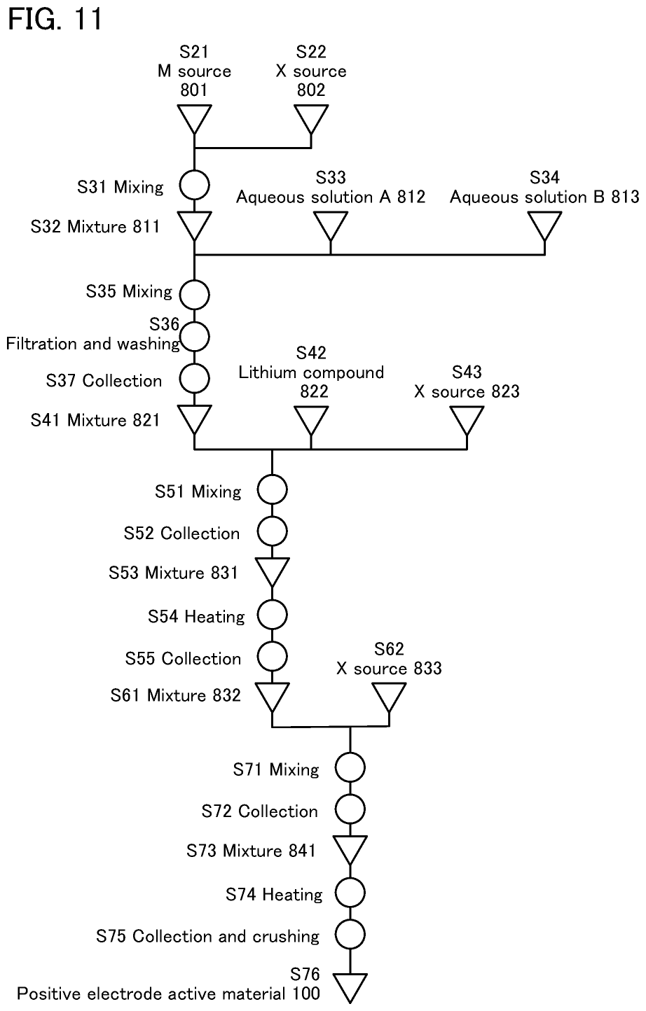

In this embodiment, an example of the manufacturing method of a positive electrode active material of one embodiment of the present invention will be described with reference to FIG. 11.

The transition metal M source 801 and the additive element X source 802 are prepared in Step S21 and Step S22 in FIG. 11, respectively.

As the transition metal M, at least one of manganese, cobalt, and nickel can be used, for example. As the transition metal M, for example, cobalt alone; nickel alone; two metals of cobalt and manganese; two metals of cobalt and nickel; or three metals of cobalt, manganese, and nickel may be used. As the transition metal M source 801, an aqueous solution containing the transition metal M is prepared.

As the transition metal M source 801, an aqueous solution containing cobalt, such as an aqueous solution of cobalt sulfate or an aqueous solution of cobalt nitrate, can be used; an aqueous solution containing nickel, such as an aqueous solution of nickel sulfate or an aqueous solution of nickel nitrate, can be used; or an aqueous solution containing manganese, such as an aqueous solution of manganese sulfate or an aqueous solution of manganese nitrate, can be used.

For the transition metal M source 801 used in synthesis, a high-purity material is preferably used. Specifically, in the case of using the aqueous solution containing the transition metal M, the aqueous solution is formed using a solute material with a purity higher than or equal to 2N (99%), preferably higher than or equal to 3N (99.9%), further preferably higher than or equal to 4N (99.99%), and water with a specific resistance of preferably 1 MΩ·cm or higher, further preferably 10 MΩ·cm or higher, still further preferably 15 MΩ·cm or higher, which is desirably pure water containing few impurities. The use of a high-purity material can increase the capacity of a secondary battery and/or increase the reliability of the secondary battery.

As the additive element X, one or more selected from nickel, cobalt, magnesium, calcium, chlorine, fluorine, aluminum, manganese, titanium, zirconium, yttrium, vanadium, iron, chromium, niobium, lanthanum, hafnium, zinc, silicon, sulfur, phosphorus, boron, and arsenic can be used. In addition to the above elements, bromine and beryllium may be used as the additive elements X Note that the additive elements X given earlier are more suitable because bromine and beryllium are elements having toxicity to living things.

As the additive element X source 802, any one or more of an aqueous solution containing the additive element X, an alkoxide containing the additive element X, and a solid compound containing the additive element X can be used. An aqueous solution containing the additive element X is preferably prepared as the additive element X source 802 in Step S22.

For the additive element X source 802 used in synthesis, a high-purity material is preferably used. Specifically, the purity of the material is higher than or equal to 2N (99%), preferably higher than or equal to 3N (99.9%), further preferably higher than or equal to 4N (99.99%). The use of a high-purity material can increase the capacity of a secondary battery and/or increase the reliability of the secondary battery.

Next, in Step S31, the transition metal M source 801 and the additive element X source 802 are mixed, whereby the mixture 811 in Step S32 is obtained.

Next, the aqueous solution A 812 and the aqueous solution B 813 are prepared in Step S33 and Step S34, respectively.

As the aqueous solution A 812, any one of ammonia water and an aqueous solution containing at least one of chelating agents such as glycine, oxine, 1-nitroso-2-naphthol, and 2-mercaptobenzothiazole, or a mixed solution of a plurality of them can be used.

As the aqueous solution B 813, any one of an aqueous solution of sodium hydroxide, an aqueous solution of potassium hydroxide, and an aqueous solution of lithium hydroxide, or a mixed solution of a plurality of them can be used.

Next, in Step S35, the mixture 811 in Step S32, the aqueous solution A 812, and the aqueous solution B 813 are mixed.

As a mixing method in Step S35, a mixing method in which the mixture 811 in Step S32 and the aqueous solution B 813 are dripped into the aqueous solution A 812 that is put in a reaction container can be used. While the mixture 811 in Step S32 is dripped at a constant rate, the aqueous solution B 813 is desirably dripped as appropriate so that the pH of the mixed solution in the reaction container is kept in a predetermined range. In the mixing of Step S35, it is desirable that the solution in the reaction container be stirred with a stirring blade or a stirrer, and that dissolved oxygen in the solution in the reaction container, the mixture 811 in Step S32, the aqueous solution A 812, and the aqueous solution B 813 be removed by N₂ bubbling. In the mixing of Step S35, the pH in the reaction container is preferably greater than or equal to 9 and less than or equal to 11, further preferably greater than or equal to 10.0 and less than or equal to 10.5. In the mixing of Step S35, the temperature of the solution in the reaction container is preferably higher than or equal to 40° C. and lower than or equal to 80° C., further preferably higher than or equal to 50° C. and lower than or equal to 70° C.

Alternatively, as the mixing method in Step S35, a mixing method in which the aqueous solution A 812 and the aqueous solution B 813 are dripped into the mixture 811 in Step S32 that is put in a reaction container can be used. It is preferred to adjust the dripping rates of the aqueous solution A 812 and the aqueous solution B 813 in order to keep the concentration of hydroxyl groups and the concentration of dissolved ions of the aqueous solution A 812 in the reaction container in predetermined ranges. In the mixing of Step S35, it is desirable that the solution in the reaction container be stirred with a stirring blade or a stirrer, and that dissolved oxygen in the solution in the reaction container, the mixture 811 in Step S32, the aqueous solution A 812, and the aqueous solution B 813 be removed by N₂ bubbling. In the mixing of Step S35, the temperature of the solution in the reaction container is preferably higher than or equal to 40° C. and lower than or equal to 80° C., further preferably higher than or equal to 50° C. and lower than or equal to 70° C.

The case where the aqueous solution A 812 is not used in the mixing method in Step S35 is described. A certain amount of the aqueous solution B 813 is dripped and added to the mixture 811 in Step S32 that is put in a reaction container. In the mixing of Step S35, it is desirable that the solution in the reaction container be stirred with a stirring blade or a stirrer, and that dissolved oxygen in the solution in the reaction container, the mixture 811 in Step S32, and the aqueous solution B 813 be removed by N₂ bubbling. In the mixing of Step S35, the temperature of the solution in the reaction container is preferably higher than or equal to 40° C. and lower than or equal to 80° C., further preferably higher than or equal to 50° C. and lower than or equal to 70° C.

The case where pure water is used in addition to the mixture 811 in Step S32, the aqueous solution A 812, and the aqueous solution B 813 in the mixing method in Step S35 is described. While the mixture 811 in Step S32 and the aqueous solution A 812 are dripped into pure water that is put in a reaction container at constant rates, the aqueous solution B 813 can be dripped as appropriate so that the pH of the mixed solution in the reaction container is kept in a predetermined range. In the mixing of Step S35, it is desirable that the solution in the reaction container be stirred with a stirring blade or a stirrer, and that dissolved oxygen in the solution in the reaction container, the mixture 811 in Step S32, the aqueous solution A 812, and the aqueous solution B 813 be removed by N₂ bubbling. In the mixing of Step S35, the pH in the reaction container is preferably greater than or equal to 9 and less than or equal to 11, further preferably greater than or equal to 10.0 and less than or equal to 10.5. In the mixing of Step S35, the temperature of the solution in the reaction container is preferably higher than or equal to 40° C. and lower than or equal to 80° C., further preferably higher than or equal to 50° C. and lower than or equal to 70° C.

Next, in Step S36, a solution that is formed by the mixing in Step S35 and contains a hydroxide containing the transition metal M is filtered and then washed with water. It is desirable that the water used for the washing be pure water containing few impurities, with a specific resistance of preferably 1 MΩ·cm or higher, further preferably 10 MΩ·cm or higher, still further preferably 15 MΩ·cm or higher. The use of the pure water containing few impurities for the washing can remove impurities contained in the hydroxide containing the transition metal M. Accordingly, a high-purity hydroxide containing the transition metal M can be obtained as a precursor of the positive electrode active material 100.

Next, the hydroxide containing the transition metal M after the washing in Step S36 is dried and collected, and crushed and sieved as needed, whereby the mixture 821 in Step S41 is obtained. The mixture 821 is also referred to as the precursor of the positive electrode active material 100. The precursor preferably has high crystallinity, and further preferably includes single-crystal grains. In other words, the precursor is preferably a single crystal.

Next, the lithium compound 822 is prepared in Step S42, and the additive element X source 823 is prepared in Step S43. In Step S51, the mixture 821 in Step S41, the lithium compound 822, and the additive element X source 823 are mixed. After the mixing, the mixture is collected in Step S52, and crushed and sieved as needed, whereby the mixture 831 in Step S53 is obtained. The mixing can be performed by a dry process or a wet process. A mixer such as a planetary centrifugal mixer, a ball mill, or a bead mill can be used for the mixing, for example. In the case where a planetary centrifugal mixer Awatorirentaro manufactured by THINKY CORPORATION is used as the planetary centrifugal mixer, for example, 1.5-minute treatment at a rotational frequency of 2000 rpm is preferably repeated three times. When a ball mill is used, zirconia balls are preferably used as media, for example. When a ball mill, a bead mill, or the like is used, the peripheral speed is preferably greater than or equal to 100 mm/s and less than or equal to 2000 mm/s in order to inhibit contamination from the media or the material. For example, the mixing is preferably performed at a peripheral speed of 838 mm/s (the rotational frequency is 400 rpm, and the ball mill diameter is 40 mm).

It is preferred to perform the mixing in Step S51 sufficiently so that the mixture 821 and the lithium compound 822 can be mixed evenly.

As the lithium compound 822, lithium hydroxide, lithium carbonate, lithium nitrate, or lithium fluoride can be used, for example. The lithium compound 822 is referred to as a lithium source in some cases.

For the lithium compound 822 used in synthesis, a high-purity material is preferably used. Specifically, the purity of the material is higher than or equal to 4N (99.99%), preferably higher than or equal to 4N5UP (99.995%), further preferably higher than or equal to 5N (99.999%). The use of a high-purity material can increase the capacity of a secondary battery and/or increase the reliability of the secondary battery.

As the additive element X, one or more selected from nickel, cobalt, magnesium, calcium, chlorine, fluorine, aluminum, manganese, titanium, zirconium, yttrium, vanadium, iron, chromium, niobium, lanthanum, hafnium, zinc, silicon, sulfur, phosphorus, boron, and arsenic can be used. In addition to the above elements, bromine and beryllium may be used as the additive elements X Note that the additive elements X given earlier are more suitable because bromine and beryllium are elements having toxicity to living things.

As the additive element X source 823 in Step S43, any one or more of an aqueous solution containing the additive element X, an alkoxide containing the additive element X, and a solid compound containing the additive element X can be used.

For the additive element X source used in synthesis, a high-purity material is preferably used. Specifically, the purity of the material is higher than or equal to 2N (99%), preferably higher than or equal to 3N (99.9%), further preferably higher than or equal to 4N (99.99%). The use of a high-purity material can increase the capacity of a secondary battery and/or increase the reliability of the secondary battery.

Next, in Step S54, the mixture 831 in Step S53 is heated. The heating temperature is preferably around melting points of the mixture 821, the lithium compound 822, and the like, preferably higher than or equal to 700° C. and lower than 1100° C., further preferably higher than or equal to 800° C. and lower than or equal to 1000° C., still further preferably higher than or equal to 800° C. and lower than or equal to 950° C. In the heating, a container (crucible) containing the mixture 831 is preferably covered with a lid. Unnecessary evaporation of the raw materials can be prevented.

The heating time can be longer than or equal to 1 hour and shorter than or equal to 100 hours, for example, and is preferably longer than or equal to 2 hours and shorter than or equal to hours. The heating is preferably performed in oxygen or an oxygen-containing atmosphere with few moisture (e.g., with a dew point lower than or equal to −50° C., preferably lower than or equal to −80° C.), such as a dry air. In this embodiment, the heating is performed in an atmosphere with a dew point of −93° C. Furthermore, it is suitable to perform the heating in an atmosphere where the concentrations of impurities, CH₄, CO, CO₂, and H₂, are each less than or equal to 5 ppb (parts per billion), in which case impurities can be inhibited from entering the materials.

For example, when the heating is performed at 850° C. for 10 hours, the temperature rise is preferably 200° C./h and the flow rate of a dry atmosphere is preferably 10 L/min. After that, the heated materials can be cooled to room temperature. The temperature decreasing time from the specified temperature to room temperature is preferably longer than or equal to 10 hours and shorter than or equal to 50 hours, for example. Note that the cooling to room temperature in Step S54 is not essential.

Note that a crucible used in the heating in Step S54 is suitably made of a material into which impurities do not enter. In this embodiment, a crucible made of alumina with a purity of 99.9% is used.

It is suitable to collect the materials subjected to the heating in Step S54 after the materials are transferred from the crucible to a mortar because impurities are prevented from entering the materials. The mortar is suitably made of a material into which impurities do not enter. Specifically, it is suitable to use a mortar made of alumina with a purity of 90 wt % or higher, preferably 99 wt % or higher.

Next, the materials baked in the above step are collected in Step S55 and crushed and sieved as needed, whereby the mixture 832 in Step S61 is obtained.

Next, in Step S62, the additive element X source 833 is prepared.

For the additive element X source 833, one or more selected from nickel, cobalt, magnesium, calcium, chlorine, fluorine, aluminum, manganese, titanium, zirconium, yttrium, vanadium, iron, chromium, niobium, lanthanum, hafnium, zinc, silicon, sulfur, phosphorus, boron, and arsenic can be used. In addition to the above elements, bromine and beryllium may be used for the additive element X source. Note that the additive element X source given earlier is more suitable because bromine and beryllium are elements having toxicity to living things.

As the additive element X source 833 in Step S62 in FIG. 11, any one or more of an aqueous solution containing the additive element X, an alkoxide containing the additive element X, and a solid compound containing the additive element X can be used. For example, as shown in S62a or S62b in FIG. 3A and FIG. 3B, one or more solid compounds each containing the additive element X may be prepared, crushing and mixing may be performed, and the mixture (the mixture 843a or the mixture 843b) may be used as the additive element X source 833 in Step S62 in FIG. 11. In the case of using one or more solid compounds each containing the additive element X, mixing may be performed after crushing, crushing may be performed after mixing, or the solid compounds may be used as the additive element X source 833 in Step S62 without being subjected to crushing.

For the additive element X source used in synthesis, a high-purity material is preferably used. Specifically, the purity of the material is higher than or equal to 2N (99%), preferably higher than or equal to 3N (99.9%), further preferably higher than or equal to 4N (99.99%). The use of a high-purity material can increase the capacity of a secondary battery and/or increase the reliability of the secondary battery.

Next, in Step S71, the mixture 832 in Step S61 and the additive element X source 833 in Step S62 are mixed. After the mixing, the mixture is collected in Step S72, and crushed and sieved as needed, whereby the mixture 841 in Step S73 is obtained. The mixing can be performed by a dry process or a wet process. A mixer such as a planetary centrifugal mixer, a ball mill, or a bead mill can be used for the mixing, for example. In the case where a planetary centrifugal mixer Awatorirentaro manufactured by THINKY CORPORATION is used as the planetary centrifugal mixer, for example, 1.5-minute treatment at a rotational frequency of 2000 rpm is preferably repeated three times. When a ball mill is used, zirconia balls are preferably used as media, for example. When a ball mill, a bead mill, or the like is used, the peripheral speed is preferably greater than or equal to 100 mm/s and less than or equal to 2000 mm/s in order to inhibit contamination from the media or the material. For example, the mixing is preferably performed at a peripheral speed of 838 mm/s (the rotational frequency is 400 rpm, and the ball mill diameter is 40 mm).

Next, in Step S74, the mixture 841 in Step S73 is heated. In the heating, a container (crucible) containing the mixture 841 is preferably covered with a lid. Unnecessary evaporation of the raw materials can be prevented. The temperature of the heating in Step S74 is preferably higher than or equal to 500° C. and lower than or equal to 1100° C., further preferably higher than or equal to 500° C. and lower than or equal to 1000° C., still further preferably higher than or equal to 500° C. and lower than or equal to 950° C., yet still further preferably higher than or equal to 500° C. and lower than or equal to 900° C.

As the heating in Step S74, heating by a roller hearth kiln may be performed. When heat treatment is performed by a roller hearth kiln, the mixture 841 may be processed using a heat-resistant container having a lid.

The heating time can be longer than or equal to 1 hour and shorter than or equal to 100 hours, for example, and is preferably longer than or equal to 2 hours and shorter than or equal to hours. The heating is preferably performed in oxygen or an oxygen-containing atmosphere with few moisture (e.g., with a dew point lower than or equal to −50° C., preferably lower than or equal to −80° C.), such as a dry air. In this embodiment, the heating is performed in an atmosphere with a dew point of −93° C. Furthermore, it is suitable to perform the heating in an atmosphere where the concentrations of impurities, CH₄, CO, CO₂, and H₂, are each less than or equal to 5 ppb (parts per billion), in which case impurities can be inhibited from entering the materials.

For example, when the heating is performed at 850° C. for 10 hours, the temperature rise is preferably 200° C./h and the flow rate of a dry atmosphere is preferably 10 L/min. After that, the heated materials can be cooled to room temperature. The temperature decreasing time from the specified temperature to room temperature is preferably longer than or equal to 10 hours and shorter than or equal to 50 hours, for example. Note that the cooling to room temperature in Step S74 is not essential.

Next, the materials baked in the above step are collected and crushed in Step S75, whereby the positive electrode active material 100 in Step S76 is obtained. The materials may be sieved as needed after being crushed. Through the above process, the positive electrode active material 100 of one embodiment of the present invention can be manufactured.

The positive electrode active material 100 preferably has high crystallinity; when the mixture 821 in Step S41 has high crystallinity, the positive electrode active material 100 also has high crystallinity. In the case where the positive electrode active material 100 has high crystallinity and the positive electrode active material 100 includes single-crystal grains, crystal planes where lithium enters and leaves can be aligned. A greater number of the crystal planes where lithium enters and leaves can be exposed to an electrolyte, which improves battery characteristics. Furthermore, the positive electrode active material 100 having high crystallinity and including single-crystal grains is durable; thus, an active material which does not easily deteriorate even when charging and discharging are repeated can be provided.

The positive electrode active material 100 is sometimes referred to as a composite oxide containing lithium, the transition metal M, and oxygen (LiMO₂). Note that the positive electrode active material of one embodiment of the present invention only needs to have a crystal structure of a lithium composite oxide represented by LiMO₂, and the composition is not strictly limited to Li:M:O=1:1:2. For example, in the case where three metals of cobalt, manganese, and nickel are used as the transition metals M and aluminum is used as the additive element X, the positive electrode active material 100 is a composite oxide containing Ni, Co, Mn, and Al (an NCMA). The NCMA may be obtained by adding Al to an NCM in which the ratio of Ni:Co:Mn is any of 1:1:1 and the neighborhood thereof, 9:0.5:0.5 and the neighborhood thereof, 8:1:1 and the neighborhood thereof, 6:2:2 and the neighborhood thereof, and 5:2:3 and the neighborhood thereof. In the case where Ni:Co:Mn is 8:1:1 and the neighborhood thereof, for example, the aluminum concentration is preferably higher than or equal to 0.1 at % and lower than or equal to 2 at %.

When the step of introducing the transition metal M and the steps of introducing the additive elements X are separately performed as shown in FIG. 11, the element concentration profiles in the depth direction can be made different from each other in some cases. For example, the concentration of each of the additive elements X can be made higher in the surface portion than in the inner portion of a particle. Furthermore, with the number of atoms of the transition metal M as a reference, the ratio of the number of atoms of each of the additive elements X with respect to the reference can be higher in the surface portion than in the inner portion. In the NCMA, a region with an aluminum concentration higher than or equal to 0.1 at % and lower than or equal to 2 at % may be in either the surface portion or the inner portion of the particle.

In one embodiment of the present invention, a positive electrode active material is manufactured using a high-purity material for the transition metal M source used in synthesis and using a process which hardly allows entry of impurities in the synthesis. The manufacturing method in which entry of impurities into the transition metal M source and entry of impurities in the synthesis are thoroughly prevented and in which desired additive elements X are controlled to be introduced into the positive electrode active material can provide a positive electrode active material in which a region with a low impurity concentration and a region where the additive elements X are introduced are controlled. The positive electrode active material described in this embodiment is a material having high crystallinity. Furthermore, the positive electrode active material obtained by the manufacturing method of a positive electrode active material, which is one embodiment of the present invention, can increase the capacity of a secondary battery and/or increase the reliability of the secondary battery.

### Embodiment 10

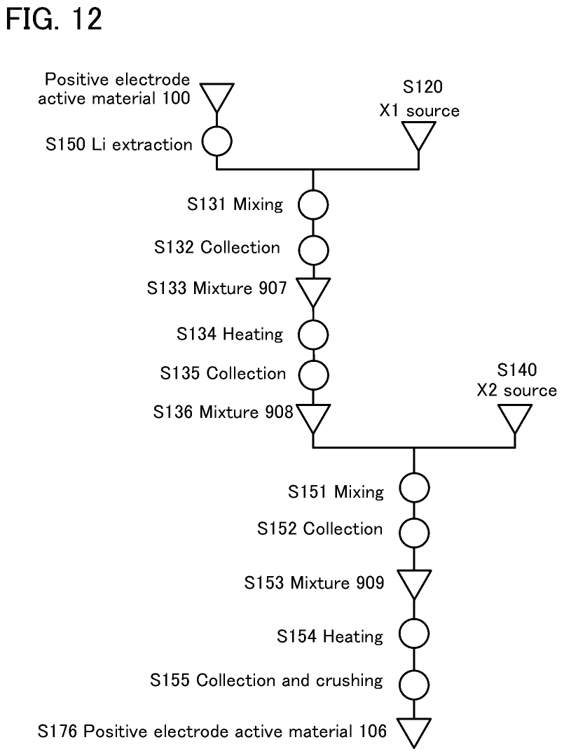

In this embodiment, an example of the manufacturing method of a positive electrode active material of one embodiment of the present invention will be described with reference to FIG. 12.

FIG. 12 is an example of a manufacturing method in which the positive electrode active material 100 obtained through the steps described in any one of Embodiment 1 to Embodiment 9 is subjected to Step S150, which is a lithium extraction step for reducing or removing lithium. There is no particular limitation on the method in Step S150 as long as lithium is extracted and reduced from the positive electrode active material 100; lithium can be extracted by a charge reaction or a chemical reaction using a solution. Step S150 can be also referred to as a step for providing a locally deteriorated portion by reducing the amount of lithium in the obtained positive electrode active material 100 by approximately half Although a structure in which the amount of lithium in the positive electrode active material 100 is reduced by approximately half is described as an example in this embodiment, one embodiment of the present invention is not limited thereto. The amount of lithium to be extracted from the positive electrode active material 100 is greater than or equal to 5% and less than or equal to 95%, preferably greater than or equal to 30% and less than or equal to 70%, further preferably greater than or equal to 40% and less than or equal to 60%.

In Step S120 in FIG. 12, an additive element X1 source is prepared. For the additive element X1 source, one or more selected from nickel, cobalt, magnesium, calcium, chlorine, fluorine, aluminum, manganese, titanium, zirconium, yttrium, vanadium, iron, chromium, niobium, lanthanum, hafnium, zinc, silicon, sulfur, phosphorus, boron, and arsenic can be used. In addition to the above elements, bromine and beryllium may be used for the additive element X1 source. Note that the additive element X1 source given earlier is more suitable because bromine and beryllium are elements having toxicity to living things.

Any one or more of magnesium, fluorine, and calcium can be suitably used as an additive element X1, and a compound of the element(s) and lithium, e.g., lithium fluoride or magnesium fluoride, is preferably used as the additive element X1 source to supply lithium because the amount of lithium is reduced by approximately half in Step S150.

A step of mixing the X1 source and the positive electrode active material from which lithium is extracted is included as Step S131. After the mixing, the mixture is collected in Step S132, and crushed and sieved as needed, whereby a mixture 907 in Step S133 is obtained. The mixing can be performed by a dry process or a wet process. A mixer such as a planetary centrifugal mixer, a ball mill, or a bead mill can be used for the mixing, for example. In the case where a planetary centrifugal mixer Awatorirentaro manufactured by THINKY CORPORATION is used as the planetary centrifugal mixer, for example, 1.5-minute treatment at a rotational frequency of 2000 rpm is preferably repeated three times. When a ball mill is used, zirconia balls are preferably used as media, for example.

Next, in Step S134, the mixture 907 collected in Step S132 is heated. The heating temperature is preferably around melting points of the X1 source and the positive electrode active material from which lithium is extracted, preferably higher than or equal to 700° C. and lower than 1100° C., further preferably higher than or equal to 800° C. and lower than or equal to 1000° C., still further preferably higher than or equal to 800° C. and lower than or equal to 950° C.

The heating time can be longer than or equal to 1 hour and shorter than or equal to 100 hours, for example, and is preferably longer than or equal to 2 hours and shorter than or equal to hours. The heating is preferably performed in oxygen or an oxygen-containing atmosphere with few moisture (e.g., with a dew point lower than or equal to −50° C., preferably lower than or equal to −80° C.), such as a dry air. In this embodiment, the heating is performed in an atmosphere with a dew point of −93° C. Furthermore, it is suitable to perform the heating in an atmosphere where the concentrations of impurities, CH₄, CO, CO₂, and H₂, are each less than or equal to 5 ppb (parts per billion), in which case impurities can be inhibited from entering the materials.

For example, when the heating is performed at 850° C. for 10 hours, the temperature rise is preferably 200° C./h and the flow rate of a dry atmosphere is preferably 10 L/min. After that, the heated materials can be cooled to room temperature. The temperature decreasing time from the specified temperature to room temperature is preferably longer than or equal to 10 hours and shorter than or equal to 50 hours, for example. Note that the cooling to room temperature in Step S134 is not essential.

Note that a crucible used in the heating in Step S134 is suitably made of a material into which impurities do not enter. In this embodiment, a crucible made of alumina with a purity of 99.9% is used.

It is suitable to collect the materials subjected to the heating in Step S134 after the materials are transferred from the crucible to a mortar because impurities are prevented from entering the materials. The mortar is suitably made of a material into which impurities do not enter. Specifically, it is suitable to use a mortar made of alumina with a purity of 90 wt % or higher, preferably 99 wt % or higher.

Next, the materials baked in the above step are collected in Step S135, and crushed and sieved as needed, whereby a mixture 908 in Step S136 is obtained.

Then, in Step S140, an additive element X2 source is prepared. For the additive element X2 source, one or more selected from nickel, cobalt, magnesium, calcium, chlorine, fluorine, aluminum, manganese, titanium, zirconium, yttrium, vanadium, iron, chromium, niobium, lanthanum, hafnium, zinc, silicon, sulfur, phosphorus, boron, and arsenic can be used. In addition to the above elements, bromine and beryllium may be used for the additive element X2 source. Note that the additive element X2 source given earlier is more suitable because bromine and beryllium are elements having toxicity to living things.

As an additive element X2, one or more selected from nickel, titanium, boron, zirconium, and aluminum can be suitably used.

A step of mixing the mixture 908 and the X2 source is included as Step S151. After the mixing, the mixture is collected in Step S152, and crushed and sieved as needed, whereby a mixture 909 in Step S153 is obtained. The mixing can be performed by a dry process or a wet process. A mixer such as a planetary centrifugal mixer, a ball mill, or a bead mill can be used for the mixing, for example. In the case where a planetary centrifugal mixer Awatorirentaro manufactured by THINKY CORPORATION is used as the planetary centrifugal mixer, for example, 1.5-minute treatment at a rotational frequency of 2000 rpm is preferably repeated three times. When a ball mill is used, zirconia balls are preferably used as media, for example.

Next, in Step S154, the mixture 909 is heated. The heating temperature is preferably higher than or equal to 700° C. and lower than 1100° C., further preferably higher than or equal to 800° C. and lower than or equal to 1000° C., still further preferably higher than or equal to 800° C. and lower than or equal to 950° C.

The heating time can be longer than or equal to 1 hour and shorter than or equal to 100 hours, for example, and is preferably longer than or equal to 2 hours and shorter than or equal to hours. The heating is preferably performed in oxygen or an oxygen-containing atmosphere with few moisture (e.g., with a dew point lower than or equal to −50° C., preferably lower than or equal to −80° C.), such as a dry air. In this embodiment, the heating is performed in an atmosphere with a dew point of −93° C. Furthermore, it is suitable to perform the heating in an atmosphere where the concentrations of impurities, CH₄, CO, CO₂, and H₂, are each less than or equal to 5 ppb (parts per billion), in which case impurities can be inhibited from entering the materials.

For example, when the heating is performed at 850° C. for 10 hours, the temperature rise is preferably 200° C./h and the flow rate of a dry atmosphere is preferably 10 L/min. After that, the heated materials can be cooled to room temperature. The temperature decreasing time from the specified temperature to room temperature is preferably longer than or equal to 10 hours and shorter than or equal to 50 hours, for example. Note that the cooling to room temperature in Step S154 is not essential.

Note that a crucible used in the heating in Step S154 is suitably made of a material into which impurities do not enter. In this embodiment, a crucible made of alumina with a purity of 99.9% is used.

It is suitable to collect the materials subjected to the heating in Step S154 after the materials are transferred from the crucible to a mortar because impurities are prevented from entering the materials. The mortar is suitably made of a material into which impurities do not enter. Specifically, it is suitable to use a mortar made of alumina with a purity of 90 wt % or higher, preferably 99 wt % or higher.

Next, the materials baked in the above step are collected and crushed in Step S155, whereby a positive electrode active material 106 in Step S176 is obtained. The materials may be sieved as needed after being crushed.

In Step S176, the positive electrode active material 106 obtained by adding the metal oxide, specifically, aluminum or nickel, repeatedly to the positive electrode active material 100 can be manufactured. Since the steps of adding the additive element X1 source and the additive element X2 source are included after the amount of lithium in the positive electrode active material 100 is reduced by approximately half in Step S150, lithium is extracted from the positive electrode active material 100 and then the additive element X1 or the additive element X2 can be selectively introduced into the locally deteriorated portion. The additive element X1 or the additive element X2 is likely to be introduced into the inside of the particle.

The positive electrode active material obtained by the manufacturing method of a positive electrode active material, which is one embodiment of the present invention, can increase the capacity of a secondary battery and/or increase the reliability of the secondary battery.

### Embodiment 11

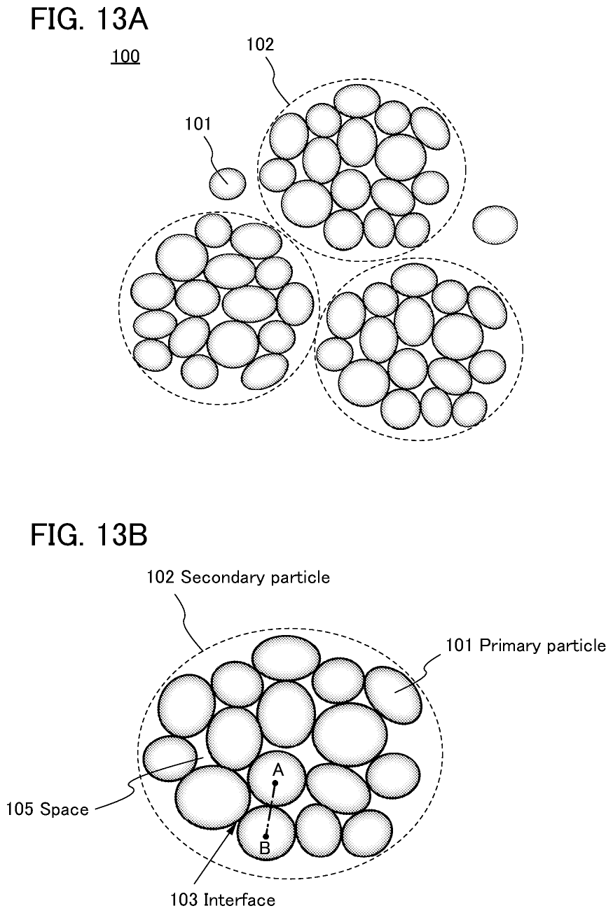

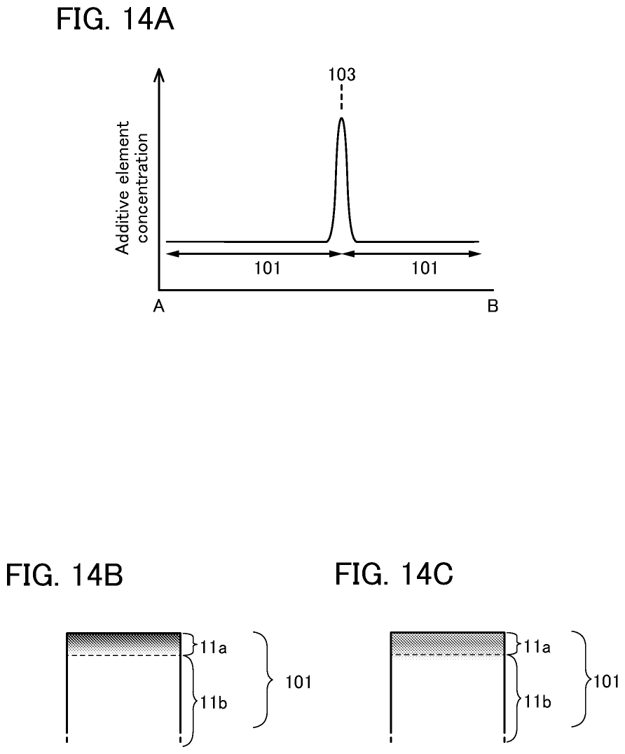

In this embodiment, the positive electrode active material of one embodiment of the present invention will be described with reference to FIG. 13A to FIG. 14C.

FIG. 13A illustrates a cross-sectional view of the positive electrode active material 100. The positive electrode active material 100 includes a plurality of primary particles 101. At least some of the plurality of primary particles 101 adhere to each other to form secondary particles 102. Some of the primary particles 101 do not form the secondary particles. FIG. 13B illustrates an enlarged view of one of the secondary particles 102. The positive electrode active material 100 may include a space 105. Note that the shapes of the primary particles 101 and the secondary particles 102 illustrated in FIG. 13A and FIG. 13B are just examples and are not limited thereto.

In this specification and the like, a primary particle is a smallest unit that is recognizable as a solid having a clear boundary in micrographs such as a SEM image, a TEM image, and a STEM image. A secondary particle is a particle in which a plurality of primary particles are sintered, adhere to each other, or aggregate. In this case, there is no limitation on the bonding force acting between the plurality of primary particles. The bonding force may be any of covalent bonding, ionic bonding, a hydrophobic interaction, the Van der Waals force, and other molecular interactions, or a plurality of bonding forces may work together. In addition, the simple term “particle” includes a primary particle and a secondary particle.

### <Contained Elements>

The positive electrode active material 100 contains lithium, the transition metal M, oxygen, and the additive element X

The positive electrode active material 100 can be regarded as a composite oxide represented by LiMO₂ to which a plurality of additive elements X are added. Note that the positive electrode active material of one embodiment of the present invention only needs to have a crystal structure of a lithium composite oxide represented by LiMO₂, and the composition is not strictly limited to Li:M:O=1:1:2.

As the transition metal M contained in the positive electrode active material 100, a metal that can form, together with lithium, a layered rock-salt composite oxide belonging to the space group R-3m is preferably used. For example, at least one of manganese, cobalt, and nickel can be used. That is, as the transition metal contained in the positive electrode active material 100, only cobalt may be used, only nickel may be used, two metals of cobalt and manganese or two metals of cobalt and nickel may be used, or three metals of cobalt, manganese, and nickel may be used. In other words, the positive electrode active material 100 can contain a composite oxide containing lithium and the transition metal M, such as lithium cobalt oxide, lithium nickel oxide, lithium cobalt oxide in which manganese is substituted for part of cobalt, lithium cobalt oxide in which nickel is substituted for part of cobalt, or lithium nickel-manganese-cobalt oxide.

Specifically, using cobalt at greater than or equal to 75 atomic %, preferably greater than or equal to 90 atomic %, further preferably greater than or equal to 95 atomic % as the transition metal M contained in the positive electrode active material 100 brings many advantages such as relatively easy synthesis, easy handling, and excellent cycle performance.

Using nickel at greater than or equal to 33 atomic %, preferably greater than or equal to 60 atomic %, further preferably greater than or equal to 80 atomic % as the transition metal M contained in the positive electrode active material 100 is preferable because in that case, the cost of the raw materials might be lower than that in the case of using a large amount of cobalt and charge and discharge capacity per weight might be increased.

Moreover, when nickel is partly contained as the transition metal M together with cobalt, a shift in a layered structure formed of octahedrons of cobalt and oxygen is sometimes inhibited. This is preferable because the crystal structure becomes more stable particularly in a charged state at a high temperature in some cases. This is presumably because nickel is easily diffused into the inner portion of lithium cobalt oxide and exists in a cobalt site at the time of discharging but can be positioned in a lithium site owing to cation mixing at the time of charging. Nickel existing in the lithium site at the time of charging functions as a pillar supporting the layered structure formed of octahedrons of cobalt and oxygen and presumably contributes to stabilization of the crystal structure.

Note that manganese is not necessarily contained as the transition metal M. In addition, nickel is not necessarily contained. Furthermore, cobalt is not necessarily contained.

As the additive elements X, at least one of magnesium, fluorine, aluminum, titanium, zirconium, yttrium, vanadium, iron, chromium, niobium, lanthanum, hafnium, zinc, silicon, sulfur, phosphorus, boron, and arsenic is preferably used.

It is particularly preferred that phosphorus be added to the positive electrode active material 100, in which case the continuous charge tolerance can be improved and thus a highly safe secondary battery can be provided.

Manganese, titanium, vanadium, and chromium are materials each of which is likely to be tetravalent stably and thus can increase contribution to structure stability in some cases when used as the transition metal M of the positive electrode active material 100.

These additive elements X further stabilize the crystal structure of the positive electrode active material 100 in some cases as described later. That is, the positive electrode active material 100 can contain lithium cobalt oxide to which magnesium and fluorine are added, lithium nickel-cobalt oxide to which magnesium and fluorine are added, lithium cobalt-aluminum oxide to which magnesium and fluorine are added, lithium nickel-cobalt-aluminum oxide, lithium nickel-cobalt-aluminum oxide to which magnesium and fluorine are added, lithium nickel-manganese-cobalt oxide to which magnesium and fluorine are added, or the like. In the lithium cobalt oxide, the magnesium concentration is preferably higher than or equal to 0.1 at % and lower than or equal to 2 at %. Note that in this specification and the like, the additive elements X may be rephrased as mixtures, constituents of materials, impurities, or the like.

Each of the additive elements Xin the positive electrode active material 100 is preferably added at a concentration that does not largely change the crystallinity of the composite oxide represented by LiMO₂. For example, each of the additive elements is preferably added at an amount that does not cause the Jahn-Teller effect or the like.

Note that as the additive elements X, magnesium, fluorine, aluminum, titanium, zirconium, yttrium, vanadium, iron, chromium, niobium, lanthanum, hafnium, zinc, silicon, sulfur, phosphorus, or boron is not necessarily contained.

### <Element Distribution>

At least one of the additive elements X in the positive electrode active material 100 preferably has a concentration gradient.

For example, it is preferred that the primary particles 101 each include a surface portion 11a and an inner portion 11b, and that the concentration of the additive element X be higher in the surface portion 11a than in the inner portion 11b. In FIG. 13A and FIG. 13B, the concentration of the additive element Xin the primary particles 101 is represented by a gradation. A dark color in the gradation, that is, a color close to black means that the concentration of the additive element X is high; a light color, that is, a color close to white means that the concentration of the additive element X is low.

The concentration of the additive element X at an interface 103 between primary particles and around the interface 103 is preferably higher than that in the inner portions 11b of the primary particles 101. In this specification and the like, “around the interface 103” refers to a region within approximately 10 nm from the interface 103.

FIG. 14A shows an example of the concentration distribution of the additive element X of the positive electrode active material 100 along the dashed-dotted line A-B in FIG. 13B. In FIG. 14A, the horizontal axis represents the length of the dashed-dotted line A-B in FIG. 13B, and the vertical axis represents the concentration of the additive element X.

The interface 103 and the vicinity of the interface 103 include a region where the concentration of the additive element X is higher than that of the primary particles 101. Note that the shape of the concentration distribution of the additive element X is not limited to the shape shown in FIG. 14A.

In the case where a plurality of additive elements X are contained, the peak position of the concentration preferably differs between the additive elements X

Examples of the additive elements X that preferably have a concentration gradient which increases from the inner portion 11b toward the surface as illustrated in FIG. 14B include magnesium, fluorine, and titanium.

As illustrated in FIG. 14C, some of the additive elements X other than the above preferably have a concentration peak in the positive electrode active material 100 in a region close to the inner portion 11b, as compared with the additive elements X that are distributed as illustrated in FIG. 14B. Examples of the additive elements X that are preferably distributed in such a manner include aluminum. The concentration peak may be located in the surface portion or located deeper than the surface portion. For example, the concentration peak is preferably located in a region of 5 nm to 30 nm inclusive in depth from the surface.

It is preferred that some of the additive elements X, e.g., magnesium, have a concentration gradient in which the concentration increases from the inner portion 11b toward the surface as illustrated in FIG. 14B, and be thinly distributed throughout each of the primary particles 101. For example, the magnesium concentration in the surface portion 11a measured by XPS or the like is preferably higher than the average magnesium concentration in the whole particle measured by ICP-MS or the like.

In the case where the positive electrode active material 100 of one embodiment of the present invention contains an element other than cobalt, for example, one or more metals selected from nickel, aluminum, manganese, iron, and chromium, the concentration of the metal in a region in the surface portion of the primary particle 101 is preferably higher than the average concentration in the whole particle. For example, the concentration of the element other than cobalt in the surface portion 11a measured by XPS or the like is preferably higher than the average concentration of the element in the whole particle measured by ICP-MS or the like.

The surface portion of the particle is in a state where bonds are cut unlike the crystal's inner portion, and lithium is extracted from the surface during charging; thus, the lithium concentration in the surface portion tends to be lower than that in the inner portion 11b. Therefore, the surface portion tends to be unstable and its crystal structure is likely to be broken. The higher the concentration of the additive element X in the surface portion 11a is, the more effectively the change in the crystal structure can be inhibited. In addition, a high concentration of the additive element X in the surface portion 11a probably increases corrosion resistance to hydrofluoric acid generated by decomposition of an electrolyte solution.

As described above, the surface portion 11a of the positive electrode active material 100 of one embodiment of the present invention preferably has a higher concentration of the additive element X than the inner portion 11b and has a composition different from that of the inner portion 11b. The composition preferably has a crystal structure stable at room temperature (25° C.). Accordingly, the surface portion 11a may have a crystal structure different from that of the inner portion 11b. For example, at least part of the surface portion 11a of the positive electrode active material 100 of one embodiment of the present invention may have a rock-salt crystal structure. When the surface portion 11a and the inner portion 11b have different crystal structures, the orientations of crystals in the surface portion 11a and the inner portion 11b are preferably substantially aligned with each other.

However, in the surface portion 11a where only the additive elements X and oxygen, e.g., MgO, are contained or MgO and CoO(II) form a solid solution, it is difficult to insert and extract lithium. Thus, the surface portion 11a should contain at least the transition metal M, and also contain lithium in a discharged state and have a path through which lithium is inserted and extracted. Moreover, the concentration of the transition metal M is preferably higher than the concentrations of the additive elements X.

Note that the positive electrode active material 100 of one embodiment of the present invention is not limited thereto. Some of the additive elements X may have no concentration gradient.

Note that the transition metal M, especially cobalt and nickel, is preferably dissolved uniformly in the entire positive electrode active material 100.

Note that a kind of the transition metal M, e.g., manganese, contained in the positive electrode active material 100 may have a concentration gradient in which the concentration increases from the inner portion 11b toward the surface.

When the additive elements X are distributed in the above manner, deterioration of the positive electrode active material 100 due to charging and discharging can be reduced. That is, deterioration of a secondary battery can be inhibited. A highly safe secondary battery can be provided.

In general, the repetition of charging and discharging of a secondary battery causes the following side reactions: dissolution of the transition metal M such as cobalt or manganese from a positive electrode active material included in the secondary battery into an electrolyte solution, release of oxygen, and an unstable crystal structure; hence, deterioration of the positive electrode active material proceeds in some cases. The deterioration of the positive electrode active material sometimes accelerates deterioration such as a decrease in the capacity of the secondary battery. Note that in this specification and the like, a chemical or structural change of the positive electrode active material, such as dissolution of the transition metal M from a positive electrode active material into an electrolyte solution, release of oxygen, and an unstable crystal structure, is referred to as deterioration of the positive electrode active material in some cases. In this specification and the like, a decrease in the capacity of the secondary battery is referred to as deterioration of the secondary battery in some cases.

A metal dissolved from the positive electrode active material is reduced at a negative electrode and precipitated, which might inhibit the electrode reaction of the negative electrode. The precipitation of the metal in the negative electrode promotes deterioration such as a capacity decrease in some cases.

A crystal lattice of the positive electrode active material expands and contracts with insertion and extraction of lithium due to charging and discharging, thereby undergoing strain and a change in volume in some cases. The strain and change in volume of the crystal lattice cause cracking of the positive electrode active material, which might promote deterioration such as a capacity decrease. Cracking of the positive electrode active material may start from the interface 103 between the primary particles.

When the temperature inside the secondary battery turns high and oxygen is released from the positive electrode active material, the safety of the secondary battery might be adversely affected. In addition, the release of oxygen might change the crystal structure of the positive electrode active material and promote deterioration such as a capacity decrease. Note that oxygen is sometimes released from the positive electrode active material by insertion and extraction of lithium due to charging and discharging.

In view of the above, the positive electrode active material 100 that is more chemically and structurally stable than a lithium composite oxide represented by LiMO₂ and includes the additive element X or a compound (e.g., an oxide of the additive element X) in the surface portion 11a or at the interface 103 is provided. Thus, the positive electrode active material 100 can be chemically and structurally stable, and a change in structure, a change in volume, and strain due to charging and discharging can be inhibited. That is, the crystal structure of the positive electrode active material 100 is more stable and hardly changes even after repetition of charging and discharging. In addition, cracking of the positive electrode active material 100 can be inhibited. This is preferable because deterioration such as a capacity decrease can be inhibited. When the charge voltage increases and the amount of lithium in the positive electrode at the time of charging decreases, the crystal structure becomes unstable and is more likely to deteriorate. The use of the positive electrode active material 100 of one embodiment of the present invention is particularly preferable, in which case the crystal structure can be more stable and thus deterioration such as a decrease in capacity can be inhibited.

Since the positive electrode active material 100 of one embodiment of the present invention has a stable crystal structure, dissolution of the transition metal M from the positive electrode active material can be inhibited, which is preferable because deterioration such as a capacity decrease can be inhibited.

When the positive electrode active material 100 of one embodiment of the present invention is cracked along the interface 103 between the primary particles 101, the compound of the additive element X is included in the surfaces of the cracked primary particles 101. That is, a side reaction can be inhibited even in the cracked positive electrode active material 100 and deterioration of the positive electrode active material 100 can be reduced. In other words, deterioration of the secondary battery can be inhibited.

### <Analysis Method>

### <<Particle Diameter>>

When the particle diameter of the positive electrode active material 100 of one embodiment of the present invention is too large, there are problems such as difficulty in lithium diffusion and large surface roughness of an active material layer at the time when the material is applied to a current collector. By contrast, when the particle diameter is too small, there are problems such as difficulty in loading of the active material layer at the time when the material is applied to the current collector and overreaction with an electrolyte solution.

Thus, in the positive electrode active material 100 including the primary particles 101 and the secondary particles 102, the average particle diameter (D50, also referred to as a median diameter) obtained with a particle size distribution analyzer using a laser diffraction and scattering method is preferably greater than or equal to 1 μm and less than or equal to 100 μm, further preferably greater than or equal to 2 μm and less than or equal to 40 μm, still further preferably greater than or equal to 5 μm and less than or equal to 30 μm. Alternatively, the D50 is preferably greater than or equal to 1 μm and less than or equal to 40 μm. Alternatively, the D50 is preferably greater than or equal to 1 μm and less than or equal to 30 μm. Alternatively, the D50 is preferably greater than or equal to 2 μm and less than or equal to 100 μm. Alternatively, the D50 is preferably greater than or equal to 2 μm and less than or equal to 30 μm. Alternatively, the D50 is preferably greater than or equal to 5 μm and less than or equal to 100 μm. Alternatively, the D50 is preferably greater than or equal to 5 μm and less than or equal to 40 μm.

Alternatively, two or more positive electrode active materials 100 having different particle diameters may be mixed and used. In other words, the positive electrode active materials 100 exhibiting a plurality of peaks when subjected to particle size distribution measurement by a laser diffraction and scattering method may be used. In that case, the mixing ratio is preferably set such that the powder packing density is high in order to increase the capacity per volume of a secondary battery.

The size of each of the primary particles 101 in the positive electrode active material 100 can be calculated from the half width of the XRD pattern of the positive electrode active material 100, for example. The size of each of the primary particles 101 is preferably greater than or equal to 50 nm and less than or equal to 200 nm.

### <<XPS>>

A region from the surface to a depth of 2 nm to 8 nm inclusive (normally, approximately nm) can be analyzed by X-ray photoelectron spectroscopy (XPS); thus, the concentration of each element in approximately half of the surface portion 11a can be quantitatively analyzed. The bonding states of the elements can be analyzed by narrow scanning. Note that the quantitative accuracy of XPS is approximately ±1 atomic % in many cases. The lower detection limit is approximately 1 atomic % but depends on the element.

When the positive electrode active material 100 of one embodiment of the present invention is subjected to XPS analysis, the number of atoms of the additive element X is preferably greater than or equal to 1.6 times and less than or equal to 6.0 times, further preferably greater than or equal to 1.8 times and less than 4.0 times the number of atoms of the transition metal M. When the additive element X is magnesium and the transition metal M is cobalt, the number of magnesium atoms is preferably greater than or equal to 1.6 times and less than or equal to 6.0 times, further preferably greater than or equal to 1.8 times and less than 4.0 times the number of cobalt atoms. The number of atoms of halogen such as fluorine is preferably greater than or equal to 0.2 times and less than or equal to 6.0 times, further preferably greater than or equal to 1.2 times and less than or equal to 4.0 times the number of atoms of the transition metal M.

In the XPS analysis, monochromatic aluminum can be used as an X-ray source, for example. The output can be set to 1486.6 eV, for example. An extraction angle is, for example, 45°. With such measurement conditions, a region from the surface to a depth of 2 nm to 8 nm inclusive (normally, approximately 5 nm) can be analyzed, as mentioned above.

In addition, when the positive electrode active material 100 of one embodiment of the present invention is analyzed by XPS, a peak indicating the bonding energy of fluorine with another element is preferably at greater than or equal to 682 eV and less than 685 eV, further preferably approximately 684.3 eV. This bonding energy is different from that of lithium fluoride (685 eV) and that of magnesium fluoride (686 eV). That is, the positive electrode active material 100 of one embodiment of the present invention containing fluorine is preferably in the bonding state other than lithium fluoride and magnesium fluoride.

Furthermore, when the positive electrode active material 100 of one embodiment of the present invention is analyzed by XPS, a peak indicating the bonding energy of magnesium with another element is preferably at greater than or equal to 1302 eV and less than 1304 eV, further preferably approximately 1303 eV. This bonding energy is different from that of magnesium fluoride (1305 eV) and is close to that of magnesium oxide. That is, the positive electrode active material 100 of one embodiment of the present invention containing magnesium is preferably in the bonding state other than magnesium fluoride.

The concentrations of the additive elements X that preferably exist in the surface portion 11a in a large amount, such as magnesium, aluminum, and titanium, measured by XPS or the like are preferably higher than the concentrations measured by ICP-MS (inductively coupled plasma mass spectrometry), GD-MS (glow discharge mass spectrometry), or the like.

When a cross section is exposed by processing and analyzed by TEM-EDX, the concentrations of magnesium, aluminum, and titanium in the surface portion 11a are preferably higher than those in the inner portion 11b. For example, in the TEM-EDX analysis, the magnesium concentration preferably attenuates, at a depth of 1 nm from a point where the concentration reaches a peak, to less than or equal to 60% of the peak concentration. In addition, the magnesium concentration preferably attenuates, at a depth of 2 nm from the point where the concentration reaches the peak, to less than or equal to 30% of the peak concentration. The processing can be performed with an FIB (focused ion beam) system, for example.

In the XPS (X-ray photoelectron spectroscopy) analysis, the number of magnesium atoms is preferably greater than or equal to 0.4 times and less than or equal to 1.5 times the number of cobalt atoms. In the ICP-MS analysis, the atomic ratio of magnesium to cobalt (Mg/Co) is preferably greater than or equal to 0.001 and less than or equal to 0.06.

By contrast, it is preferred that nickel, which is one of the transition metals M, not be unevenly distributed in the surface portion 11a but be distributed in the entire positive electrode active material 100.

### <<EPMA>>

Elements can be quantified by EPMA (electron probe microanalysis). In surface analysis, distribution of each element can be analyzed.

In EPMA, a region from a surface to a depth of approximately 1 μm is analyzed. Thus, the concentration of each element is sometimes different from measurement results obtained by other analysis methods. For example, when surface analysis is performed on the positive electrode active material 100, the concentration of the additive element X existing in the surface portion might be lower than the concentration obtained in XPS. The concentration of the additive element X existing in the surface portion might be higher than the concentration obtained in ICP-MS or a value based on the ratio of the raw materials mixed in the process of forming the positive electrode active material.

EPMA surface analysis of a cross section of the positive electrode active material 100 of one embodiment of the present invention preferably reveals a concentration gradient in which the concentration of the additive element X increases from the inner portion toward the surface. Specifically, each of magnesium, fluorine, and titanium preferably has a concentration gradient in which the concentration increases from the inner portion toward the surface as illustrated in FIG. 14B. The concentration of aluminum preferably has a peak in a region deeper than the region where the concentration of any of the above elements has a peak, as illustrated in FIG. 14C. The aluminum concentration peak may be located in the surface portion or located deeper than the surface portion.

Note that the surface of the positive electrode active material of one embodiment of the present invention do not contain a carbonic acid, a hydroxy group, or the like which is chemisorbed after formation of the positive electrode active material. Furthermore, an electrolyte solution, a binder, a conductive material, and a compound originating from any of these that are attached to the surface of the positive electrode active material are not contained either. Thus, in quantification of the elements contained in the positive electrode active material, correction may be performed to exclude carbon, hydrogen, excess oxygen, excess fluorine, and the like that might be detected in surface analysis such as XPS and EPMA. For example, in XPS, the kinds of bonds can be identified by analysis, and a C—F bond originating from a binder may be excluded by correction.

Furthermore, before any of various kinds of analyses is performed, a sample such as a positive electrode active material and a positive electrode active material layer may be washed, for example, to eliminate an electrolyte solution, a binder, a conductive material, and a compound originating from any of these that are attached to the surface of the positive electrode active material. Although lithium might be eluted to a solvent or the like used in the washing at this time, the transition metal M and the additive element X are not easily eluted even in that case; thus, the atomic proportions of the transition metal M and the additive element X are not affected.

### <<Surface Roughness and Specific Surface Area>>

The primary particles 101 included in the positive electrode active material 100 of one embodiment of the present invention preferably have smooth surfaces with little unevenness. A smooth surface with little unevenness is one indication for favorable distribution of the additive element X in the surface portion 11a.

The smooth surfaces with little unevenness of the primary particles 101 can be determined from, for example, a cross-sectional SEM image or a cross-sectional TEM image of the positive electrode active material 100.

The level of the surface smoothness of the positive electrode active material 100 can be quantified from its cross-sectional SEM image, as described below, for example.

First, the positive electrode active material 100 is processed with an FIB or the like such that its cross section is exposed. At this time, the positive electrode active material 100 is preferably covered with a protective film, a protective agent, or the like. Next, a SEM image of the interface between the positive electrode active material 100 and the protective film or the like is taken. The SEM image is subjected to noise processing using image processing software. For example, the Gaussian Blur (σ=2) is performed, followed by binarization. In addition, interface extraction is performed using image processing software. Moreover, an interface line between the positive electrode active material 100 and the protective film or the like is selected with an automatic selection tool or the like, and data is extracted to spreadsheet software or the like. With the use of the function of the spreadsheet software or the like, correction is performed using regression curves (quadratic regression), parameters for calculating roughness are obtained from data subjected to slope correction, and root-mean-square surface roughness (RMS) is obtained by calculating standard deviation. This surface roughness refers to the surface roughness in at least 400 nm of the particle periphery of the positive electrode active material.

On the surface of each of the primary particles 101 of the positive electrode active material 100 of this embodiment, root-mean-square surface roughness (RMS), which is an index of roughness, is preferably less than 3 nm, further preferably less than 1 nm, still further preferably less than 0.5 nm.

Note that the image processing software used for the noise processing, the interface extraction, or the like is not particularly limited.

The contents described in this embodiment can be implemented in combination with the contents described in the other embodiments.

### Embodiment 12

In this embodiment, a lithium-ion secondary battery including a positive electrode active material of one embodiment of the present invention will be described. The secondary battery at least includes an exterior body, a current collector, an active material (a positive electrode active material or a negative electrode active material), a conductive material, and a binder. An electrolyte solution in which a lithium salt or the like is dissolved is also included. In the secondary battery using an electrolyte solution, a positive electrode, a negative electrode, and a separator between the positive electrode and the negative electrode are provided.

### [Positive Electrode]

The positive electrode includes a positive electrode active material layer and a positive electrode current collector. The positive electrode active material layer preferably includes the positive electrode active material described in Embodiment 1 to Embodiment 11, and may further include a binder, a conductive material, or the like.

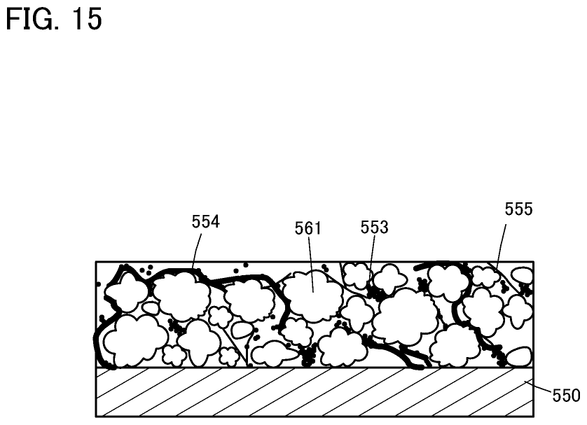

FIG. 15 illustrates an example of a cross-sectional schematic view of the positive electrode.

A current collector 550 is metal foil, and the positive electrode is formed by applying slurry onto the metal foil and drying the slurry. Pressing is performed after drying in some cases. The positive electrode is a component obtained by forming an active material layer over the current collector 550.

Slurry refers to a material solution that is used to form an active material layer over the current collector 550 and includes at least an active material, a binder, and a solvent, preferably also a conductive material mixed therewith. Slurry may also be referred to as slurry for an electrode or active material slurry; in some cases, slurry for forming a positive electrode active material layer is referred to as slurry for a positive electrode, and slurry for forming a negative electrode active material layer is referred to as slurry for a negative electrode.

A conductive material is also referred to as a conductivity-imparting agent or a conductive additive, and a carbon material is used. A conductive material is attached between a plurality of active materials, whereby the plurality of active materials are electrically connected to each other, and the conductivity increases. Note that the term “attach” refers not only to a state where an active material and a conductive material are physically in close contact with each other, and includes, for example, the following concepts: the case where covalent bonding occurs, the case where bonding with the Van der Waals force occurs, the case where a conductive material covers part of the surface of an active material, the case where a conductive material is embedded in surface roughness of an active material, and the case where an active material and a conductive material are electrically connected to each other without being in contact with each other.

Typical examples of the carbon material used as the conductive material include carbon black (e.g., furnace black, acetylene black, and graphite).

In FIG. 15, acetylene black 553, graphene and a graphene compound 554, and a carbon nanotube 555 are illustrated as the conductive material. Note that the positive electrode active material 100 described in Embodiment 1 to Embodiment 10 corresponds to an active material 561 in FIG. 15.

In the positive electrode of the secondary battery, a binder (a resin) is mixed in order to fix the current collector 550 such as metal foil and the active material. The binder is also referred to as a binding agent. Since the binder is a high molecular material, a large amount of the binder lowers the proportion of the active material in the positive electrode, thereby reducing the discharge capacity of the secondary battery. Therefore, the amount of the binder mixed is reduced to a minimum.

Graphene, which has electrically, mechanically, or chemically remarkable characteristics, is a carbon material that is expected to be used in a variety of fields, such as field-effect transistors and solar batteries.

A graphene compound in this specification and the like includes multilayer graphene, multi graphene, graphene oxide, multilayer graphene oxide, multi graphene oxide, reduced graphene oxide, reduced multilayer graphene oxide, reduced multi graphene oxide, or the like. A graphene compound contains carbon, has a plate-like shape, a sheet-like shape, or the like, and has a two-dimensional structure formed of a six-membered ring composed of carbon atoms. A graphene compound preferably has a curved shape. A graphene compound may also be referred to as a carbon sheet. A graphene compound preferably includes a functional group. A graphene compound may be rounded like a carbon nanofiber.

The graphene and graphene compound may have excellent electrical characteristics of high conductivity and excellent physical properties of high flexibility and high mechanical strength. The graphene and graphene compound have a sheet-like shape. The graphene and graphene compound have a curved surface in some cases, thereby enabling low-resistant surface contact. Furthermore, the graphene and graphene compound have extremely high conductivity even with a small thickness in some cases and thus allow a conductive path to be formed in an active material layer efficiently even with a small amount. Hence, the use of the graphene and graphene compound as the conductive material can increase the area where the active material and the conductive material are in contact with each other. Note that the graphene and graphene compound preferably overlay at least part of the secondary particles 102 in the positive electrode active material 100. Alternatively, the shape of the graphene and graphene compound preferably conforms to at least part of the shape of the secondary particles 102. The shape of the secondary particles 102 means, for example, an uneven surface of a single secondary particle 102 or an uneven surface formed by a plurality of the secondary particles 102. The graphene compound preferably surrounds at least part of the secondary particles 102. The graphene compound may have a hole.

Note that in FIG. 15, a region that is not filled with the active material 561, the graphene and graphene compound 554, the acetylene black 553, or the carbon nanotube 555 represents a space or the binder. A space is required for the electrolyte solution to penetrate the positive electrode; too many spaces lower the electrode density, too few spaces do not allow the electrolyte solution to penetrate the positive electrode, and a space that remains after the secondary battery is completed lowers the energy density.

Note that all of the acetylene black 553, the graphene and graphene compound 554, and the carbon nanotube 555 are not necessarily included as the conductive material. At least one kind of conductive material is needed.

The positive electrode active material 100 described in Embodiment 1 to Embodiment 11 is used in the positive electrode, whereby a secondary battery having a high energy density and favorable output characteristics can be obtained.

A secondary battery can be fabricated by using the positive electrode in FIG. 15; setting, in a container (e.g., an exterior body or a metal can) or the like, a stack in which a separator is provided over the positive electrode and a negative electrode is provided over the separator; and filling the container with an electrolyte solution.

Although the above structure is an example of a secondary battery using an electrolyte solution, one embodiment of the present invention is not particularly limited thereto.

For example, a semi-solid-state battery or an all-solid-state battery can be fabricated using the positive electrode active material 100 described in Embodiment 1 to Embodiment 11.

In this specification and the like, a semi-solid-state battery refers to a battery in which at least one of an electrolyte layer, a positive electrode, and a negative electrode includes a semi-solid-state material. The term “semi-solid-state” here does not mean that the proportion of a solid-state material is 50%. The term “semi-solid-state” means having properties of a solid, such as a small volume change, and also having some of properties close to those of a liquid, such as flexibility. A single material or a plurality of materials can be used as long as the above properties are satisfied. For example, a porous solid-state material infiltrated with a liquid material may be used.

In this specification and the like, a polymer electrolyte secondary battery refers to a secondary battery in which an electrolyte layer between a positive electrode and a negative electrode contains a polymer. Polymer electrolyte secondary batteries include a dry (or intrinsic) polymer electrolyte battery and a polymer gel electrolyte battery. A polymer electrolyte secondary battery may be referred to as a semi-solid-state battery.

A semi-solid-state battery fabricated using the positive electrode active material 100 described in Embodiment 1 to Embodiment 11 is a secondary battery having high charge and discharge capacity. The semi-solid-state battery can have high charge and discharge voltages. Alternatively, a highly safe or reliable semi-solid-state battery can be provided.

The positive electrode active material described in any one of Embodiment 1 to Embodiment 11 and another positive electrode active material may be mixed to be used.

Other examples of the positive electrode active material include a composite oxide with an olivine crystal structure, a composite oxide with a layered rock-salt crystal structure, and a composite oxide with a spinel crystal structure. For example, a compound such as LiFePO₄, LiFeO₂, LiNiO₂, LiMn₂O₄, V₂O₅, Cr₂O₅, or MnO₂ can be used.

As another positive electrode active material, it is preferable to mix lithium nickel oxide (LiNiO₂ or LiNi₁₋ₓMₓO₂ (0<x<1) (M=Co, Al, or the like)) with a lithium-containing material that has a spinel crystal structure and contains manganese, such as LiMn₂O₄. This composition can improve the performance of the secondary battery.

Another example of the positive electrode active material is a lithium-manganese composite oxide that can be represented by a composition formula LiₐMn_{b}M_{c}O_{d}. Here, the element M is preferably silicon, phosphorus, or a metal element other than lithium and manganese, further preferably nickel. In the case where the whole particles of a lithium-manganese composite oxide are measured, it is preferable to satisfy the following at the time of discharging: 0<a/(b+c)<2; c>0; and 0.26≤(b+c)/d<0.5. Note that the proportions of metals, silicon, phosphorus, and other elements in the whole particles of a lithium-manganese composite oxide can be measured with, for example, an ICP-MS (inductively coupled plasma mass spectrometer). The proportion of oxygen in the whole particles of a lithium-manganese composite oxide can be measured by, for example, EDX (energy dispersive X-ray spectroscopy). Alternatively, the proportion of oxygen can be measured by ICP-MS analysis combined with fusion gas analysis and valence evaluation of XAFS (X-ray absorption fine structure) analysis. Note that the lithium-manganese composite oxide is an oxide containing at least lithium and manganese, and may contain at least one element selected from a group consisting of chromium, cobalt, aluminum, nickel, iron, magnesium, molybdenum, zinc, indium, gallium, copper, titanium, niobium, silicon, phosphorus, and the like.

### <Binder>

As the binder, a rubber material such as styrene-butadiene rubber (SBR), styrene-isoprene-styrene rubber, acrylonitrile-butadiene rubber, butadiene rubber, or an ethylene-propylene-diene copolymer is preferably used, for example. Alternatively, fluororubber can be used as the binder.

As the binder, for example, water-soluble polymers are preferably used. As the water-soluble polymers, a polysaccharide can be used, for example. As the polysaccharide, starch, a cellulose derivative such as carboxymethyl cellulose (CMC), methyl cellulose, ethyl cellulose, hydroxypropyl cellulose, diacetyl cellulose, or regenerated cellulose, and the like can be used. It is further preferable that such water-soluble polymers be used in combination with any of the above rubber materials.

Alternatively, as the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

Two or more of the above-described materials may be used in combination for the binder.

For example, a material having a significant viscosity modifying effect and another material may be used in combination. For example, a rubber material or the like has high adhesion and high elasticity but may have difficulty in viscosity modification when mixed in a solvent. In such a case, a rubber material or the like is preferably mixed with a material having a significant viscosity modifying effect, for example. As a material having a significant viscosity modifying effect, for instance, a water-soluble polymer is preferably used. As a water-soluble polymer having a significant viscosity modifying effect, the above-mentioned polysaccharide, for instance, a cellulose derivative such as carboxymethyl cellulose (CMC), methyl cellulose, ethyl cellulose, hydroxypropyl cellulose, diacetyl cellulose, or regenerated cellulose or starch can be used.

Note that a cellulose derivative such as carboxymethyl cellulose obtains a higher solubility when converted into a salt such as a sodium salt or an ammonium salt of carboxymethyl cellulose, and thus easily exerts an effect as a viscosity modifier. A high solubility can also increase the dispersibility of an active material and other components in the formation of slurry for an electrode. In this specification, cellulose and a cellulose derivative used as a binder of an electrode include salts thereof.

A water-soluble polymer stabilizes the viscosity by being dissolved in water and allows stable dispersion of the active material or another material combined as a binder, such as styrene-butadiene rubber, in an aqueous solution. Furthermore, a water-soluble polymer is expected to be easily and stably adsorbed onto an active material surface because it has a functional group. Many cellulose derivatives, such as carboxymethyl cellulose, have a functional group such as a hydroxyl group or a carboxyl group. Because of functional groups, polymers are expected to interact with each other and cover an active material surface in a large area.

In the case where the binder that covers or is in contact with the active material surface forms a film, the film is expected to serve also as a passivation film to suppress the decomposition of the electrolyte solution. Here, a passivation film refers to a film without electric conductivity or a film with extremely low electric conductivity, and can inhibit the decomposition of an electrolyte solution at a potential at which a battery reaction occurs when the passivation film is formed on the active material surface, for example. It is preferred that the passivation film can conduct lithium ions while suppressing electric conduction.

### <Positive Electrode Current Collector>

The current collector can be formed using a material that has high conductivity, such as a metal like stainless steel, gold, platinum, aluminum, or titanium, or an alloy thereof. It is preferred that a material used for the positive electrode current collector not be dissolved at the potential of the positive electrode. It is also possible to use an aluminum alloy to which an element that improves heat resistance, such as silicon, titanium, neodymium, scandium, or molybdenum, is added. A metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel. The current collector can have a foil-like shape, a plate-like shape, a sheet-like shape, a net-like shape, a punching-metal shape, an expanded-metal shape, or the like as appropriate. The current collector preferably has a thickness greater than or equal to 5 μm and less than or equal to 30 μm.

### [Negative Electrode]

The negative electrode includes a negative electrode active material layer and a negative electrode current collector. The negative electrode active material layer contains a negative electrode active material, and may further contain a conductive material and a binder.

### <Negative Electrode Active Material>

As a negative electrode active material, for example, an alloy-based material or a carbon-based material, a mixture thereof, and the like can be used.

For the negative electrode active material, an element that enables charge and discharge reactions by an alloying reaction and a dealloying reaction with lithium can be used. For example, a material containing at least one of silicon, tin, gallium, aluminum, germanium, lead, antimony, bismuth, silver, zinc, cadmium, indium, and the like can be used. Such elements have higher capacity than carbon. In particular, silicon has a high theoretical capacity of 4200 mAh/g. For this reason, silicon is preferably used as the negative electrode active material. Alternatively, a compound containing any of the above elements may be used. Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge and discharge reactions by an alloying reaction and a dealloying reaction with lithium, a compound containing the element, and the like may be referred to as an alloy-based material.

In this specification and the like, SiO refers, for example, to silicon monoxide. Note that SiO can alternatively be expressed as SiOₓ. Here, it is preferred that x be 1 or have an approximate value of 1. For example, x is preferably greater than or equal to 0.2 and less than or equal to 1.5, or preferably greater than or equal to 0.3 and less than or equal to 1.2.

As the carbon-based material, graphite, graphitizing carbon (soft carbon), non-graphitizing carbon (hard carbon), a carbon nanotube, graphene, carbon black, or the like can be used.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used. For example, MCMB is preferably used because it may have a spherical shape. Moreover, MCMB may preferably be used because it can relatively easily have a small surface area. Examples of natural graphite include flake graphite and spherical natural graphite.

Graphite has a low potential substantially equal to that of a lithium metal (greater than or equal to 0.05 V and less than or equal to 0.3 V vs. Li/Li⁺) when lithium ions are inserted into graphite (while a lithium-graphite intercalation compound is formed). For this reason, a lithium-ion secondary battery using graphite can have a high operating voltage. In addition, graphite is preferred because of its advantages such as a relatively high capacity per unit volume, relatively small volume expansion, low cost, and a higher level of safety than that of a lithium metal.

As the negative electrode active material, an oxide such as titanium dioxide (TiO₂), lithium titanium oxide (Li₄Ti₅O₁₂), a lithium-graphite intercalation compound (LiₓC₆), niobium pentoxide (Nb₂O₅), tungsten oxide (WO₂), or molybdenum oxide (MoO₂) can be used.

Alternatively, as the negative electrode active material, Li₃₋ₓMₓN (M=Co, Ni, or Cu) with a Li₃N structure, which is a composite nitride of lithium and a transition metal, can be used. For example, Li_{2.6}Co_{0.4}N₃ is preferable because of high charge and discharge capacity (900 mAh/g and 1890 mAh/cm³).

A composite nitride of lithium and a transition metal is preferably used, in which case lithium ions are contained in the negative electrode active material and thus the negative electrode active material can be used in combination with a material for a positive electrode active material that does not contain lithium ions, such as V₂O₅ or Cr₃O₈. Note that in the case of using a material containing lithium ions as a positive electrode active material, the composite nitride of lithium and a transition metal can be used as the negative electrode active material by extracting the lithium ions contained in the positive electrode active material in advance.

Alternatively, a material that causes a conversion reaction can be used for the negative electrode active material; for example, a transition metal oxide that does not form an alloy with lithium, such as cobalt oxide (CoO), nickel oxide (NiO), or iron oxide (FeO), may be used as the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

For the conductive material and the binder that can be included in the negative electrode active material layer, materials similar to those for the conductive material and the binder that can be included in the positive electrode active material layer can be used.

### <Negative Electrode Current Collector>

For the negative electrode current collector, copper or the like can be used in addition to a material similar to that for the positive electrode current collector. Note that a material that is not alloyed with carrier ions of lithium or the like is preferably used for the negative electrode current collector.

### [Separator]

A separator is placed between the positive electrode and the negative electrode. As the separator, for example, a fiber containing cellulose such as paper; nonwoven fabric; a glass fiber; ceramics; a synthetic fiber using nylon (polyamide), vinylon (polyvinyl alcohol-based fiber), polyester, acrylic, polyolefin, or polyurethane; or the like can be used. The separator is preferably formed to have an envelope-like shape to wrap one of the positive electrode and the negative electrode.

The separator may have a multilayer structure. For example, an organic material film of polypropylene, polyethylene, or the like can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the separator is coated with the ceramic-based material, the oxidation resistance is improved; hence, deterioration of the separator in charging and discharging at a high voltage can be suppressed and thus the reliability of the secondary battery can be improved. When the separator is coated with the fluorine-based material, the separator is easily brought into close contact with an electrode, resulting in high output characteristics. When the separator is coated with the polyamide-based material, in particular, aramid, the safety of the secondary battery can be improved because heat resistance is improved.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

With the use of a separator having a multilayer structure, the capacity per volume of the secondary battery can be increased because the safety of the secondary battery can be maintained even when the total thickness of the separator is small.

### [Electrolyte Solution]

The electrolyte solution contains a solvent and an electrolyte. As the solvent of the electrolyte solution, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination at an appropriate ratio.

Alternatively, the use of one or more ionic liquids (room temperature molten salts) that are unlikely to burn and volatilize as the solvent of the electrolyte solution can prevent a power storage device from exploding or catching fire even when the power storage device internally shorts out or the internal temperature increases owing to overcharge or the like. An ionic liquid contains a cation and an anion, specifically, an organic cation and an anion. Examples of the organic cation used for the electrolyte solution include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As the electrolyte dissolved in the above-described solvent, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂)(CF₃SO₂), LiN(C₂F₅SO₂)₂, and lithium bis(oxalate)borate (Li(C₂O₄)₂, LiBOB) can be used, or two or more of these lithium salts can be used in an appropriate combination at an appropriate ratio.

The electrolyte solution used for a power storage device is preferably highly purified and contains a small number of dust particles or elements other than the constituent elements of the electrolyte solution (hereinafter, also simply referred to as impurities). Specifically, the weight ratio of impurities to the electrolyte solution is preferably less than or equal to 1%, further preferably less than or equal to 0.1%, still further preferably less than or equal to 0.01%.

Furthermore, an additive agent such as vinylene carbonate, propane sultone (PS), tert-butylbenzene (TBB), fluoroethylene carbonate (FEC), lithium bis(oxalate)borate (LiBOB), or a dinitrile compound such as succinonitrile or adiponitrile may be added to the electrolyte solution. The concentration of the additive agent in the whole solvent is, for example, higher than or equal to 0.1 wt % and lower than or equal to 5 wt %.

Alternatively, a polymer gel electrolyte obtained in such a manner that a polymer is swelled with an electrolyte solution may be used.

When a polymer gel electrolyte is used, safety against liquid leakage and the like is improved. Moreover, a secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used. Examples of the polymer include a polymer having a polyalkylene oxide structure, such as polyethylene oxide (PEO); PVDF; polyacrylonitrile; and a copolymer containing any of them. For example, PVDF-HFP, which is a copolymer of PVDF and hexafluoropropylene (HFP), can be used. The formed polymer may be porous.

Instead of the electrolyte solution, a solid electrolyte including an inorganic material such as a sulfide-based or oxide-based inorganic material, a solid electrolyte including a polymer material such as a PEO (polyethylene oxide)-based polymer material, or the like may alternatively be used. When the solid electrolyte is used, a separator or a spacer is not necessary. Furthermore, the battery can be entirely solidified; therefore, there is no possibility of liquid leakage and thus the safety of the battery is dramatically improved.

Accordingly, the positive electrode active material 100 obtained in Embodiment 1 to Embodiment 11 can also be used for all-solid-state batteries. By using the positive electrode slurry or the electrode in an all-solid-state battery, an all-solid-state battery with a high level of safety and favorable characteristics can be obtained.

### [Exterior Body]

For an exterior body included in the secondary battery, a metal material such as aluminum or a resin material can be used, for example. A film-like exterior body can also be used. As the film, for example, it is possible to use a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body.

The contents described in this embodiment can be combined with the contents described in the other embodiments.

### Embodiment 13

This embodiment describes examples of shapes of several types of secondary batteries including a positive electrode or a negative electrode formed by the formation method described in the foregoing embodiment.

### [Coin-Type Secondary Battery]

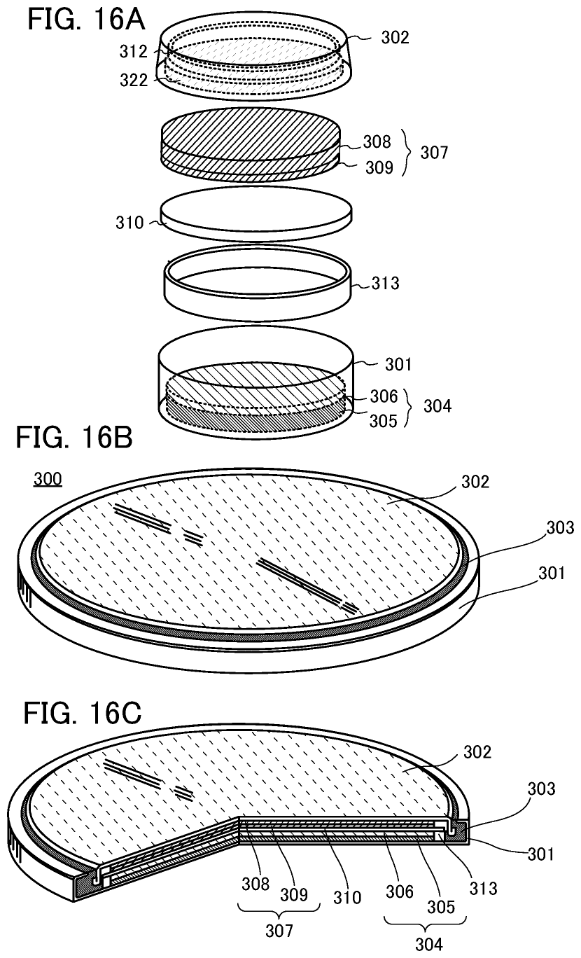

An example of a coin-type secondary battery is described. FIG. 16A is an exploded perspective view of a coin-type (single-layer flat type) secondary battery, FIG. 16B is an external view thereof, and FIG. 16C is a cross-sectional view thereof. Coin-type secondary batteries are mainly used in small electronic devices. In this specification and the like, coin-type batteries include button-type batteries.

For easy understanding, FIG. 16A is a schematic view showing overlap (a vertical relation and a positional relation) between components. Thus, FIG. 16A and FIG. 16B do not completely correspond with each other.

In FIG. 16A, a positive electrode 304, a separator 310, a negative electrode 307, a spacer 322, and a washer 312 are overlaid. They are sealed with a negative electrode can 302 and a positive electrode can 301. Note that a gasket for sealing is not illustrated in FIG. 16A. The spacer 322 and the washer 312 are used to protect the inside or fix the position inside the cans at the time when the positive electrode can 301 and the negative electrode can 302 are bonded with pressure. For the spacer 322 and the washer 312, stainless steel or an insulating material is used.

The positive electrode 304 has a stacked-layer structure in which a positive electrode active material layer 306 is formed over a positive electrode current collector 305.

To prevent a short circuit between the positive electrode and the negative electrode, the separator 310 and a ring-shaped insulator 313 are placed to cover the side surface and top surface of the positive electrode 304. The separator 310 has a larger flat surface area than the positive electrode 304.

FIG. 16B is a perspective view of a completed coin-type secondary battery.

In a coin-type secondary battery 300, the positive electrode can 301 doubling as a positive electrode terminal and the negative electrode can 302 doubling as a negative electrode terminal are insulated from each other and sealed by a gasket 303 made of polypropylene or the like. The positive electrode 304 includes the positive electrode current collector 305 and the positive electrode active material layer 306 provided in contact with the positive electrode current collector 305. The negative electrode 307 includes a negative electrode current collector 308 and a negative electrode active material layer 309 provided in contact with the negative electrode current collector 308. The negative electrode 307 is not limited to having a stacked-layer structure, and lithium metal foil or lithium-aluminum alloy foil may be used.

Note that only one surface of each of the positive electrode 304 and the negative electrode 307 used for the coin-type secondary battery 300 is provided with an active material layer.

For the positive electrode can 301 and the negative electrode can 302, a metal having corrosion resistance to an electrolyte solution, such as nickel, aluminum, or titanium, an alloy of such a metal, or an alloy of such a metal and another metal (e.g., stainless steel) can be used. The positive electrode can 301 and the negative electrode can 302 are preferably covered with nickel, aluminum, and the like in order to prevent corrosion due to the electrolyte solution, for example. The positive electrode can 301 and the negative electrode can 302 are electrically connected to the positive electrode 304 and the negative electrode 307, respectively.

The coin-type secondary battery 300 is manufactured in the following manner: the negative electrode 307, the positive electrode 304, and the separator 310 are immersed in the electrolyte solution; as illustrated in FIG. 16C, the positive electrode 304, the separator 310, the negative electrode 307, and the negative electrode can 302 are stacked in this order with the positive electrode can 301 positioned at the bottom; and then the positive electrode can 301 and the negative electrode can 302 are subjected to pressure bonding with the gasket 303 therebetween.

The secondary battery can be the coin-type secondary battery 300 having high capacity, high charge and discharge capacity, and excellent cycle performance. Note that in the case of a secondary battery, the separator 310 is not necessarily provided between the negative electrode 307 and the positive electrode 304.

### [Cylindrical Secondary Battery]

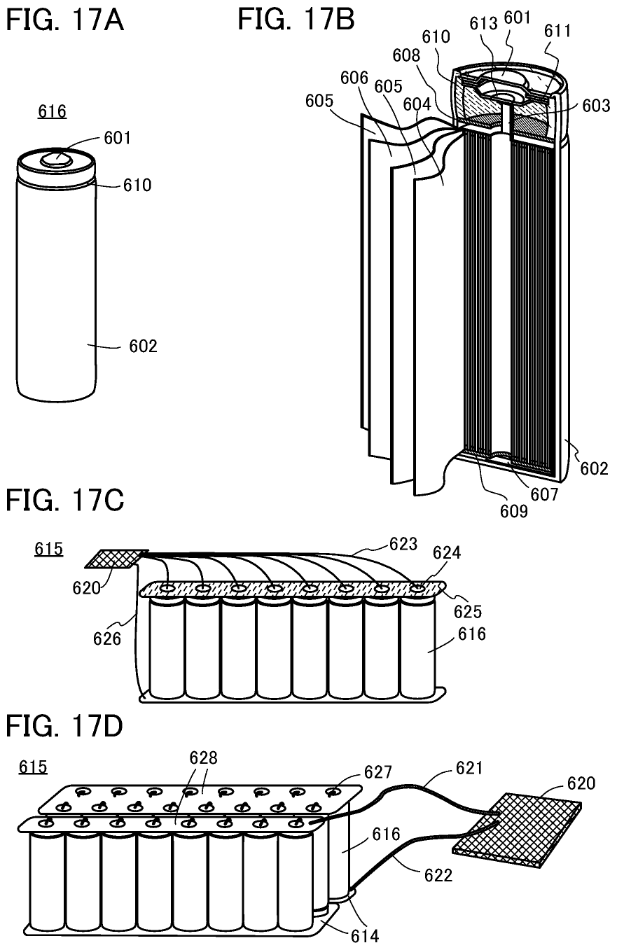

An example of a cylindrical secondary battery is described with reference to FIG. 17A. As illustrated in FIG. 17A, a cylindrical secondary battery 616 includes a positive electrode cap (battery cap) 601 on the top surface and a battery can (outer can) 602 on the side surface and bottom surface. The positive electrode cap 601 and the battery can (outer can) 602 are insulated from each other by a gasket (insulating gasket) 610.

FIG. 17B schematically illustrates a cross section of a cylindrical secondary battery. The cylindrical secondary battery illustrated in FIG. 17B includes the positive electrode cap (battery cap) 601 on the top surface and the battery can (outer can) 602 on the side surface and bottom surface. The positive electrode cap and the battery can (outer can) 602 are insulated from each other by the gasket (insulating gasket) 610.

Inside the battery can 602 having a hollow cylindrical shape, a battery element in which a belt-like positive electrode 604 and a belt-like negative electrode 606 are wound with a belt-like separator 605 located therebetween is provided. Although not illustrated, the battery element is wound around a central axis. One end of the battery can 602 is close and the other end thereof is open. For the battery can 602, a metal having corrosion resistance to an electrolyte solution, such as nickel, aluminum, or titanium, an alloy of such a metal, and an alloy of such a metal and another metal (e.g., stainless steel) can be used. The battery can 602 is preferably covered with nickel, aluminum, and the like in order to prevent corrosion due to the electrolyte solution. Inside the battery can 602, the battery element in which the positive electrode, the negative electrode, and the separator are wound is provided between a pair of insulating plates 608 and 609 that face each other. A nonaqueous electrolyte solution (not illustrated) is injected inside the battery can 602 provided with the battery element. A nonaqueous electrolyte solution similar to that for the coin-type secondary battery can be used.

Since a positive electrode and a negative electrode that are used for a cylindrical storage battery are wound, active materials are preferably formed on both surfaces of a current collector. Note that although FIG. 17A to FIG. 17D each illustrate the secondary battery 616 in which the height of the cylinder is larger than the diameter of the cylinder, one embodiment of the present invention is not limited thereto. In a secondary battery, the diameter of the cylinder may be larger than the height of the cylinder. Such a structure can reduce the size of a secondary battery, for example.

The positive electrode active material 100 obtained in Embodiment 1 to Embodiment 11 is used for the positive electrode 604, whereby the cylindrical secondary battery 616 can have high capacity, high charge and discharge capacity, and excellent cycle performance.

A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a PTC element (Positive Temperature Coefficient) 611. The safety valve mechanism 613 cuts off electrical connection between the positive electrode cap 601 and the positive electrode 604 when the internal pressure of the battery exceeds a predetermined threshold. The PTC element 611, which is a thermally sensitive resistor whose resistance increases as temperature rises, limits the amount of current by increasing the resistance, in order to prevent abnormal heat generation. Barium titanate (BaTiO₃)-based semiconductor ceramic or the like can be used for the PTC element.

FIG. 17C illustrates an example of a power storage system 615. The power storage system 615 includes a plurality of the secondary batteries 616. The positive electrodes of the secondary batteries are in contact with and electrically connected to conductors 624 isolated by an insulator 625. The conductor 624 is electrically connected to a control circuit 620 through a wiring 623. The negative electrodes of the secondary batteries are electrically connected to the control circuit 620 through a wiring 626. As the control circuit 620, a protection circuit for preventing overcharge or overdischarge can be used, for example.

FIG. 17D illustrates an example of the power storage system 615. The power storage system 615 includes the plurality of secondary batteries 616, and the plurality of secondary batteries 616 are sandwiched between a conductive plate 628 and a conductive plate 614. The plurality of secondary batteries 616 are electrically connected to the conductive plate 628 and the conductive plate 614 through a wiring 627. The plurality of secondary batteries 616 may be connected in parallel, connected in series, or connected in series after being connected in parallel. With the power storage system 615 including the plurality of secondary batteries 616, large electric power can be extracted.

The plurality of secondary batteries 616 may be connected in series after being connected in parallel.

A temperature control device may be provided between the plurality of secondary batteries 616. The secondary batteries 616 can be cooled with the temperature control device when overheated, whereas the secondary batteries 616 can be heated with the temperature control device when cooled too much. Thus, the performance of the power storage system 615 is less likely to be influenced by the outside temperature.

In FIG. 17D, the power storage system 615 is electrically connected to the control circuit 620 through a wiring 621 and a wiring 622. The wiring 621 is electrically connected to the positive electrodes of the plurality of secondary batteries 616 through the conductive plate 628, and the wiring 622 is electrically connected to the negative electrodes of the plurality of secondary batteries 616 through the conductive plate 614.

### Other Structure Examples of Secondary Battery

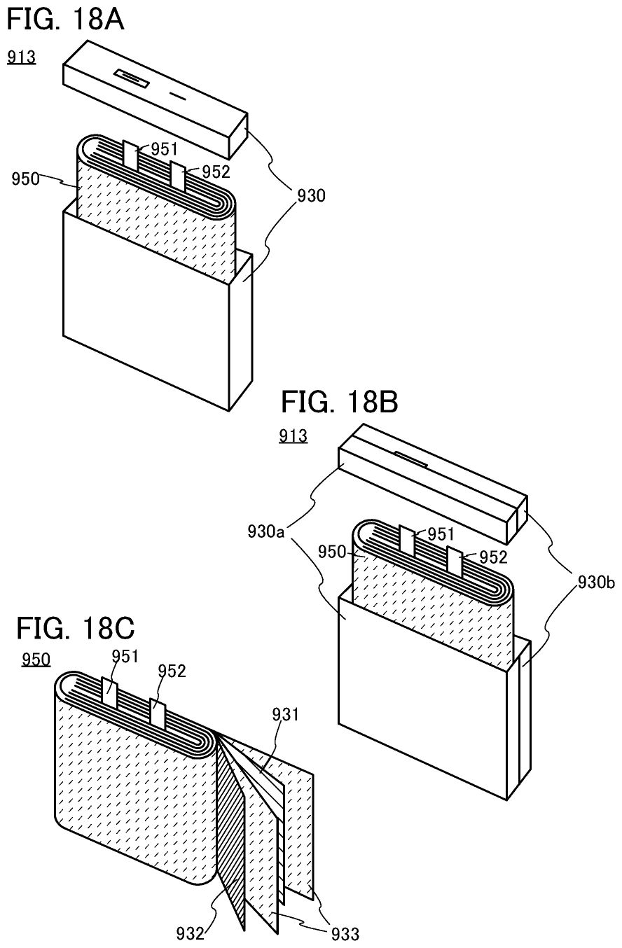

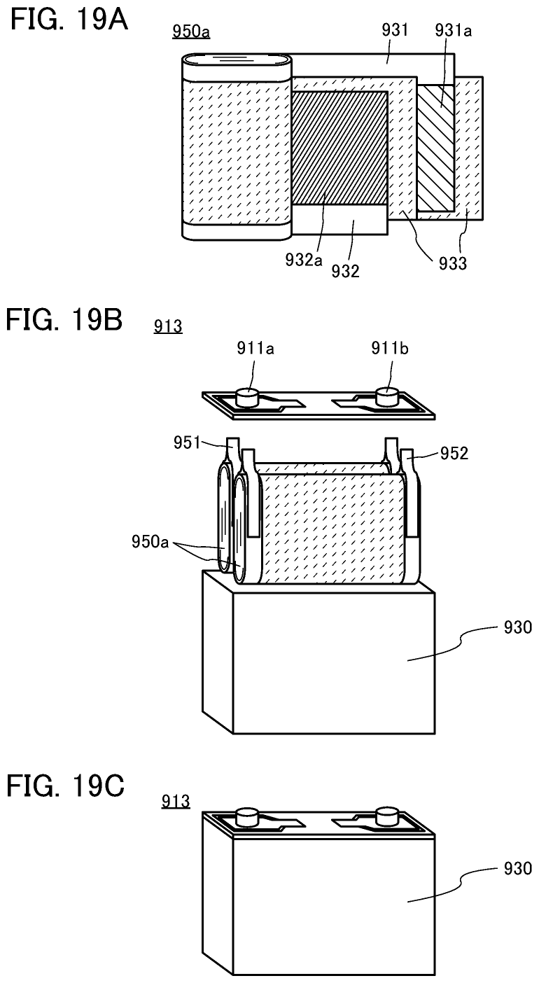

Structure examples of secondary batteries are described with reference to FIG. 18 and FIG. 19.

A secondary battery 913 illustrated in FIG. 18A includes a wound body 950 provided with a terminal 951 and a terminal 952 inside a housing 930. The wound body 950 is immersed in an electrolyte solution inside the housing 930. The terminal 952 is in contact with the housing 930. The use of an insulator or the like inhibits contact between the terminal 951 and the housing 930. Note that in FIG. 18A, the housing 930 divided into pieces is illustrated for convenience; however, in the actual structure, the wound body 950 is covered with the housing 930, and the terminal 951 and the terminal 952 extend to the outside of the housing 930. For the housing 930, a metal material (e.g., aluminum) or a resin material can be used.

Note that as illustrated in FIG. 18B, the housing 930 illustrated in FIG. 18A may be formed using a plurality of materials. For example, in the secondary battery 913 illustrated in FIG. 18B, a housing 930a and a housing 930b are attached to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field by the secondary battery 913 can be inhibited. When an electric field is not significantly blocked by the housing 930a, an antenna may be provided inside the housing 930a. For the housing 930b, a metal material can be used, for example.

FIG. 18C illustrates the structure of the wound body 950. The wound body 950 includes a negative electrode 931, a positive electrode 932, and separators 933. The wound body 950 is obtained by winding a sheet of a stack in which the negative electrode 931 and the positive electrode 932 overlap with each other with the separator 933 therebetween. Note that a plurality of stacks each including the negative electrode 931, the positive electrode 932, and the separators 933 may be further stacked.

As illustrated in FIG. 19A to FIG. 19C, the secondary battery 913 may include a wound body 950a. The wound body 950a illustrated in FIG. 19A includes the negative electrode 931, the positive electrode 932, and the separators 933. The negative electrode 931 includes a negative electrode active material layer 931a. The positive electrode 932 includes a positive electrode active material layer 932a.

The positive electrode active material 100 obtained in Embodiment 1 to Embodiment 11 is used for the positive electrode 932, whereby the secondary battery 913 can have high capacity, high charge and discharge capacity, and excellent cycle performance.

The separator 933 has a larger width than the negative electrode active material layer 931a and the positive electrode active material layer 932a, and is wound to overlap with the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high level of safety and high productivity.

As illustrated in FIG. 19B, the negative electrode 931 is electrically connected to the terminal 951. The terminal 951 is electrically connected to a terminal 911a. The positive electrode 932 is electrically connected to the terminal 952. The terminal 952 is electrically connected to a terminal 911b.

As illustrated in FIG. 19C, the wound body 950a and an electrolyte solution are covered with the housing 930, whereby the secondary battery 913 is completed. The housing 930 is preferably provided with a safety valve, an overcurrent protection element, and the like. In order to prevent the battery from exploding, a safety valve is a valve to be released when the internal pressure of the housing 930 reaches a predetermined pressure.

As illustrated in FIG. 19B, the secondary battery 913 may include a plurality of the wound bodies 950a. The use of the plurality of wound bodies 950a enables the secondary battery 913 to have higher charge and discharge capacity. The description of the secondary battery 913 illustrated in FIG. 18A to FIG. 18C can be referred to for the other components of the secondary battery 913 illustrated in FIG. 19A and FIG. 19B.

### <Laminated Secondary Battery>

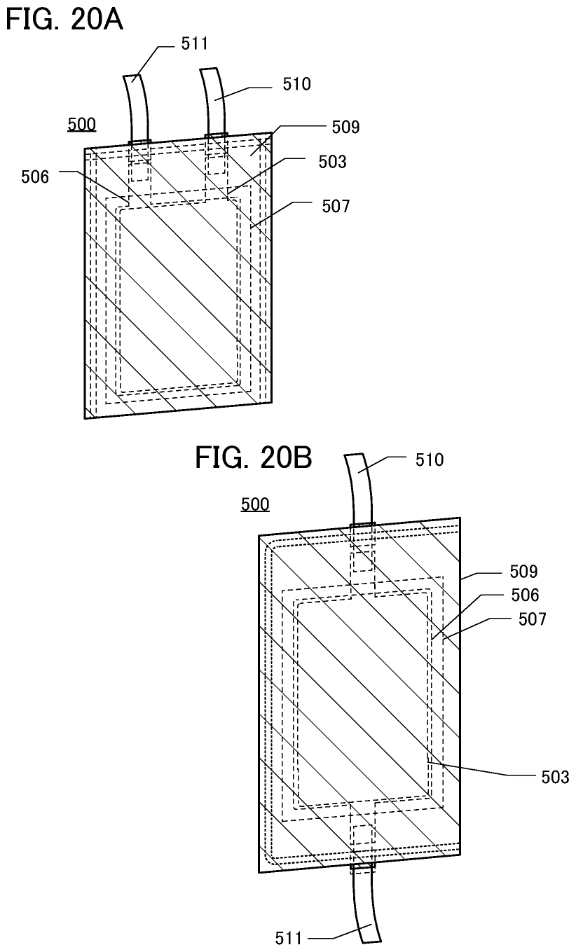

Next, examples of the appearance of a laminated secondary battery are illustrated in FIG. 20A and FIG. 20B. In FIG. 20A and FIG. 20B, a positive electrode 503, a negative electrode 506, a separator 507, an exterior body 509, a positive electrode lead electrode 510, and a negative electrode lead electrode 511 are included.

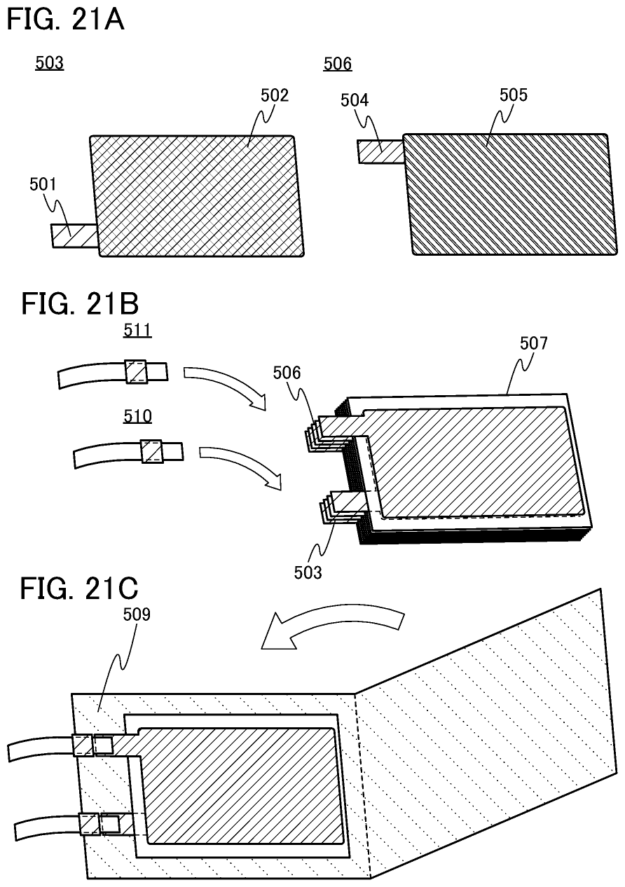

FIG. 21A illustrates the appearance of the positive electrode 503 and the negative electrode 506. The positive electrode 503 includes a positive electrode current collector 501, and a positive electrode active material layer 502 is formed on a surface of the positive electrode current collector 501. The positive electrode 503 also includes a region where the positive electrode current collector 501 is partly exposed (hereinafter, referred to as a tab region). The negative electrode 506 includes a negative electrode current collector 504, and a negative electrode active material layer 505 is formed on a surface of the negative electrode current collector 504.

The negative electrode 506 also includes a region where the negative electrode current collector 504 is partly exposed, that is, a tab region. The areas and the shapes of the tab regions included in the positive electrode and the negative electrode are not limited to the examples illustrated in FIG. 21A.

### <Method for Fabricating Laminated Secondary Battery>

Here, an example of a method for fabricating the laminated secondary battery whose external view is illustrated in FIG. 20A will be described with reference to FIG. 21B and FIG. 21C.

First, the negative electrode 506, the separator 507, and the positive electrode 503 are stacked. FIG. 21B illustrates the negative electrodes 506, the separators 507, and the positive electrodes 503 that are stacked. Here, an example in which five negative electrodes and four positive electrodes are used is shown. The component can also be referred to as a stack including the negative electrodes, the separators, and the positive electrodes. Next, the tab regions of the positive electrodes 503 are bonded to each other, and the positive electrode lead electrode 510 is bonded to the tab region of the positive electrode on the outermost surface. The bonding can be performed by ultrasonic welding, for example. In a similar manner, the tab regions of the negative electrodes 506 are bonded to each other, and the negative electrode lead electrode 511 is bonded to the tab region of the negative electrode on the outermost surface.

After that, the negative electrodes 506, the separators 507, and the positive electrodes 503 are placed over the exterior body 509.

Subsequently, the exterior body 509 is folded along a portion shown by a dashed line, as illustrated in FIG. 21C. Then, the outer edges of the exterior body 509 are bonded to each other. The bonding can be performed by thermocompression, for example. At this time, an unbonded region (hereinafter, referred to as an inlet) is provided for part (or one side) of the exterior body 509 so that an electrolyte solution can be introduced later.

Next, the electrolyte solution (not illustrated) is introduced into the exterior body 509 from the inlet of the exterior body 509. The electrolyte solution is preferably introduced in a reduced pressure atmosphere or in an inert atmosphere. Lastly, the inlet is sealed by bonding. In this manner, a laminated secondary battery 500 can be fabricated.

The positive electrode active material 100 described in any of Embodiment 1 to Embodiment 11 is used for the positive electrode 503, whereby the secondary battery 500 can have high capacity, high charge and discharge capacity, and excellent cycle performance.

### Examples of Battery Pack

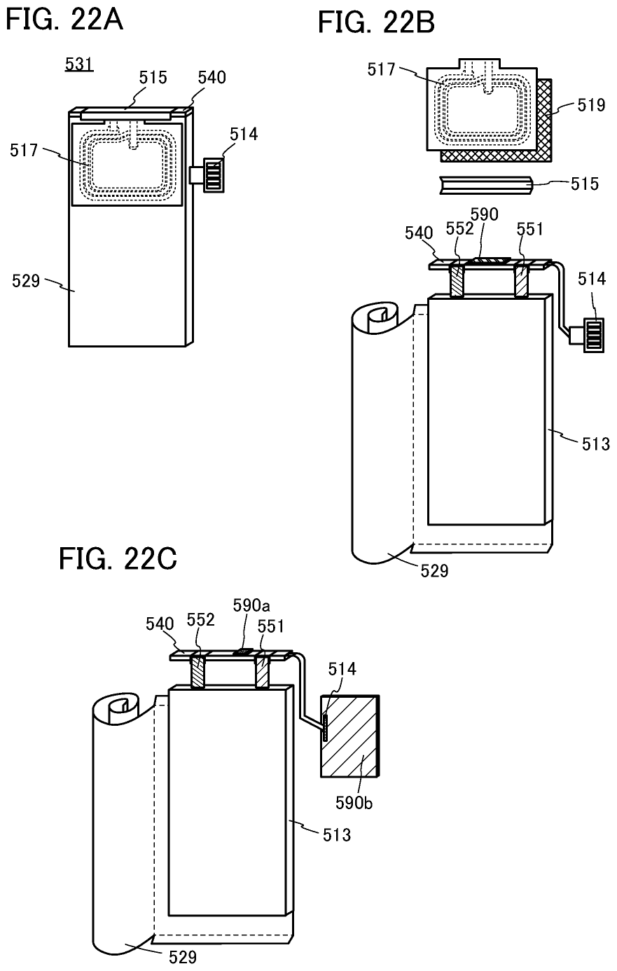

Examples of a secondary battery pack of one embodiment of the present invention that is capable of wireless charging using an antenna will be described with reference to FIG. 22A to FIG. 22C.

FIG. 21A is a diagram illustrating the appearance of a secondary battery pack 531 that has a rectangular solid shape with a small thickness (also referred to as a flat plate shape with a certain thickness). FIG. 22B is a diagram illustrating a structure of the secondary battery pack 531. The secondary battery pack 531 includes a circuit board 540 and a secondary battery 513. A label 529 is attached to the secondary battery 513. The circuit board 540 is fixed by a sealant 515. The secondary battery pack 531 also includes an antenna 517.

A wound body or a stack may be included inside the secondary battery 513.

In the secondary battery pack 531, a control circuit 590 is provided over the circuit board 540 as illustrated in FIG. 22B, for example. The circuit board 540 is electrically connected to a terminal 514. The circuit board 540 is electrically connected to the antenna 517, one 551 of a positive electrode lead and a negative electrode lead of the secondary battery 513, and the other 552 of the positive electrode lead and the negative electrode lead.

Alternatively, as illustrated in FIG. 22C, a circuit system 590a provided over the circuit board 540 and a circuit system 590b electrically connected to the circuit board 540 through the terminal 514 may be included.

Note that the shape of the antenna 517 is not limited to a coil shape and may be a linear shape or a plate shape, for example. Furthermore, a planar antenna, an aperture antenna, a traveling-wave antenna, an EH antenna, a magnetic-field antenna, a dielectric antenna, or the like may be used. Alternatively, the antenna 517 may be a flat-plate conductor. The flat-plate conductor can serve as one of conductors for electric field coupling. That is, the antenna 517 can function as one of two conductors of a capacitor. Thus, electric power can be transmitted and received not only by an electromagnetic field or a magnetic field but also by an electric field.

The secondary battery pack 531 includes a layer 519 between the antenna 517 and the secondary battery 513. The layer 519 has a function of blocking an electromagnetic field from the secondary battery 513, for example. As the layer 519, a magnetic material can be used, for example.

The contents in this embodiment can be freely combined with the contents in the other embodiments.

### Embodiment 14

In this embodiment, an example in which an all-solid-state battery is fabricated using the positive electrode active material 100 described in Embodiment 1 to Embodiment 11 will be described.

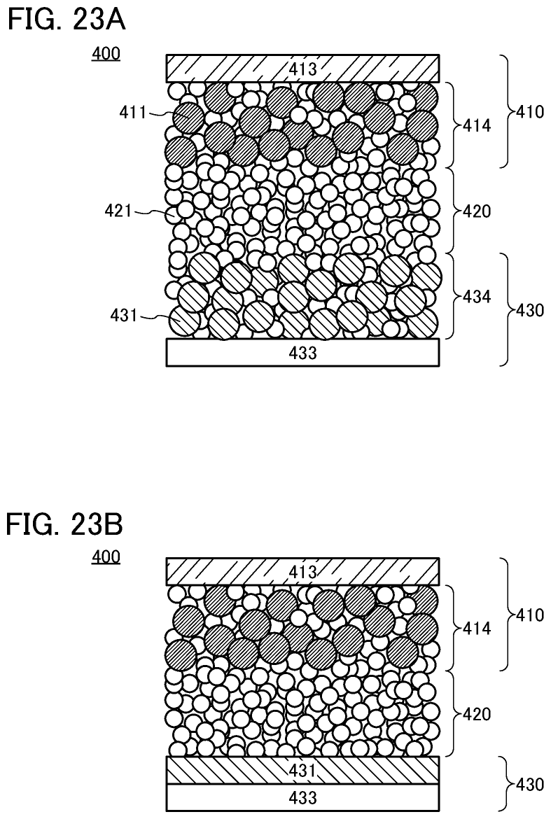

As illustrated in FIG. 23A, a secondary battery 400 of one embodiment of the present invention includes a positive electrode 410, a solid electrolyte layer 420, and a negative electrode 430.

The positive electrode 410 includes a positive electrode current collector 413 and a positive electrode active material layer 414. The positive electrode active material layer 414 includes a positive electrode active material 411 and a solid electrolyte 421. The positive electrode active material 100 described in Embodiment 1 to Embodiment 11 is used as the positive electrode active material 411. The positive electrode active material layer 414 may include a conductive material and a binder.

The solid electrolyte layer 420 includes the solid electrolyte 421. The solid electrolyte layer 420 is positioned between the positive electrode 410 and the negative electrode 430 and is a region that includes neither the positive electrode active material 411 nor a negative electrode active material 431.

The negative electrode 430 includes a negative electrode current collector 433 and a negative electrode active material layer 434. The negative electrode active material layer 434 includes the negative electrode active material 431 and the solid electrolyte 421. The negative electrode active material layer 434 may include a conductive material and a binder. Note that when metal lithium is used as the negative electrode active material 431, metal lithium does not need to be processed into particles; thus, the negative electrode 430 that does not include the solid electrolyte 421 can be formed, as illustrated in FIG. 23B. The use of metal lithium for the negative electrode 430 is preferable because the energy density of the secondary battery 400 can be increased.

As the solid electrolyte 421 included in the solid electrolyte layer 420, a sulfide-based solid electrolyte, an oxide-based solid electrolyte, or a halide-based solid electrolyte can be used, for example.

The sulfide-based solid electrolyte includes a thio-LISICON-based material (e.g., Li₁₀GeP₂S₁₂ or Li_{3.25}Ge_{0.25}P_{0.75}S₄), sulfide glass (e.g., 70Li₂S·30P₂S₅, 30Li₂S·26B₂S₃·44LiI, 63Li₂S·36SiS₂·1Li₃PO₄, 57Li₂S·38SiS₂·5Li₄SiO₄, or 50Li₂S·₅₀GeS₂), or sulfide-based crystallized glass (e.g., Li₇P₃S₁₁ or Li_{3.25}P_{0.95}S₄). The sulfide-based solid electrolyte has advantages such as high conductivity of some materials, low-temperature synthesis, and ease of maintaining a path for electrical conduction after charging and discharging because of its relative softness.

The oxide-based solid electrolyte includes a material with a perovskite crystal structure (e.g., La_{2/3-x}Li₃ₓTiO₃), a material with a NASICON crystal structure (e.g., Li_{1-Y}Al_{Y}Ti_{2-Y}(PO₄)₃), a material with a garnet crystal structure (e.g., Li₇La₃Zr₂O₁₂), a material with a LISICON crystal structure (e.g., Li₁₄ZnGe₄O₁₆), LLZO (Li₇La₃Zr₂O₁₂), oxide glass (e.g., Li₃PO₄—Li₄SiO₄ or 50Li₄SiO₄·50Li₃BO₃), or oxide-based crystallized glass (e.g., Li_{1.07}Al_{0.69}Ti_{1.46}(PO₄)₃ or Li_{1.5}Al_{0.5}Ge_{1.5}(PO₄)₃). The oxide-based solid electrolyte has an advantage of stability in the air.

Examples of the halide-based solid electrolyte include LiAlCl₄, Li₃InBr₆, LiF, LiCl, LiBr, and LiI. Moreover, a composite material in which pores of porous aluminum oxide or porous silica are filled with such a halide-based solid electrolyte can be used as the solid electrolyte.

Alternatively, different solid electrolytes may be mixed and used.

In particular, Li₁₊ₓAlₓTi₂₋ₓ(PO₄)₃ (0[x[1) having a NASICON crystal structure (hereinafter, LATP) is preferable because it contains aluminum and titanium, each of which is the element the positive electrode active material used in the secondary battery 400 of one embodiment of the present invention is allowed to contain, and thus synergy of improving the cycle performance is expected. Moreover, higher productivity due to the reduction in the number of steps is expected. Note that in this specification and the like, a NASICON crystal structure refers to a compound that is represented by M₂(XO₄)₃ (M: transition metal; X S, P, As, Mo, W, or the like) and has a structure in which MO₆ octahedrons and XO₄ tetrahedrons that share common corners are arranged three-dimensionally.

### [Exterior Body and Shape of Secondary Battery]

An exterior body of the secondary battery 400 of one embodiment of the present invention can be formed using a variety of materials and have a variety of shapes, and preferably has a function of applying pressure to the positive electrode, the solid electrolyte layer, and the negative electrode.

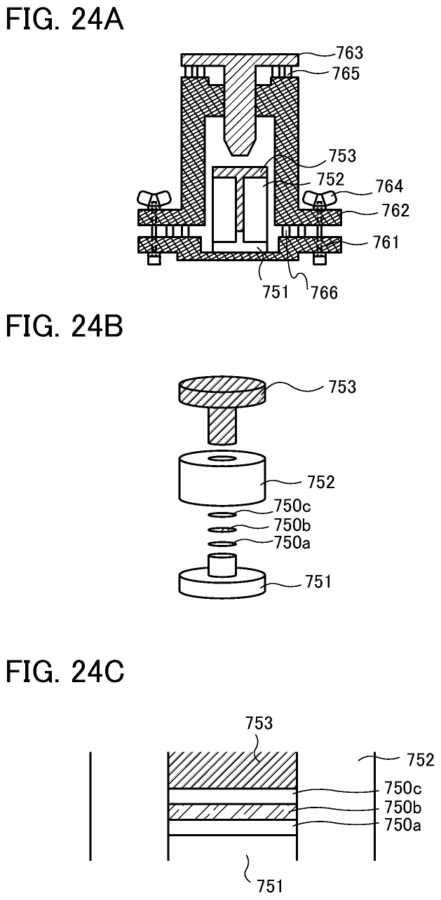

FIG. 24 illustrates an example of a cell for evaluating materials of an all-solid-state battery, for example.

FIG. 24A is a cross-sectional schematic view of the evaluation cell, and the evaluation cell includes a lower component 761, an upper component 762, and a fixation screw or a butterfly nut 764 for fixing these components; by rotating a pressure screw 763, an electrode plate 753 is pressed to fix an evaluation material. An insulator 766 is provided between the lower component 761 and the upper component 762 that are made of a stainless steel material. An 0 ring 765 for hermetic sealing is provided between the upper component 762 and the pressure screw 763.

The evaluation material is placed on an electrode plate 751, surrounded by an insulating tube 752, and pressed from above by the electrode plate 753. FIG. 24B is an enlarged perspective view of the evaluation material and its vicinity.

A stack of a positive electrode 750a, a solid electrolyte layer 750b, and a negative electrode 750c is illustrated here as an example of the evaluation material, and its cross-sectional view is illustrated in FIG. 24C. Note that the same portions in FIG. 24A to FIG. 24C are denoted by the same reference numerals.

The electrode plate 751 and the lower component 761 that are electrically connected to the positive electrode 750a correspond to a positive electrode terminal. The electrode plate 753 and the upper component 762 that are electrically connected to the negative electrode 750c correspond to a negative electrode terminal. The electric resistance or the like can be measured while pressure is applied to the evaluation material through the electrode plate 751 and the electrode plate 753.

A package having excellent airtightness is preferably used as the exterior body of the secondary battery of one embodiment of the present invention. For example, a ceramic package or a resin package can be used. The exterior body is sealed preferably in a closed atmosphere where the outside air is blocked, for example, in a glove box.

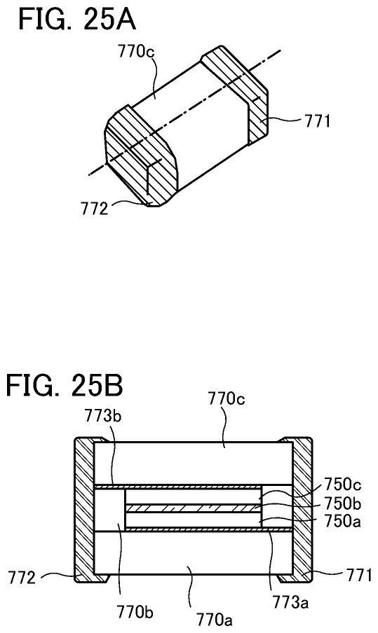

FIG. 25A illustrates a perspective view of a secondary battery of one embodiment of the present invention that has an exterior body and a shape different from those in FIG. 24. The secondary battery in FIG. 25A includes external electrodes 771 and 772 and is sealed with an exterior body including a plurality of package components.

FIG. 25B illustrates an example of a cross section along the dashed-dotted line in FIG. 25A. A stack including the positive electrode 750a, the solid electrolyte layer 750b, and the negative electrode 750c has a structure of being surrounded and sealed by a package component 770a including an electrode layer 773a on a flat plate, a frame-like package component 770b, and a package component 770c including an electrode layer 773b on a flat plate. For the package components 770a, 770b, and 770c, an insulating material, e.g., a resin material and ceramic, can be used.

The external electrode 771 is electrically connected to the positive electrode 750a through the electrode layer 773a and functions as a positive electrode terminal. The external electrode 772 is electrically connected to the negative electrode 750c through the electrode layer 773b and functions as a negative electrode terminal.

The use of the positive electrode active material 100 described in any one of Embodiment 1 to Embodiment 11 can achieve an all-solid-state secondary battery having a high energy density and favorable output characteristics.

The contents in this embodiment can be combined with the contents in the other embodiments as appropriate.

### Embodiment 15

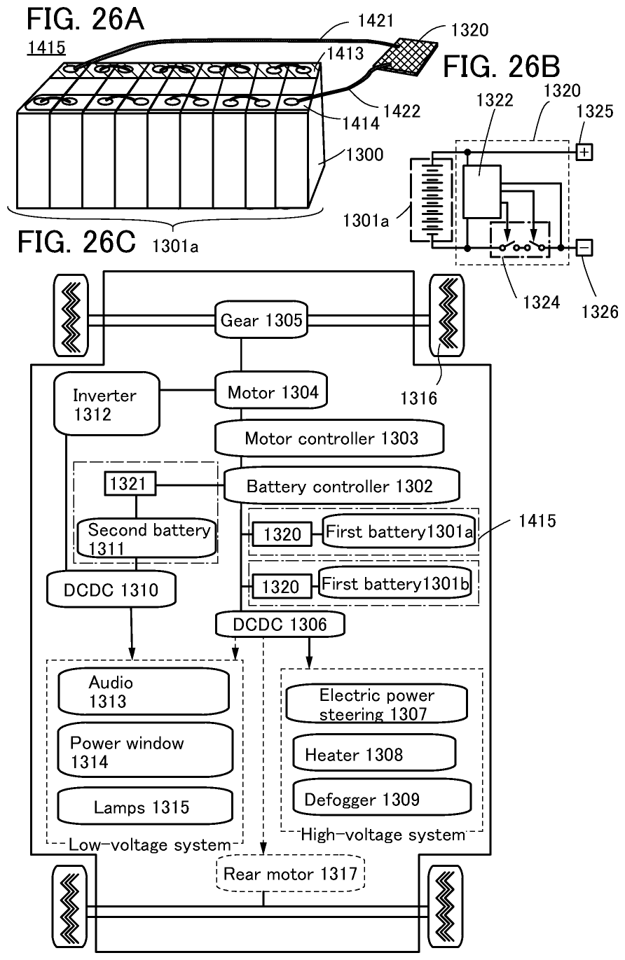

In this embodiment, an example different from the cylindrical secondary battery in FIG. 17D will be described. An example of application to an electric vehicle (EV) will be described with reference to FIG. 26C.

The electric vehicle is provided with first batteries 1301a and 1301b as main secondary batteries for driving and a second battery 1311 that supplies electric power to an inverter 1312 for starting a motor 1304. The second battery 1311 is also referred to as a cranking battery (also referred to as a starter battery). The second battery 1311 only needs high output and high capacity is not so much needed; the capacity of the second battery 1311 is lower than that of the first batteries 1301a and 1301b.

The internal structure of the first battery 1301a may be the wound structure illustrated in FIG. 18A or FIG. 19C or the stacked-layer structure illustrated in FIG. 20A or FIG. 20B.

Alternatively, the first battery 1301a may be an all-solid-state battery. The use of the all-solid-state battery as the first battery 1301a can achieve high capacity, improvement in safety, and reduction in size and weight.

Although this embodiment describes an example in which the two first batteries 1301a and 1301b are connected in parallel, three or more batteries may be connected in parallel. In the case where the first battery 1301a can store sufficient electric power, the first battery 1301b may be omitted. By constituting a battery pack including a plurality of secondary batteries, large electric power can be extracted. The plurality of secondary batteries may be connected in parallel, connected in series, or connected in series after being connected in parallel. The plurality of secondary batteries are also referred to as an assembled battery.

In order to cut off electric power from the plurality of secondary batteries, the secondary batteries in the vehicle include a service plug or a circuit breaker that can cut off a high voltage without the use of equipment. The first battery 1301a is provided with such a service plug or a circuit breaker.

Electric power from the first batteries 1301a and 1301b is mainly used to rotate the motor 1304 and is supplied to in-vehicle parts for 42 V (such as an electric power steering 1307, a heater 1308, and a defogger 1309) through a DCDC circuit 1306. Even in the case where there is a rear motor 1317 for rear wheels, the first battery 1301a is used to rotate the rear motor 1317.

The second battery 1311 supplies electric power to in-vehicle parts for 14 V (such as a stereo 1313, a power window 1314, and lamps 1315) through a DCDC circuit 1310.

The first battery 1301a will be described with reference to FIG. 26A.

FIG. 26A illustrates an example in which nine rectangular secondary batteries 1300 form one battery pack 1415. The nine rectangular secondary batteries 1300 are connected in series; one electrode of each battery is fixed by a fixing portion 1413 made of an insulator, and the other electrode thereof is fixed by a fixing portion 1414 made of an insulator. Although this embodiment describes an example in which the secondary batteries are fixed by the fixing portions 1413 and 1414, they may be stored in a battery container box (also referred to as a housing). Since a vibration or a jolt is assumed to be given to the vehicle from the outside (e.g., a road surface), the plurality of secondary batteries are preferably fixed by the fixing portions 1413 and 1414 and a battery container box, for example. Furthermore, the one electrode is electrically connected to a control circuit portion 1320 through a wiring 1421. The other electrode is electrically connected to the control circuit portion 1320 through a wiring 1422.

The control circuit portion 1320 may include a memory circuit including a transistor using an oxide semiconductor. A charge control circuit or a battery control system that includes a memory circuit including a transistor using an oxide semiconductor is referred to as a BTOS (Battery operating system or Battery oxide semiconductor) in some cases.

A metal oxide functioning as an oxide semiconductor is preferably used. For example, as the oxide, a metal oxide such as an In-M-Zn oxide (the element M is one or more kinds selected from aluminum, gallium, yttrium, copper, vanadium, beryllium, boron, titanium, iron, nickel, germanium, zirconium, molybdenum, lanthanum, cerium, neodymium, hafnium, tantalum, tungsten, magnesium, and the like) or the like is preferably used. In particular, the In-M-Zn oxide that can be used as the oxide is preferably a CAAC-OS (C-Axis Aligned Crystal Oxide Semiconductor) or a CAC-OS (Cloud-Aligned Composite Oxide Semiconductor). Alternatively, an In—Ga oxide or an In—Zn oxide may be used as the oxide. The CAAC-OS is an oxide semiconductor that has a plurality of crystal regions each of which has c-axis alignment in a particular direction. Note that the particular direction refers to the film thickness direction of a CAAC-OS film, the normal direction of the surface where the CAAC-OS film is formed, or the normal direction of the surface of the CAAC-OS film. The crystal region refers to a region having a periodic atomic arrangement. Note that when an atomic arrangement is regarded as a lattice arrangement, the crystal region also refers to a region with a uniform lattice arrangement. The CAAC-OS has a region where a plurality of crystal regions are connected in the a-b plane direction, and the region has distortion in some cases. Note that distortion refers to a portion where the orientation of a lattice arrangement changes between a region with a uniform lattice arrangement and another region with a uniform lattice arrangement in a region where a plurality of crystal regions are connected. That is, the CAAC-OS is an oxide semiconductor having c-axis alignment and having no clear alignment in the a-b plane direction. The CAC-OS refers to one composition of a material in which elements constituting a metal oxide are unevenly distributed with a size greater than or equal to 0.5 nm and less than or equal to 10 nm, preferably greater than or equal to 1 nm and less than or equal to 3 nm, or a similar size, for example. Note that a state in which one or more metal elements are unevenly distributed and regions including the metal element(s) are mixed with a size greater than or equal to 0.5 nm and less than or equal to 10 nm, preferably greater than or equal to 1 nm and less than or equal to 3 nm, or a similar size in a metal oxide is hereinafter referred to as a mosaic pattern or a patch-like pattern.

In addition, the CAC-OS has a composition in which materials are separated into a first region and a second region to form a mosaic pattern, and the first regions are distributed in the film (this composition is hereinafter also referred to as a cloud-like composition). That is, the CAC-OS is a composite metal oxide having a composition in which the first regions and the second regions are mixed.

Here, the atomic ratios of In, Ga, and Zn to the metal elements contained in the CAC-OS in an In—Ga—Zn oxide are denoted by [In], [Ga], and [Zn], respectively. For example, the first region in the CAC-OS in the In—Ga—Zn oxide is a region having [In] higher than [In] in the composition of the CAC-OS film. Moreover, the second region is a region having [Ga] higher than [Ga] in the composition of the CAC-OS film. Alternatively, for example, the first region is a region having [In] higher than [In] in the second region and [Ga] lower than [Ga] in the second region. Moreover, the second region is a region having [Ga] higher than [Ga] in the first region and [In] lower than [In] in the first region.

Specifically, the first region is a region containing an indium oxide, an indium zinc oxide, or the like as its main component. The second region is a region containing a gallium oxide, a gallium zinc oxide, or the like as its main component. That is, the first region can be rephrased as a region containing In as its main component. The second region can be rephrased as a region containing Ga as its main component.

Note that a clear boundary between the first region and the second region cannot be observed in some cases.

For example, energy dispersive X-ray spectroscopy (EDX) is used to obtain EDX mapping, and according to the EDX mapping, the CAC-OS in the In—Ga—Zn oxide can be found to have a structure in which the region containing In as its main component (the first region) and the region containing Ga as its main component (the second region) are unevenly distributed and mixed.

In the case where the CAC-OS is used for a transistor, a switching function (On/Off switching function) can be given to the CAC-OS owing to the complementary action of the conductivity derived from the first region and the insulating property derived from the second region. That is, the CAC-OS has a conducting function in part of the material and has an insulating function in another part of the material; as a whole, the CAC-OS has a function of a semiconductor. Separation of the conducting function and the insulating function can maximize each function. Accordingly, when the CAC-OS is used for a transistor, high on-state current (Ion), high field-effect mobility (μ), and excellent switching operation can be achieved.

An oxide semiconductor has various structures with different properties. Two or more kinds among an amorphous oxide semiconductor, a polycrystalline oxide semiconductor, an a-like OS, a CAC-OS, an nc-OS, and a CAAC-OS may be included in an oxide semiconductor of one embodiment of the present invention.

The control circuit portion 1320 preferably includes a transistor using an oxide semiconductor because it can be used in a high-temperature environment. For the process simplicity, the control circuit portion 1320 may be formed using transistors of the same conductivity type. A transistor using an oxide semiconductor in its semiconductor layer has an operating ambient temperature range of ˜40° C. to 150° C. inclusive, which is wider than that of a single crystal Si transistor, and thus shows a smaller change in characteristics than the single crystal Si transistor when the secondary battery is heated. The off-state current of the transistor using an oxide semiconductor is lower than or equal to the lower measurement limit even at 150° C. independently of the temperature; meanwhile, the off-state current characteristics of the single crystal Si transistor largely depend on the temperature. For example, at 150° C., the off-state current of the single crystal Si transistor increases, and a sufficiently high current on/off ratio cannot be obtained. The control circuit portion 1320 can improve the safety. When the control circuit portion 1320 is used in combination with a secondary battery including a positive electrode using the positive electrode active material 100 described in Embodiment 1 to Embodiment 11, the synergy on safety can be obtained.

The control circuit portion 1320 that includes a memory circuit including a transistor using an oxide semiconductor can also function as an automatic control device for the secondary battery to resolve causes of instability, such as a micro-short circuit. Examples of functions of resolving the causes of instability of the secondary battery include prevention of overcharge, prevention of overcurrent, control of overheating during charging, cell balance of an assembled battery, prevention of overdischarge, a battery indicator, automatic control of charge voltage and current amount according to temperature, control of the amount of charge current according to the degree of deterioration, abnormal behavior detection for a micro-short circuit, and anomaly prediction regarding a micro-short circuit; the control circuit portion 1320 has at least one of these functions. Furthermore, the automatic control device for the secondary battery can be extremely small in size.

A micro-short circuit refers to a minute short circuit caused in a secondary battery and refers not to a state where the positive electrode and the negative electrode of a secondary battery are short-circuited so that charging and discharging are impossible, but to a phenomenon in which a slight short-circuit current flows through a minute short-circuit portion. Since a large voltage change is caused even when a micro-short circuit occurs in a relatively short time in a minute area, the abnormal voltage value might adversely affect estimation to be performed subsequently.

One of the causes of a micro-short circuit is as follows: a plurality of charging and discharging cause an uneven distribution of positive electrode active materials, which leads to local concentration of current in part of the positive electrode and part of the negative electrode, whereby part of a separator stops functioning or a by-product is generated by a side reaction, which is thought to generate a micro short-circuit.

It can be said that the control circuit portion 1320 not only detects a micro-short circuit but also senses terminal voltage of the secondary battery and controls the charge and discharge state of the secondary battery. For example, to prevent overcharge, an output transistor of a charge circuit and an interruption switch can be turned off substantially at the same time.

FIG. 26B illustrates an example of a block diagram of the battery pack 1415 illustrated in FIG. 26A.

The control circuit portion 1320 includes a switch portion 1324 that includes at least a switch for preventing overcharge and a switch for preventing overdischarge, a control circuit 1322 for controlling the switch portion 1324, and a portion for measuring the voltage of the first battery 1301a. The control circuit portion 1320 is set to have the upper limit voltage and the lower limit voltage of the secondary battery to be used, and imposes the upper limit of current from the outside, the upper limit of output current to the outside, and the like. The range from the lower limit voltage to the upper limit voltage of the secondary battery falls within the recommended voltage range; when a voltage falls outside the range, the switch portion 1324 operates and functions as a protection circuit. The control circuit portion 1320 can also be referred to as a protection circuit because it controls the switch portion 1324 to prevent overdischarge and overcharge. For example, when the control circuit 1322 detects a voltage that is likely to cause overcharge, current is interrupted by turning off the switch in the switch portion 1324. Furthermore, a function of interrupting current in accordance with a temperature rise may be set by providing a PTC element in the charge and discharge path. The control circuit portion 1320 includes an external terminal (+IN) 1325 and an external terminal (—IN) 1326.

The switch portion 1324 can be formed by a combination of an n-channel transistor and a p-channel transistor. The switch portion 1324 is not limited to a switch including a Si transistor using single crystal silicon; the switch portion 1324 may be formed using, for example, a power transistor containing Ge (germanium), SiGe (silicon germanium), GaAs (gallium arsenide), GaAlAs (gallium aluminum arsenide), InP (indium phosphide), SiC (silicon carbide), ZnSe (zinc selenide), GaN (gallium nitride), GaOₓ (gallium oxide, where x is a real number greater than 0), or the like. A memory element using an OS transistor can be freely placed by being stacked over a circuit using a Si transistor, for example; hence, integration can be easy. Furthermore, an OS transistor can be fabricated with a manufacturing apparatus similar to that for a Si transistor and thus can be fabricated at low cost. That is, the control circuit portion 1320 using an OS transistor can be stacked over the switch portion 1324 so that they can be integrated into one chip. Since the volume occupied by the control circuit portion 1320 can be reduced, a reduction in size is possible.

The first batteries 1301a and 1301b mainly supply electric power to in-vehicle parts for 42 V (for a high-voltage system), and the second battery 1311 supplies electric power to in-vehicle parts for 14 V (for a low-voltage system).

In this embodiment, an example in which a lithium-ion secondary battery is used as both the first battery 1301a and the second battery 1311 is described. As the second battery 1311, a lead storage battery, an all-solid-state battery, or an electric double layer capacitor may be used. For example, the all-solid-state battery in Embodiment 5 may be used. The use of the all-solid-state battery in Embodiment 5 as the second battery 1311 can achieve high capacity and reduction in size and weight.

Regenerative energy generated by rolling of tires 1316 is transmitted to the motor 1304 through a gear 1305, and is stored in the second battery 1311 from a motor controller 1303 and a battery controller 1302 through a control circuit portion 1321. Alternatively, the regenerative energy is stored in the first battery 1301a from the battery controller 1302 through the control circuit portion 1320. Alternatively, the regenerative energy is stored in the first battery 1301b from the battery controller 1302 through the control circuit portion 1320. For efficient charging with regenerative energy, the first batteries 1301a and 1301b are desirably capable of fast charging.

The battery controller 1302 can set the charge voltage, charge current, and the like of the first batteries 1301a and 1301b. The battery controller 1302 can set charge conditions in accordance with charge characteristics of a secondary battery to be used, so that fast charging can be performed.

Although not illustrated, in the case of connection to an external charger, an outlet of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used; to prevent overcharge, the first batteries 1301a and 1301b are preferably charged through the control circuit portion 1320. In addition, a connection cable or the connection cable of the charger is sometimes provided with a control circuit. The control circuit portion 1320 is also referred to as an ECU (Electronic Control Unit). The ECU is connected to a CAN (Controller Area Network) provided in the electric vehicle. The CAN is a type of a serial communication standard used as an in-vehicle LAN. The ECU includes a microcomputer. Moreover, the ECU uses a CPU or a GPU.

External chargers installed at charge stations and the like have a 100 V outlet, a 200 V outlet, and a three-phase 200 V outlet with 50 kW, for example. Furthermore, charging can be performed with electric power supplied from external charge equipment by a contactless power feeding method or the like.

For fast charging, secondary batteries that can withstand high-voltage charging have been desired to perform charging in a short time.

The above-described secondary battery in this embodiment uses the positive electrode active material 100 described in Embodiment 1 to Embodiment 11. Moreover, it is possible to achieve a secondary battery in which graphene is used as a conductive material, an electrode layer is formed thick to increase the loading amount while suppressing a reduction in capacity, and the electrical characteristics are significantly improved in synergy with maintenance of high capacity. This secondary battery is particularly effectively used in a vehicle; it is possible to provide a vehicle that has a long cruising range, specifically one charge mileage of 500 km or greater, without increasing the proportion of the weight of the secondary battery to the weight of the entire vehicle.

Specifically, in the above-described secondary battery in this embodiment, the use of the positive electrode active material 100 described in any one of Embodiment 1 to Embodiment 11 can increase the operating voltage of the secondary battery, and the increase in charge voltage can increase the available capacity. Moreover, using the positive electrode active material 100 described in Embodiment 1 to Embodiment 11 in the positive electrode can provide an automotive secondary battery having excellent cycle performance.

Next, examples in which the secondary battery of one embodiment of the present invention is mounted on a vehicle, typically a transport vehicle, will be described.

Mounting the secondary battery illustrated in any one of FIG. 17D, FIG. 19C, and FIG. 26A on vehicles can achieve next-generation clean energy vehicles such as hybrid vehicles (HVs), electric vehicles (EVs), and plug-in hybrid vehicles (PHVs). The secondary battery can also be mounted on transport vehicles such as agricultural machines, motorized bicycles including motor-assisted bicycles, motorcycles, electric wheelchairs, electric carts, boats and ships, submarines, aircraft such as fixed-wing aircraft and rotary-wing aircraft, rockets, artificial satellites, space probes, planetary probes, and spacecraft. The secondary battery of one embodiment of the present invention can be a secondary battery with high capacity. Thus, the secondary battery of one embodiment of the present invention is suitable for reduction in size and reduction in weight and is preferably used in transport vehicles.

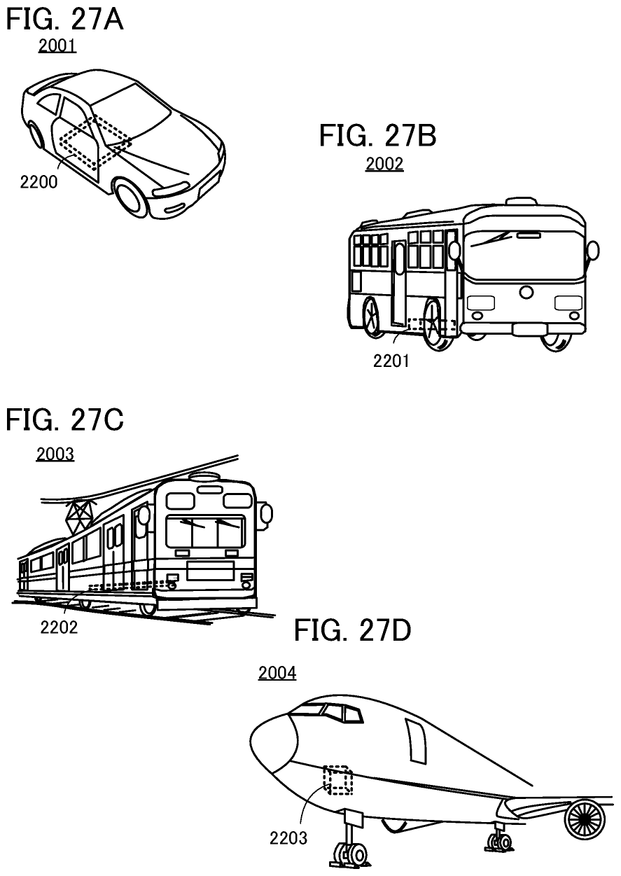

FIG. 27A to FIG. 27D illustrate examples of transport vehicles using one embodiment of the present invention. A motor vehicle 2001 illustrated in FIG. 27A is an electric vehicle that runs using an electric motor as a driving power source. Alternatively, the motor vehicle 2001 is a hybrid vehicle that can appropriately select an electric motor or an engine as a driving power source. In the case where the secondary battery is mounted on the vehicle, an example of the secondary battery described in Embodiment 4 is provided at one position or several positions. The motor vehicle 2001 illustrated in FIG. 27A includes a battery pack 2200, and the battery pack includes a secondary battery module in which a plurality of secondary batteries are connected to each other. Moreover, the battery pack preferably includes a charge control device that is electrically connected to the secondary battery module.

The motor vehicle 2001 can be charged when the secondary battery included in the motor vehicle 2001 is supplied with electric power from external charge equipment by a plug-in system, a contactless charge system, or the like. In charging, a given method such as CHAdeMO (registered trademark) or Combined Charging System may be employed as a charge method, the standard of a connector, and the like as appropriate. The secondary battery may be a charge station provided in a commerce facility or a household power supply. For example, with the use of the plug-in system, the power storage device mounted on the motor vehicle 2001 can be charged by being supplied with electric power from the outside. Charging can be performed by converting AC power into DC power through a converter such as an ACDC converter.

Although not illustrated, the vehicle can include a power receiving device so as to be charged by being supplied with electric power from an above-ground power transmitting device in a contactless manner. For the contactless power feeding system, by fitting a power transmitting device in a road or an exterior wall, charging can be performed not only when the vehicle is stopped but also when driven. In addition, the contactless power feeding system may be utilized to perform transmission and reception of electric power between two vehicles. Furthermore, a solar cell may be provided in the exterior of the vehicle to charge the secondary battery when the vehicle stops and moves. To supply electric power in such a contactless manner, an electromagnetic induction method or a magnetic resonance method can be used.

FIG. 27B illustrates a large transporter 2002 having a motor controlled by electricity, as an example of a transport vehicle. The secondary battery module of the transporter 2002 has a cell unit of four secondary batteries with a nominal voltage of 3.0 V or higher and 5.0 V or lower, and 48 cells are connected in series to have 170 V as the maximum voltage. A battery pack 2201 has the same function as that in FIG. 27A except, for example, the number of secondary batteries configuring the secondary battery module; thus, the description is omitted.

FIG. 27C illustrates a large transport vehicle 2003 having a motor controlled by electricity as an example. A secondary battery module of the transport vehicle 2003 has 100 or more secondary batteries with a nominal voltage of 3.0 V or higher and 5.0 V or lower connected in series, and the maximum voltage is 600 V, for example. When a secondary battery using the positive electrode active material 100 described in Embodiment 1 to Embodiment 11 for a positive electrode is used, a secondary battery having favorable rate performance and charge and discharge cycle performance can be manufactured, which can contribute to higher performance and a longer lifetime of the transport vehicle 2003. A battery pack 2202 has the same function as that in FIG. 26A except, for example, the number of secondary batteries configuring the secondary battery module; thus, the description is omitted.

FIG. 27D illustrates an aircraft 2004 having a combustion engine as an example. The aircraft 2004 illustrated in FIG. 27D can be regarded as a kind of transport vehicles since it is provided with wheels for takeoff and landing, and has a battery pack 2203 including a secondary battery module and a charge control device; the secondary battery module includes a plurality of connected secondary batteries.

The secondary battery module of the aircraft 2004 has eight 4 V secondary batteries connected in series, which has the maximum voltage of 32 V, for example. The battery pack 2203 has the same function as that in FIG. 27A except, for example, the number of secondary batteries configuring the secondary battery module; thus, the description is omitted.

The contents in this embodiment can be combined with the contents in the other embodiments as appropriate.

### Embodiment 16

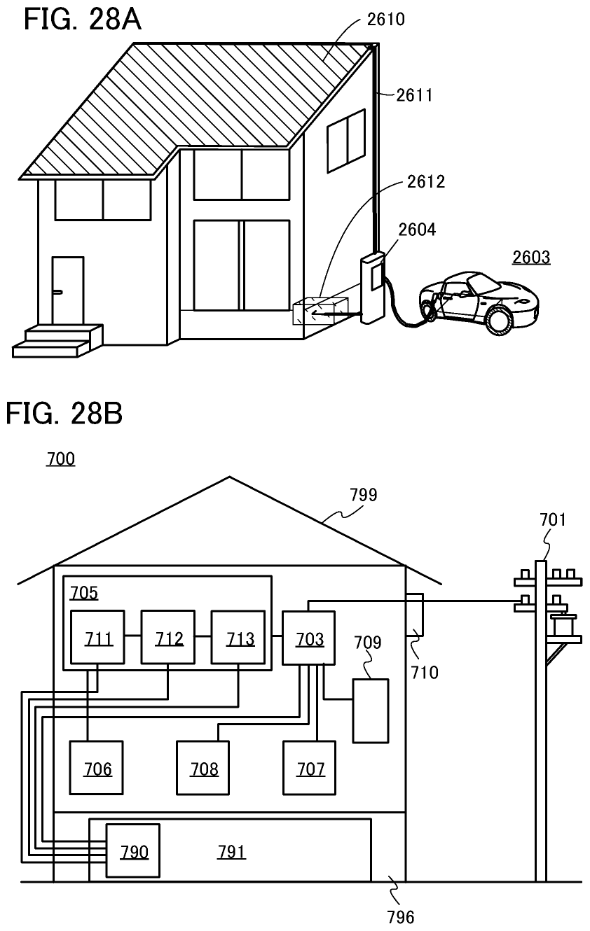

In this embodiment, examples in which the secondary battery of one embodiment of the present invention is mounted on a building will be described with reference to FIG. 28A and FIG. 28B.

A house illustrated in FIG. 28A includes a power storage device 2612 including the secondary battery of one embodiment of the present invention and a solar panel 2610. The power storage device 2612 is electrically connected to the solar panel 2610 through a wiring 2611 or the like. The power storage device 2612 may be electrically connected to ground-based charge equipment 2604. The power storage device 2612 can be charged with electric power generated by the solar panel 2610. A secondary battery included in a vehicle 2603 can be charged with the electric power stored in the power storage device 2612 through the charge equipment 2604. The power storage device 2612 is preferably provided in an underfloor space. The power storage device 2612 is provided in the underfloor space, in which case the space on the floor can be effectively used. Alternatively, the power storage device 2612 may be provided on the floor.

The electric power stored in the power storage device 2612 can also be supplied to other electronic devices in the house. Thus, with the use of the power storage device 2612 of one embodiment of the present invention as an uninterruptible power source, electronic devices can be used even when electric power cannot be supplied from a commercial power source due to power failure or the like.

FIG. 28B illustrates an example of a power storage device 700 of one embodiment of the present invention. As illustrated in FIG. 28B, a power storage device 791 of one embodiment of the present invention is provided in an underfloor space 796 of a building 799. The power storage device 791 may be provided with the control circuit described in Embodiment 15, and the use of a secondary battery including a positive electrode using the positive electrode active material 100 described in Embodiment 1 to Embodiment 11 for the power storage device 791 enables the power storage device 791 to have a long lifetime.

The power storage device 791 is provided with a control device 790, and the control device 790 is electrically connected to a distribution board 703, a power storage controller 705 (also referred to as a control device), an indicator 706, and a router 709 through wirings.

Electric power is transmitted from a commercial power source 701 to the distribution board 703 through a service wire mounting portion 710. Moreover, electric power is transmitted to the distribution board 703 from the power storage device 791 and the commercial power source 701, and the distribution board 703 supplies the transmitted electric power to a general load 707 and a power storage load 708 through outlets (not illustrated).

The general load 707 is, for example, an electric device such as a TV or a personal computer. The power storage load 708 is, for example, an electric device such as a microwave, a refrigerator, or an air conditioner.

The power storage controller 705 includes a measuring portion 711, a predicting portion 712, and a planning portion 713. The measuring portion 711 has a function of measuring the amount of electric power consumed by the general load 707 and the power storage load 708 during a day (e.g., from midnight to midnight). The measuring portion 711 may have a function of measuring the amount of electric power of the power storage device 791 and the amount of electric power supplied from the commercial power source 701. The predicting portion 712 has a function of predicting, on the basis of the amount of electric power consumed by the general load 707 and the power storage load 708 during a given day, the demand for electric power consumed by the general load 707 and the power storage load 708 during the next day. The planning portion 713 has a function of making a charge and discharge plan of the power storage device 791 on the basis of the demand for electric power predicted by the predicting portion 712.

The amount of electric power consumed by the general load 707 and the power storage load 708 and measured by the measuring portion 711 can be checked with the indicator 706. It can be checked with an electric device such as a TV or a personal computer through the router 709. Furthermore, it can be checked with a portable electronic terminal such as a smartphone or a tablet through the router 709. With the indicator 706, the electric device, or the portable electronic terminal, for example, the demand for electric power depending on a time period (or per hour) that is predicted by the predicting portion 712 can be checked.

The contents in this embodiment can be combined with the contents in the other embodiments as appropriate.

### Embodiment 17

In this embodiment, examples in which a motorcycle or a bicycle is provided with the power storage device of one embodiment of the present invention will be described.

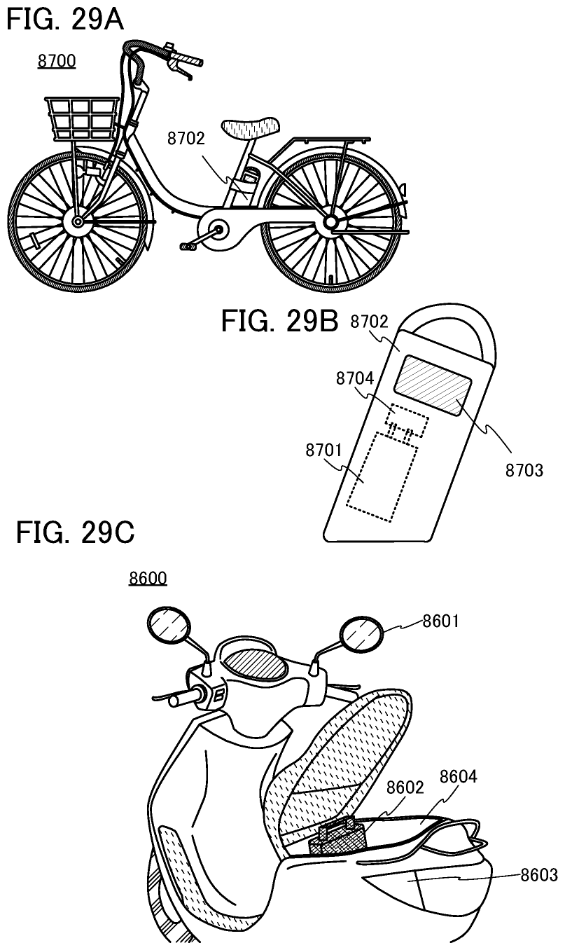

FIG. 29A illustrates an example of an electric bicycle using the power storage device of one embodiment of the present invention. The power storage device of one embodiment of the present invention can be used for an electric bicycle 8700 illustrated in FIG. 29A. The power storage device of one embodiment of the present invention includes a plurality of storage batteries and a protection circuit, for example.

The electric bicycle 8700 includes a power storage device 8702. The power storage device 8702 can supply electricity to a motor that assists a rider. The power storage device 8702 is portable, and FIG. 29B illustrates the state where the power storage device 8702 is detached from the bicycle. A plurality of storage batteries 8701 included in the power storage device of one embodiment of the present invention are incorporated in the power storage device 8702, and the remaining battery capacity and the like can be displayed on a display portion 8703. The power storage device 8702 includes a control circuit 8704 capable of anomaly detection. The control circuit 8704 is electrically connected to a positive electrode and a negative electrode of the storage battery 8701. The control circuit 8704 may be provided with the small solid-state secondary battery illustrated in FIG. 25A and FIG. 25B. When the small solid-state secondary battery illustrated in FIG. 25A and FIG. 25B is provided in the control circuit 8704, electric power can be supplied to store data in a memory circuit included in the control circuit 8704 for a long time. When the control circuit 8704 is used in combination with the secondary battery using the positive electrode active material 100 described in Embodiment 1 to Embodiment 11 in the positive electrode, the synergy on safety can be obtained. The secondary battery using the positive electrode active material 100 described in Embodiment 1 to Embodiment 11 in the positive electrode and the control circuit 8704 can greatly contribute to elimination of accidents due to secondary batteries, such as fires.

FIG. 29C illustrates an example of a motorcycle using the power storage device of one embodiment of the present invention. A motor scooter 8600 illustrated in FIG. 29C includes a power storage device 8602, side mirrors 8601, and indicator lights 8603. The power storage device 8602 can supply electricity to the indicator lights 8603. The power storage device 8602 including a plurality of secondary batteries including a positive electrode using the positive electrode active material 100 described in Embodiment 1 to Embodiment 11 can have high capacity and contribute to a reduction in size.

In the motor scooter 8600 illustrated in FIG. 29C, the power storage device 8602 can be stored in an under-seat storage unit 8604. The power storage device 8602 can be stored in the under-seat storage unit 8604 even with a small size.

The contents in this embodiment can be combined with the contents in the other embodiments as appropriate.

### Embodiment 18

In this embodiment, examples of electronic devices each including the secondary battery of one embodiment of the present invention will be described. Examples of the electronic device including the secondary battery include a television device (also referred to as a television or a television receiver), a monitor of a computer and the like, a digital camera, a digital video camera, a digital photo frame, a mobile phone (also referred to as a cellular phone or a mobile phone device), a portable game machine, a portable information terminal, an audio reproducing device, and a large-sized game machine such as a pachinko machine. Examples of the portable information terminal include a laptop personal computer, a tablet terminal, an e-book reader, and a mobile phone.

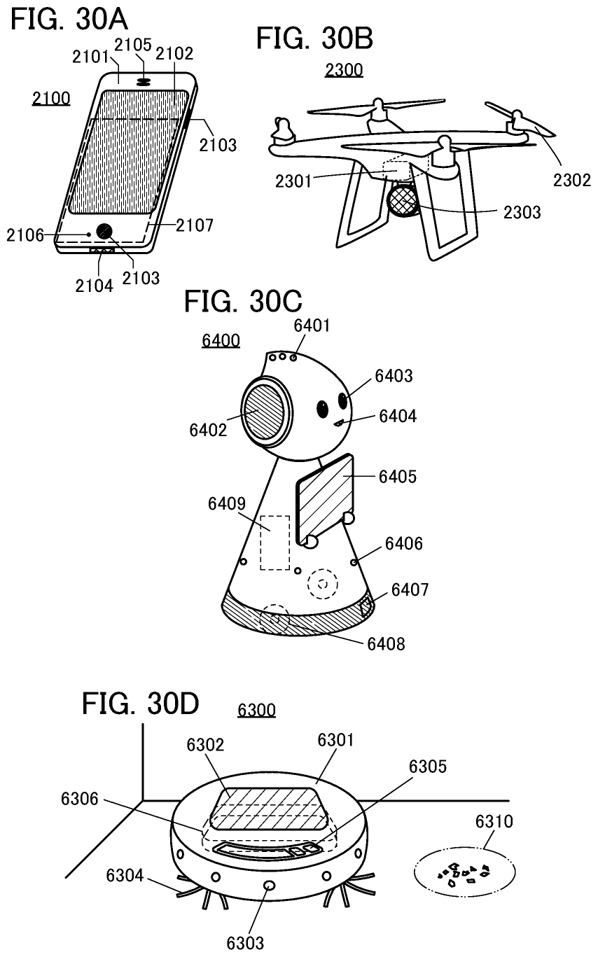

FIG. 30A illustrates an example of a mobile phone. A mobile phone 2100 includes a housing 2101 in which a display portion 2102 is incorporated, operation buttons 2103, an external connection port 2104, a speaker 2105, a microphone 2106, and the like. The mobile phone 2100 includes a secondary battery 2107. The use of the secondary battery 2107 including a positive electrode using the positive electrode active material 100 described in Embodiment 1 to Embodiment 11 achieves high capacity and a structure that accommodates space saving due to a reduction in size of the housing.

The mobile phone 2100 is capable of executing a variety of applications such as mobile phone calls, e-mailing, viewing and editing texts, music reproduction, Internet communication, and a computer game.

With the operation button 2103, a variety of functions such as time setting, power on/off, on/off of wireless communication, setting and cancellation of a silent mode, and setting and cancellation of a power saving mode can be performed. For example, the functions of the operation button 2103 can be set freely by the operating system incorporated in the mobile phone 2100.

The mobile phone 2100 can employ near field communication conformable to a communication standard. For example, mutual communication between the mobile phone 2100 and a headset capable of wireless communication enables hands-free calling.

Moreover, the mobile phone 2100 includes the external connection port 2104, and data can be directly transmitted to and received from another information terminal via a connector. In addition, charging can be performed via the external connection port 2104. Note that the charge operation may be performed by wireless power feeding without using the external connection port 2104.

The mobile phone 2100 preferably includes a sensor. As the sensor, a human body sensor such as a fingerprint sensor, a pulse sensor, or a temperature sensor, a touch sensor, a pressure sensitive sensor, or an acceleration sensor is preferably mounted, for example.

FIG. 30B illustrates an unmanned aircraft 2300 including a plurality of rotors 2302. The unmanned aircraft 2300 is sometimes also referred to as a drone. The unmanned aircraft 2300 includes a secondary battery 2301 of one embodiment of the present invention, a camera 2303, and an antenna (not illustrated). The unmanned aircraft 2300 can be remotely controlled through the antenna. A secondary battery including a positive electrode using the positive electrode active material 100 described in Embodiment 1 to Embodiment 11 has high energy density and a high level of safety, and thus can be used safely for a long time over a long period of time and is preferable as the secondary battery included in the unmanned aircraft 2300.

FIG. 30C illustrates an example of a robot. A robot 6400 illustrated in FIG. 30C includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with the user using the microphone 6402 and the speaker 6404.

The display portion 6405 has a function of displaying various kinds of information. The robot 6400 can display information desired by the user on the display portion 6405. The display portion 6405 may be provided with a touch panel. Moreover, the display portion 6405 may be a detachable information terminal, in which case charging and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes, in its inner region, the secondary battery 6409 of one embodiment of the present invention and a semiconductor device or an electronic component. A secondary battery including a positive electrode using the positive electrode active material 100 described in Embodiment 1 to Embodiment 11 has high energy density and a high level of safety, and thus can be used safely for a long time over a long period of time and is preferable as the secondary battery 6409 included in the robot 6400.

FIG. 30D illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object, such as a wire, that is likely to be caught in the brush 6304 by image analysis, the rotation of the brush 6304 can be stopped. The cleaning robot 6300 includes, in its inner region, the secondary battery 6306 of one embodiment of the present invention and a semiconductor device or an electronic component. A secondary battery including a positive electrode using the positive electrode active material 100 described in Embodiment 1 to Embodiment 11 has high energy density and a high level of safety, and thus can be used safely for a long time over a long period of time and is preferable as the secondary battery 6306 included in the cleaning robot 6300.

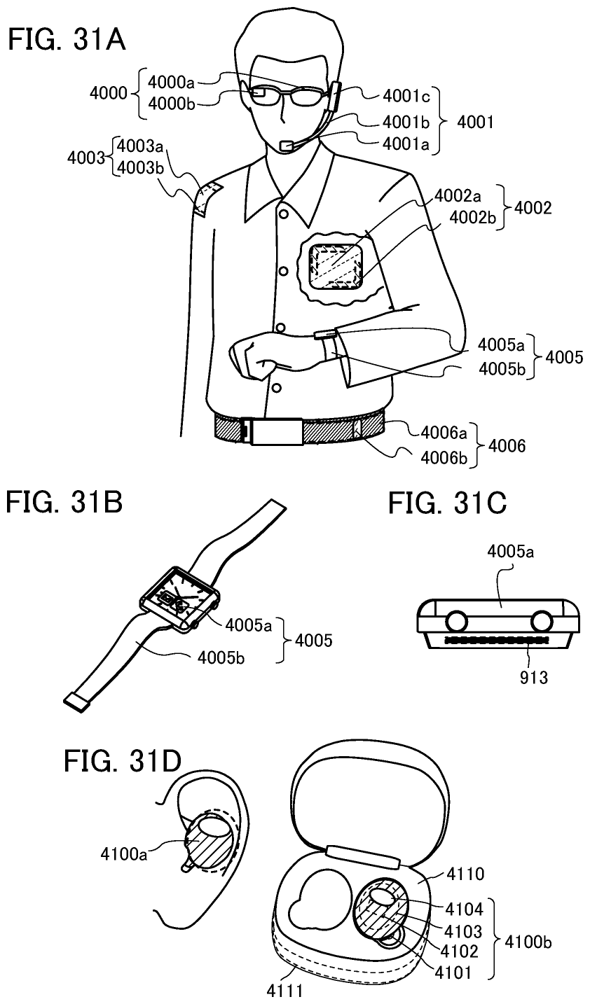

FIG. 31A illustrates examples of wearable devices. A secondary battery is used as a power source of a wearable device. To have improved splash resistance, water resistance, or dust resistance in daily use or outdoor use by a user, a wearable device is desirably capable of being charged with and without a wire whose connector portion for connection is exposed.

For example, the secondary battery of one embodiment of the present invention can be provided in a glasses-type device 4000 illustrated in FIG. 31A. The glasses-type device 4000 includes a frame 4000a and a display portion 4000b. The secondary battery is provided in a temple portion of the frame 4000a having a curved shape, whereby the glasses-type device 4000 can be lightweight, can have a well-balanced weight, and can be used continuously for a long time. A secondary battery including a positive electrode using the positive electrode active material 100 described in Embodiment 1 to Embodiment 11 has high energy density and achieves a structure that accommodates space saving due to a reduction in size of the housing.

The secondary battery of one embodiment of the present invention can be provided in a headset-type device 4001. The headset-type device 4001 includes at least a microphone portion 4001a, a flexible pipe 4001b, and an earphone portion 4001c. The secondary battery can be provided in the flexible pipe 4001b or the earphone portion 4001c. A secondary battery including a positive electrode using the positive electrode active material 100 described in Embodiment 1 to Embodiment 11 has high energy density and achieves a structure that accommodates space saving due to a reduction in size of the housing.

The secondary battery of one embodiment of the present invention can be provided in a device 4002 that can be attached directly to a body. A secondary battery 4002b can be provided in a thin housing 4002a of the device 4002. A secondary battery including a positive electrode using the positive electrode active material 100 described in Embodiment 1 to Embodiment 11 has high energy density and achieves a structure that accommodates space saving due to a reduction in size of the housing.

The secondary battery of one embodiment of the present invention can be provided in a device 4003 that can be attached to clothes. A secondary battery 4003b can be provided in a thin housing 4003a of the device 4003. A secondary battery including a positive electrode using the positive electrode active material 100 described in Embodiment 1 to Embodiment 11 has high energy density and achieves a structure that accommodates space saving due to a reduction in size of the housing.

The secondary battery of one embodiment of the present invention can be provided in a belt-type device 4006. The belt-type device 4006 includes a belt portion 4006a and a wireless power feeding and receiving portion 4006b, and the secondary battery can be provided in the inner region of the belt portion 4006a. A secondary battery including a positive electrode using the positive electrode active material 100 described in Embodiment 1 to Embodiment 11 has high energy density and achieves a structure that accommodates space saving due to a reduction in size of the housing.

The secondary battery of one embodiment of the present invention can be provided in a watch-type device 4005. The watch-type device 4005 includes a display portion 4005a and a belt portion 4005b, and the secondary battery can be provided in the display portion 4005a or the belt portion 4005b. A secondary battery including a positive electrode using the positive electrode active material 100 described in any one of Embodiment 1 to Embodiment 11 has high energy density and achieves a structure that accommodates space saving due to a reduction in size of the housing.

The display portion 4005a can display various kinds of information such as time and reception information of an e-mail and an incoming call.

The watch-type device 4005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 31B illustrates a perspective view of the watch-type device 4005 that is detached from an arm.

FIG. 31C illustrates a side view. FIG. 31C illustrates a state where the secondary battery 913 is incorporated in the inner region. The secondary battery 913 is the secondary battery described in Embodiment 4. The secondary battery 913 is provided to overlap with the display portion 4005a, can have high density and high capacity, and is small and lightweight.

Since the secondary battery in the watch-type device 4005 is required to be small and lightweight, the use of the positive electrode active material 100 described in Embodiment 1 to Embodiment 11 in the positive electrode of the secondary battery 913 enables the secondary battery 913 to have high energy density and a small size.

FIG. 31D illustrates an example of wireless earphones. The wireless earphones illustrated here as an example consist of, but not limited to, a pair of main bodies 4100a and 4100b.

The main bodies 4100a and 4100b each include a driver unit 4101, an antenna 4102, and a secondary battery 4103. A display portion 4104 may also be included. Moreover, a substrate where a circuit such as a wireless IC is provided, a terminal for charging, and the like are preferably included. Furthermore, a microphone may be included.

A case 4110 includes a secondary battery 4111. Moreover, a substrate where a circuit such as a wireless IC or a charge control IC is provided, and a terminal for charging are preferably included. Furthermore, a display portion, a button, and the like may be included.

The main bodies 4100a and 4100b can communicate wirelessly with another electronic device such as a smartphone. Thus, sound data and the like transmitted from another electronic device can be played through the main bodies 4100a and 4100b. When the main bodies 4100a and 4100b include a microphone, sound captured by the microphone is transmitted to another electronic device, and sound data obtained by processing with the electronic device can be transmitted to and played through the main bodies 4100a and 4100b. Hence, the wireless earphones can be used as a translator, for example.

The secondary battery 4103 included in the main body 4100a can be charged by the secondary battery 4111 included in the case 4110. As the secondary battery 4111 and the secondary battery 4103, the coin-type secondary battery or the cylindrical secondary battery of the foregoing embodiment, for example, can be used. A secondary battery including a positive electrode using the positive electrode active material 100 described in Embodiment 1 to Embodiment 11 has a high energy density; thus, with the use of the secondary battery as the secondary battery 4103 and the secondary battery 4111, a structure that accommodates space saving due to a reduction in size of the wireless earphones can be achieved.

This embodiment can be implemented in appropriate combination with the other embodiments.

### REFERENCE NUMERALS

11a: surface portion, 11b: inner portion, 100: positive electrode active material, 101: primary particle, 102: secondary particle, 103: interface, 105: space, 550: current collector, 553: acetylene black, 554: graphene compound, 555: carbon nanotube, 561: active material, 801: transition metal M source, 802: additive element X source, 803: nickel source, 804: cobalt source, 805: manganese source, 811: mixture, 812: aqueous solution A, 813: aqueous solution B, 821: mixture, 822: lithium compound, 823: additive element X source, 831: mixture, 832: mixture, 833: additive element X source, 833a: mixture, 833b: mixture, 834: magnesium source, 835: fluorine source, 836: mixture, 841: mixture, 842: mixture, 843: additive element X source, 843a: mixture, 843b: mixture, 845: nickel source, 846: aluminum source, 847: mixture, 851: mixture, 863: mixture, 907: mixture, 908: mixture, 909: mixture

1. A manufacturing method of a positive electrode active material comprising lithium and a transition metal, comprising:
a first step of forming a hydroxide comprising the transition metal using at least a basic aqueous solution and an aqueous solution comprising the transition metal;
a second step of preparing a lithium compound;
a third step of mixing the lithium compound and the hydroxide to form a mixture; and
a fourth step of heating the mixture to form a composite oxide comprising the lithium and the transition metal,
wherein a material with a purity higher than or equal to 99.99% is prepared as the lithium compound in the second step, and
wherein the heating in the fourth step is performed in an oxygen-containing atmosphere with a dew point lower than or equal to −50° C.

2. A manufacturing method of a positive electrode active material comprising lithium, nickel, cobalt, and manganese, comprising:
a first step of forming a hydroxide comprising nickel, cobalt, and manganese using at least a basic aqueous solution and a mixed solution of an aqueous solution comprising nickel, an aqueous solution comprising cobalt, and an aqueous solution comprising manganese;
a second step of preparing a lithium compound;
a third step of mixing the lithium compound and the hydroxide to form a mixture; and
a fourth step of heating the mixture to form a composite oxide comprising the lithium, the nickel, the cobalt, and the manganese,
wherein a material with a purity higher than or equal to 99.99% is prepared as the lithium compound in the second step, and
wherein the heating in the fourth step is performed in an oxygen-containing atmosphere with a dew point lower than or equal to −50° C.

3. A manufacturing method of a positive electrode active material comprising lithium, nickel, cobalt, manganese, and aluminum, comprising:
a first step of forming a hydroxide comprising nickel, cobalt, manganese, and aluminum using at least a basic aqueous solution and a mixed solution of an aqueous solution comprising nickel, an aqueous solution comprising cobalt, an aqueous solution comprising manganese, and an aqueous solution comprising aluminum;
a second step of preparing a lithium compound;
a third step of mixing the lithium compound and the hydroxide to form a mixture; and
a fourth step of heating the mixture to form a composite oxide comprising the lithium, the nickel, the cobalt, the manganese, and the aluminum,
wherein a material with a purity higher than or equal to 99.99% is prepared as the lithium compound in the second step, and
wherein the heating in the fourth step is performed in an oxygen-containing atmosphere with a dew point lower than or equal to −50° C.

4. A manufacturing method of a positive electrode active material comprising lithium, nickel, cobalt, manganese, and aluminum, comprising:
a first step of forming a hydroxide comprising nickel, cobalt, and manganese using at least a basic aqueous solution and a mixed solution of an aqueous solution comprising nickel, an aqueous solution comprising cobalt, and an aqueous solution comprising manganese;
a second step of preparing a lithium compound and an aluminum source;
a third step of mixing the lithium compound, the aluminum source, and the hydroxide to form a mixture; and
a fourth step of heating the mixture to form a composite oxide comprising the lithium, the nickel, the cobalt, the manganese, and the aluminum,
wherein a material with a purity higher than or equal to 99.99% and a material with a purity higher than or equal to 99.9% are prepared as the lithium compound and the aluminum source, respectively, in the second step, and
wherein the heating in the fourth step is performed in an oxygen-containing atmosphere with a dew point lower than or equal to −50° C.

5. A manufacturing method of a positive electrode active material comprising lithium, nickel, cobalt, manganese, aluminum, magnesium, and fluorine, comprising:
a first step of forming a hydroxide comprising nickel, cobalt, and manganese using at least a basic aqueous solution and a mixed solution of an aqueous solution comprising nickel, an aqueous solution comprising cobalt, and an aqueous solution comprising manganese;
a second step of preparing a lithium compound and an aluminum source;
a third step of mixing the lithium compound, the aluminum source, and the hydroxide to form a first mixture;
a fourth step of heating the first mixture to form a first composite oxide comprising the lithium, the nickel, the cobalt, the manganese, and the aluminum;
a fifth step of preparing a magnesium source and a fluorine source;
a sixth step of mixing the first composite oxide, the magnesium source, and the fluorine source to form a second mixture; and
a seventh step of heating the second mixture to form a second composite oxide comprising the lithium, the nickel, the cobalt, the manganese, the aluminum, the magnesium, and the fluorine,
wherein a material with a purity higher than or equal to 99.99% and a material with a purity higher than or equal to 99.9% are prepared as the lithium compound and the aluminum source, respectively, in the second step,
wherein a material with a purity higher than or equal to 99% and a material with a purity higher than or equal to 99% are prepared as the magnesium source and the fluorine source, respectively, in the fifth step, and
wherein the heating in the fourth step and the heating in the seventh step are performed in an oxygen-containing atmosphere with a dew point lower than or equal to −50° C.
